(19) United States
(12) Patent Application Publication
(10) Pub. No.: US 2009/0135885 A1
(43) Pub. Date: May 28, 2009

(54) NON-LINEAR FEEDBACK CONTROL LOOPS AS SPREAD SPECTRUM CLOCK GENERATOR

(75) Inventor: Wen T. Lin, Ambler, PA (US)

Correspondence Address: FOX ROTHSCHILD LLP, P O BOX 592, 112 NASSAU STREET, PRINCETON, NJ, 08542-0592, US

(73) Assignee: KEYSTONE SEMICONDUCTOR, INC., Bethlehem, PA (US)

(21) Appl. No.: 12/092,742

(22) PCT Filed: Nov. 7, 2006
(86) PCT No.: PCT/US06/60599

§ 371 Date: Jul. 17, 2008

Related U.S. Application Data
(60) Provisional application No. 60/734,222, filed on Nov. 7, 2005.
(60) Provisional application No. 60/737,592, filed on Nov. 17, 2005.
(60) Provisional application No. 60/742,764, filed on Dec. 6, 2005.
(60) Provisional application No. 60/756,040, filed on Jan. 4, 2006.
(60) Provisional application No. 60/757,645, filed on Jan. 10, 2006.
(60) Provisional application No. 60/805,900, filed on Jun. 27, 2006.
(60) Provisional application No. 60/806,900, filed on Jul. 10, 2006.
(60) Provisional application No. 60/823,339, filed on Aug. 23, 2006.
(60) Provisional application No. 60/827,288, filed on Sep. 28, 2006.

(51) Int. Cl. H04B 1/69

(52) U.S. Cl. 375/130; 375/E01.001

(57) ABSTRACT

This patent disclosure presents circuits, systems and methods to spread a clock signal to produce a random spreading for the clock signal that offers the maximum possible power density reduction for the spurious radiations generated from the clock signal and its harmonics. These new inventions utilize a non-linear feedback control loop to assist in generation of the spread spectrum clock and result in electronic products that can pass the FCC requirements for spurious radiations generated by the clock signal and its harmonics without utilizing expensive shielding and other EMI suppression methods.

### CROSS REFERENCE TO RELATED APPLICATIONS

This application is related to, and claims priority from U.S. Provisional Application No. 60/734,222, filed on Nov. 7, 2005; U.S. Provisional Application No. 60/737,592, filed on Nov. 17, 2005; U.S. Provisional Application No. 60/742,764, filed on Dec. 6, 2005; U.S. Provisional Application No. 60/756,040, filed on Jan. 4, 2006; U.S. Provisional Application No. 60/757,645, filed on Jan. 10, 2006; U.S. Provisional Application No. 60/805,900, filed on Jun. 27, 2006; U.S. Provisional Application No. 60/806,639, filed on Jul. 6, 2006; U.S. Provisional Application No. 60/823,339, filed on Aug. 23, 2006; and U.S. Provisional Application No. 60/827,288, filed on Sep. 23, 2006; and is also related to PCT Application, PCT/US05/26842 filed on Jul. 28, 2005, and PCT Application No. PCT/US06/17856, filed on May 4, 2006, the entire contents of all of which are hereby incorporated by reference.

### TECHNICAL FIELD

The present invention relates to the field of digital signal processing, and more specifically, the present invention relates to methods, circuits and systems for improved spread spectrum clock generation.

### BACKGROUND ART

The spread spectrum clock generator has become very popular among the electronic products, especially the PCs, in the past decade. This technique can effectively reduce the peak strength of spurious radiations of the clock signal and its harmonics from the PC so that the PC can be built with less RF shielding; in other words, less cost, weight and time and still passes the electromagnetic field interference (EMI) requirements set by the FCC for electronic products. The principle of this technique is to spread the frequency of the clock signal evenly into a bandwidth of small percentage of the clock frequency so that the radiated clock signal energy will not stay at one fixed frequency all the time. As a result, the peak strength of spurious radiations from the clock signal at the clock frequency and its harmonics is spread out and greatly reduced. The amount of reduction of peak spurious radiations is determined by how the clock signal is spread. The most common method to spread the frequency of clock signal is to use a triangular modulation signal with a linear ramp up and ramp down slope to evenly spread the frequency of the clock signal over a small percentage of the clock frequency. The typical response of clock spreading with a triangular modulation signal is as shown in FIG. 1. The spreading can effectively reduce the peak strength of the clock signal radiations by the spreading loss 102 which is typically only 8 to 14 db with the current technology. Unfortunately, spread by a triangular modulation, the energy spectrum of the clock signal always inevitably peaks up at both ends of the clock spectrum because the clock signal spends more time staying at both ends of the spreading. Many techniques were developed during the past decade to improve the spreading waveform so that the clock energy will spread out more evenly but all these current methods can only do so much because all the spreading functions used today are deterministic while a random noise is needed to spread the clock signal truly evenly as shown also in FIG. 1. Unfortunately, it is very difficult to implement a spread spectrum clock system inside an IC to spread the clock signal with a random noise using the current technology. A better and simpler way to spread the clock signal more evenly by using random noise is thus very desirable to reduce the peak strength of spurious radiations from the clock signal and its harmonics even more.

Currently, there are many ways to spread the clock signal, the simplest way is to dither the programmable divider of a PLL to generate a modulated clock signal and the most complicated way is to use a look-up table to store the spreading function for the modulation of the clock signal. Both methods produce a smooth modulation signal to spread the frequency of VCO. The U.S. Pat. No. 5,610,955 represents the first method while the U.S. Pat. No. 6,377,646B1 represents the second approach. As explained earlier, these methods produce a smooth deterministic function to modulate the VCO so that the energy level of the spurious clock radiation signals is still very concentrated. As a result, the current technology can only reduce the peak spurious clock radiation energy by 8 to 14 db, depending upon the spreading ratio. U.S. Pat. No. 5,506,545 provides an analog solution by using a noise source to spread the VCO. This solution provides a true random wideband spread for the clock signal; however, it is very difficult to implement this analog design into an integrated circuit.

### DISCLOSURE OF INVENTION

Four new methods and systems using non-linear feedback control loop to produce spread spectrum clock signal with mostly digital design suitable for IC implementation are presented in this disclosure. The principle behind these techniques is to make the non-linear feedback control loop unstable and oscillating at a certain frequency. In the meantime, we also let the intrinsic broadband noises of the loop control the modulation of the feedback module of the loop. The broadband noise modulation can offer a much higher spreading loss 161 to bring down the peak energy of spurious clock radiations far more than the triangular modulation can 102 with the same amount of frequency spread as shown in FIG. 1. The energy spectrum of the clock signal modulated by broadband random noise is also much smoother than the energy spectrum of clock signal modulated by triangular modulation. For a clock signal modulated by broadband random noise, since the clock signal never stays at one frequency or phase regularly, the energy of the spurious clock radiation signals is reduced to the possible minimum. As a result, the random noise modulation can greatly improve the spreading loss as compared with the traditional triangular modulation under the same spreading ratio.

By using the intrinsic noises in the non-linear feedback control loop to modulate the oscillation of clock signal, since the noises are already in the loop, we can build a spread spectrum clock generator modulated by random broadband noises easily inside an IC with minimum hardware. This and other features of the present inventions will now be described in detail by referencing to the following figures.

### BRIEF DESCRIPTIONS OF THE DRAWINGS AND FIGURES

FIG. 1—The typical clock spreading with a triangular modulation signal and a random wideband noise (prior art).

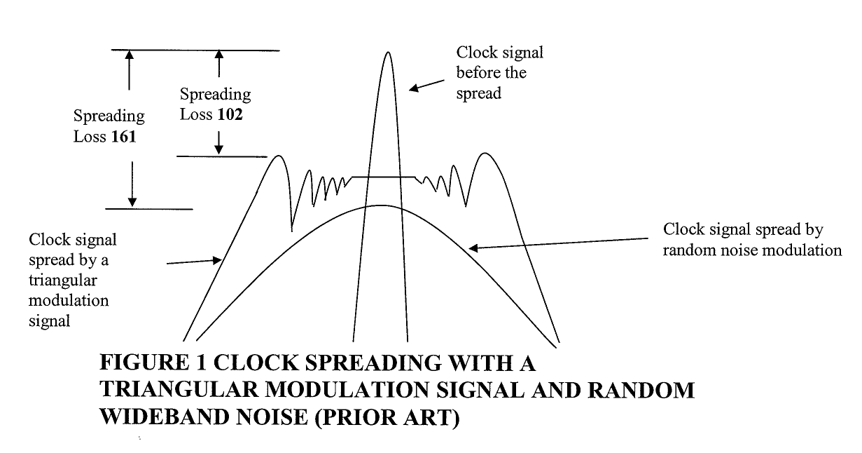

FIG. 2—The building blocks of a linear feedback control loop

FIG. 3—The transfer characteristics of the final error correction output of a linear feedback control loop.

FIG. 4—The block diagram of the traditional linear feedback control loop (prior art)

FIG. 5—The building blocks of a non-linear feedback control loop using a non-linear error comparator as the spread spectrum clock generator as the preferred embodiment.

FIG. 6—The building blocks of a non-linear feedback control loop using a linear error detector and an amplifier with infinite gain as the spread spectrum clock generator as the alternate embodiment.

FIG. 7—The transfer characteristic of the final error correction output of a non-linear feedback control loop.

FIG. 8—The acquisition behavior of the first order non-linear feedback control loop.

FIG. 9—The transfer characteristic of the gain of the non-linear feedback control loop.

FIG. 10—The block diagram for a basic spread spectrum clock generator using a non-linear amplitude locked loop with a non-linear amplitude comparator as the first embodiment.

FIG. 11—The block diagram for spread spectrum clock generator using a basic non-linear arrival-time locked loop with a non-linear arrival-time comparator as the second embodiment.

FIG. 12—The block diagram for spread spectrum clock generator using a basic non-linear arrival-time locked loop with a linear arrival-time detector and an amplifier with infinite gain as the third embodiment.

FIG. 13—The typical spread spectrum clock generator using a non-linear arrival-time locked loop with a non-linear arrival-time comparator and a frequency divider.

FIG. 14—The typical spread spectrum clock generator using a non-linear arrival-time locked loop with a linear arrival-time detector and a frequency divider.

FIG. 15—The schematics of an illustrative non-linear arrival-time comparator as the first supplement embodiment to the second embodiment.

FIG. 16—The schematics of a simplified non-linear arrival-time comparator as the second supplement embodiment to the second embodiment.

FIG. 17—The transfer characteristic of the final error correction output from the non-linear arrival-time comparators as shown in FIG. 16.

FIG. 18—The schematics of a precise non-linear arrival-time comparator with a dead zone as the third supplement embodiment to the second embodiment.

FIG. 19—An illustration for the acquisition behavior of the second order arrival-time locked loop.

FIG. 20—The schematics of a linear arrival-time detector with a dead-zone as the first supplement embodiment to the third embodiment.

FIG. 21—The schematics of a typical linear arrival-time detector without a dead-zone as the second supplement embodiment to the third embodiment.

FIG. 22—The schematics of a linear arrival-time detector using single-ended charge pump output driver with a dead zone as the third supplement embodiment to the third embodiment.

FIG. 23—The schematics of a linear arrival-time detector using single-ended charge pump output driver without a dead-zone as the fourth supplement embodiment to the third embodiment.

FIG. 24—The block diagram of the spread spectrum clock generator using a non-linear phase locked loop with a linear phase detector and an amplifier with infinite gain as the fourth embodiment.

FIG. 25—The EXOR gate as the linear phase detector.

FIG. 26—The transfer characteristics of the EXOR gate as the linear phase detector.

FIG. 27—A typical digital linear phase detector as the first supplement embodiment to the fourth embodiment.

FIG. 28—The timing diagram for the digital linear phase detector as shown in FIG. 27.

FIG. 29—The transfer characteristics of digital linear phase detector as shown in FIG. 27.

FIG. 30—The block diagram of the spread spectrum clock generator using a non-linear phase locked loop with a non-linear phase comparator as the fifth embodiment.

FIG. 31—The schematics of the non-linear phase comparator using non-linear arrival-time comparator as the supplement embodiment to the fifth embodiment.

FIG. 32—A non-linear arrival-time comparator used in the non-linear phase comparator as shown in FIG. 31.

FIG. 33—The timing diagram for the reset clock of the non-linear phase comparator.

FIG. 34—The schematics of the digital linear phase detector using arrival-time comparators as the second supplement embodiment to the fourth embodiment.

FIG. 35—The block diagram of spread spectrum clock generator using a non-linear frequency locked loop with a linear frequency detector and an amplifier with infinite gain as the sixth embodiment.

FIG. 36—The block diagram of spread spectrum clock generator using a non-linear frequency locked loop with a non-linear frequency comparator as the seventh embodiment.

FIG. 37—The output characteristic of linear frequency detector.

FIG. 38—The schematics of a current frequency detector (prior art)

FIG. 39—The timing diagram for the current frequency detector as shown in FIG. 38.

FIG. 40—The spread spectrum clock generator using a typical non-linear frequency locked loop with non-linear frequency comparator and a frequency divider.

FIG. 41—The schematics of a basic phase-frequency detector with a double-ended charge pump output driver (prior art).

FIG. 42—The timing diagram of the basic PFD as shown in FIG. 41.

FIG. 43—The schematics for the non-linear frequency comparator using two PFDs as the first supplement embodiment to the seventh embodiment.

FIG. 44—The non-linear frequency comparator using three PFDs with shift registers and adders as the second supplement embodiment for the seventh embodiment.

FIG. 45—The schematics of a typical one-shot (prior art).

FIG. 46—The schematics of a non-linear frequency comparator using a state machine as the decision module as the third supplement embodiment to the seventh embodiment.

FIG. 47—The algorithm of the state machine for the design in FIG. 46.

FIG. 48—The schematics of a non-linear frequency comparator using a frequency decision module with saturatable counters as the fourth embodiment to the seventh embodiment.

FIG. 49—The block diagram of the frequency decision module using two saturatable counters.

FIG. 50—The schematics of non-linear frequency comparator using four PFDs with shift registers and adders as the fifth supplement embodiment to the seventh embodiment.

FIG. 51—The schematics of non-linear frequency comparator using four PFDs with shift register and adders and a compressed one-shot as the sixth supplement embodiment to the seventh embodiment.

FIG. 52—The schematics of circuit to produce a compressed one-shot output.

FIG. 53—The acquisition behavior of the non-linear frequency locked loop.

FIG. 54—The block diagram for a full rate non-linear frequency comparator by using three non-linear frequency comparators as the seventh supplement embodiment to the seventh embodiment.

FIG. 55—The block diagram for a high speed non-linear frequency comparator by using N non-linear frequency comparators as the eighth supplement embodiment to the seventh embodiment.

FIG. 56—The schematics of the test board.

FIG. 57—The block diagram for improving the spreading loss of clock with small frequency spread by using frequency mixer and divider.

FIG. 58—The block diagram for improving the spreading loss of spread spectrum clock signal generated from a non-linear feedback control loop using non-linear comparator with small frequency spread by adding artificial cycle-slip.

FIG. 59—The block diagram for improving the spreading loss of spread spectrum clock signal generated from a non-linear feedback control loop using amplifier with infinite gain with small frequency spread by adding artificial cycle-slip.

### BEST MODE FOR CARRYING OUT THE INVENTION

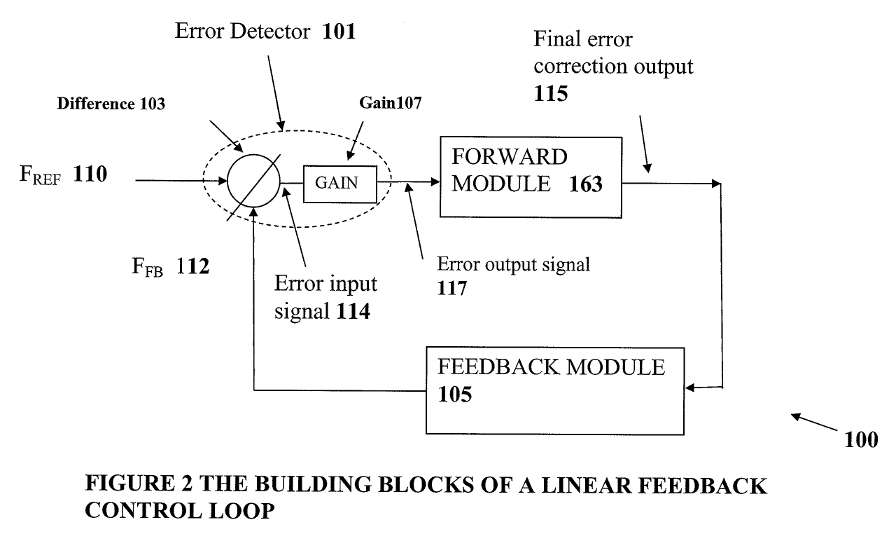

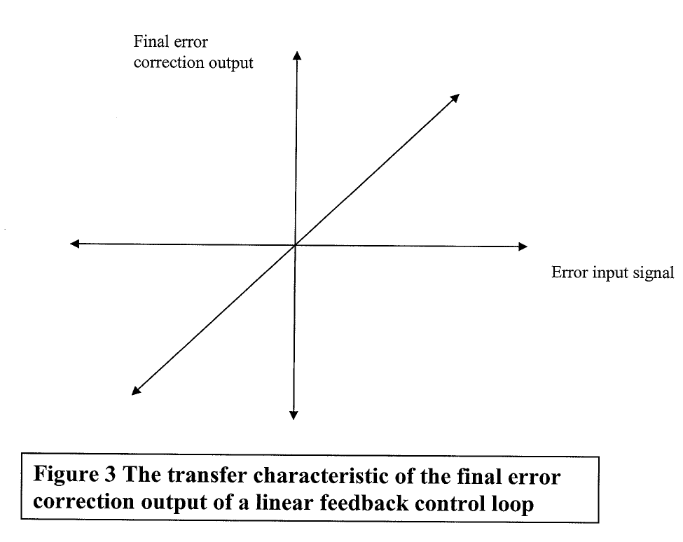

The present invention relates to systems, methods and circuits to spread the energy of clock signal evenly into a bandwidth of a small percentage of the clock frequency by using non-linear feedback control loops. There are four different kinds of non-linear feedback control loop presented in this disclosure, the non-linear arrival-time locked loop 150 and 152, the non-linear frequency locked loop 196 and 213, the non-linear phase locked loop 171 and 166 and the non-linear amplitude locked loop 135. The non-linear feedback control loop is quite different from the regular linear feedback control loop, such as a linear phase locked loop or a linear frequency locked loop. For a linear feedback control loop 100 as shown in FIG. 2, the output signal of the loop, which is the final error correction output 115 to the feedback module 105, is a linear function of the error input signal 114 as shown in FIG. 3. The feedback module 105 will be corrected according to the polarity and amplitude of the error input signal 114 linearly so that the feedback module 105 will produce a feedback signal 112 that always tracks the reference signal 110. If we use a low pass filter as the forward module 163, this low pass filter will prevent the feedback signal 112 from changing too quickly and following the reference signal 110 too closely. As a result, this filter can help us removing the unwanted fluctuations in the reference input signal 110 and provides us a clean stable feedback output signal 112 generated from a noisy reference signal input 110.

The transfer characteristics of the final error correction output 115 of a linear feedback control loop 100 as shown in FIG. 3 was obtained by comparing a single event from both inputs to the error detector 101 when the loop is opened. Ideally, the final error correction output 115 should stay a fixed constant bias when there is no error between the two input signals so that a zero error input signal 114 produces a zero final error correction output 115. The final error correction output 115 will become larger or smaller from the constant bias point depending upon the polarity of the error input signal 114. The amount of final error correction output 115 produced with respect to the fixed constant bias point depends upon the magnitude of the error input signal 114 linearly. As a result, the larger the error input signal 114, the more the final error correction output 115 will be produced to correct feedback signal 112 from the feedback module 105 so that the feedback signal 112 will always track the reference input signal 110 until there is no error between the two input signals and the error input signal 114 is zero.

To implement a linear feedback control loop 100, we need a linear error detector 101 to produce an error output signal 117 from the error between the two input signals linearly. The error detector 101 conceptually can be divided into two blocks, the difference block 103 and the gain block 107. The difference block 103 provides a conceptual error input signal 114 for the feedback control loop 100 and the gain block 107 produces the actual error output signal 117 to drive the forward module 163. This technique to conceptually break the error detector 101 into two blocks can help us deriving the gain for the feedback control loop 100 and understanding the operation of the loop 100 easily.

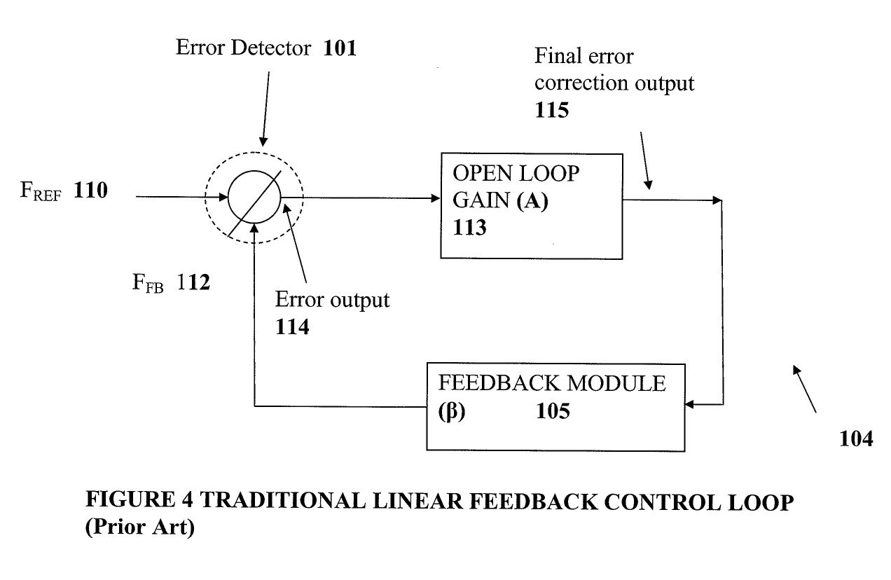

Traditionally, the error input signal 114 was considered as an output signal of the feedback control loop 104 and the reference input signal 110 was the only input signal to the feedback control loop system 104 as shown in FIG. 4. This definition seems very logical that defines all the signals related to the feedback signal 112 as the output signals; however, it is very difficult to analyze the loop 104 under this definition. First of all, the reference input signal 110 is only one of the input signals to a node, the error detector 101, of the loop but it is not part of the loop. The linear feedback control loop 100 itself, as shown in FIG. 2, contains only three modules, the error detector 101, the forward module 163 and feedback module 105 but it does not include the reference input signal 110 directly. The feedback control loop 104 is not actually directly connected to the reference input signal 110 and it is a gross mistake to treat the reference input signal 110 as the input to the feedback control loop system 104. And secondly, since the feedback control loop 104 has no beginning and no ending, there is really no way to analyze the feedback control loop 104 by itself. The only way to solve these problems is, as shown in FIG. 2, by conceptually breaking the error detector 101 into two blocks and defining the error input signal 114 as the only input to the feedback control loop 100 and the final error correction output 115 of the forward module 163 as the only output of the feedback control loop 100 and the purpose of the feedback module 105 is for the final error correction output signal 115 to produce a feedback output signal 112 to track the reference signal 110 and ultimately to produce an error input signal 114 for the feedback control loop 100.

With this new definition, we can clearly understand the function of each block of the loop 100. We can find out the gain of the feedback control loop 100 easily by taking the derivative of the final error correction output 115 vs. the derivative of the error input signal 114.

In the traditional definition of the feedback control loop 104 as shown in FIG. 4, two loop gains were used, the open loop gain and closed loop gain. The open loop gain 113 (A) is defined as the combined gain of the error detector 101 and the forward module 163 and the closed loop gain is defined as the multiplication product of the open loop gain 113 (A) and the feedback module 105 ( ) One big problem with this definition is that it is very difficult to combine the gain of the error detector 101 with the gain of the forward module 163 because they are completely different devices and it is also very difficult to characterize the combined open look gain 113 by measuring it directly. Even if the combined open loop gain 113 is measured, some small significant details of the open loop gain 113, such as the singularity caused by the discontinuity of the transfer characteristics, can be overlooked and neglected easily. Secondly, depending upon the type of the loop, the closed loop gain has different physical meanings and loop gain is no longer a right word to describe the multiplication product of the open loop gain 113 and feedback module 105. Nevertheless, these two names will still be used in this disclosure since they have been used for so long.

Using the new technique to break the error detector 101 conceptually will force us to characterize the error detector 101 separately from the rest of the loop 100. The error detector 101 can be characterized either by theory or simply by measuring the device itself. It is usually not difficult to find out the discontinuity of transfer characteristics of the error detector 101 that eventually becomes singularity of the loop 100, if there is any. Once the error detector 101 is characterized, we can figure out the transfer characteristic of the final error correction output 115 and loop gain easily.

For a first order linear feedback control loop 100 that tracks only one variable as shown in FIG. 2, such as an AGC loop or AFC loop, the multiplication product of the open loop gain 113 (A) and the feedback module 105 ( ) determines how closely the feedback signal 112 tracks the reference input signal 110. Just like the classical analysis for the traditional feedback control loop 104, the linear feedback control loop 100 can be analyzed as follows. Since the open loop gain 113 (A) is contributed by both the gain of the error detector 107 and the gain of the forward module 163, the feedback signal 112 is equal to the error input signal 114 times the open loop gain 113 (A) and the gain of the feedback module ( ) 105. The feedback signal 112 can be written as,

V_{f}=(V_{ref}−V_{f})*A* equ. 1

and the feedback signal can be solved from equation 1 as

V_{f}=V_{ref}*A/(1+A) equ. 2

So, the feedback signal 112 will be the same as the reference signal 110 only when A is infinite. In order to guarantee that the feedback signal 112 is truly locked to the reference signal 110, the closed loop gain must be infinite and it does not matter what is the polarity of the close loop gain when the closed loop gain is infinite. The irrelevancy of the polarity of closed loop gain indicates an unstable nature of the equation 2 since there are two solutions to a first order linear equation.

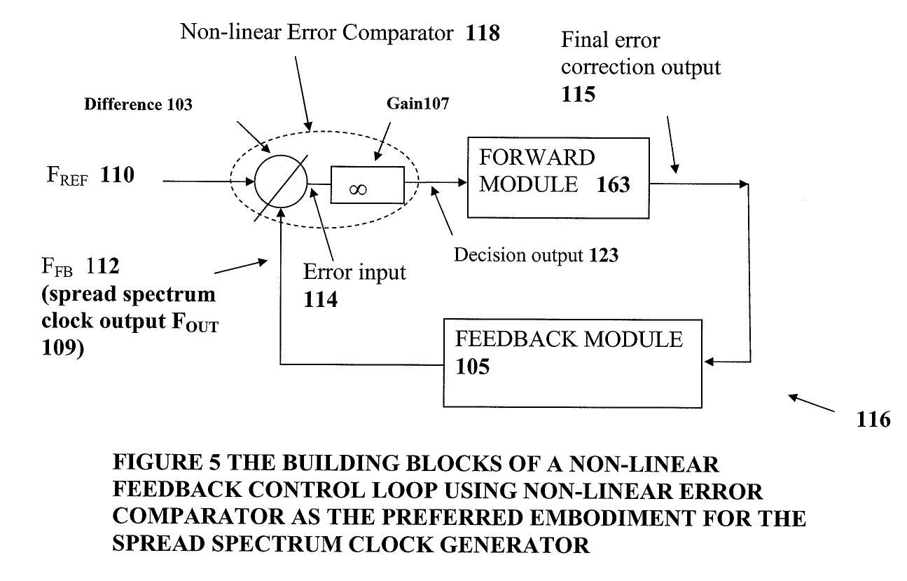

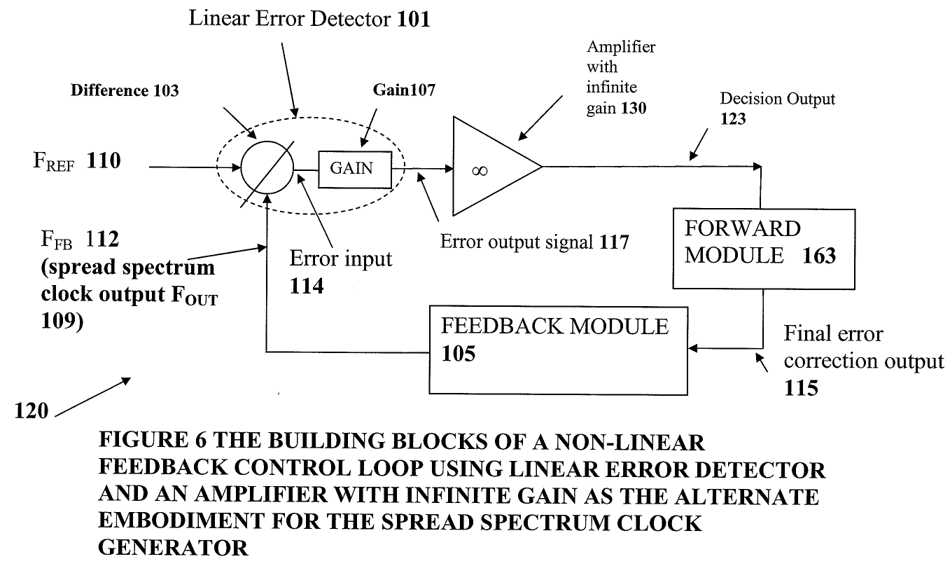

There are two ways to produce an infinite closed loop gain for the feedback control loop, either by using a linear error detector 101 to produce a linear error output 117 followed by an amplifier with an infinite gain 130 to turn the linear error output 117 into bipolar decision output 123 as shown in FIG. 6 or by using a non-linear error comparator 118 to produce a bipolar decision output 123 directly as shown in FIG. 5. An OPAMP is usually used as the amplifier with infinite gain 130 because an OPAMP configured as an active integrator can produce infinite DC gain easily; however, the OPAMP is a linear device that requires a lot of circuits and consumes more current. The solution to use a non-linear error comparator 118 is thus usually the simpler and better choice to provide an infinite gain so that the design in FIG. 5 is the preferred design for the non-linear feedback control loop.

A non-linear error comparator 118 can only produce a decision output 123 in two digital states, either H or L state, regardless of the amount of error input 114. Since the decision output 123 of the non-linear error comparator 118 remains constant even as the amplitude of the error input 114 grows linearly from 0 to infinity, the effective gain of the non-linear error comparator 118 must be produced in proportional to 1/(error input) in order to maintain a constant output. As a result, the gain of the non-linear error comparator 118 is approaching infinity when the error input 114 is zero.

When an ideal non-linear feedback control loop locks the local feedback signal 112 to the reference input signal 110 perfectly, the final error correction output 115 should remain at a constant DC to produce a stable feedback signal 112 that is always equal to the reference input signal 110; further corrections to the feedback module 105 are no longer needed and the error input signal 114 is always zero since the two input signals to the non-linear error comparator 118 or linear error detector 101, one from the reference input 110 and the other one from the feedback input 112, are locked and are equal all the time. As a result, we can maintain the locking condition of the loop by either providing the infinite loop gain for the loop when the error input 114 is zero, such as by using the non-linear error comparator 118 or by providing an infinite DC gain for the loop to produce a finite final error correction output 115 at a constant DC from zero error input 114, such as using an OPAMP configured as an active filter. Both the non-linear error comparator 118 used in FIG. 5 and the linear error detector 101 with amplifier with infinite gain 130 used in FIG. 6 are capable of providing the infinite gain we need to support the non-linear feedback control loops 116 and 120.

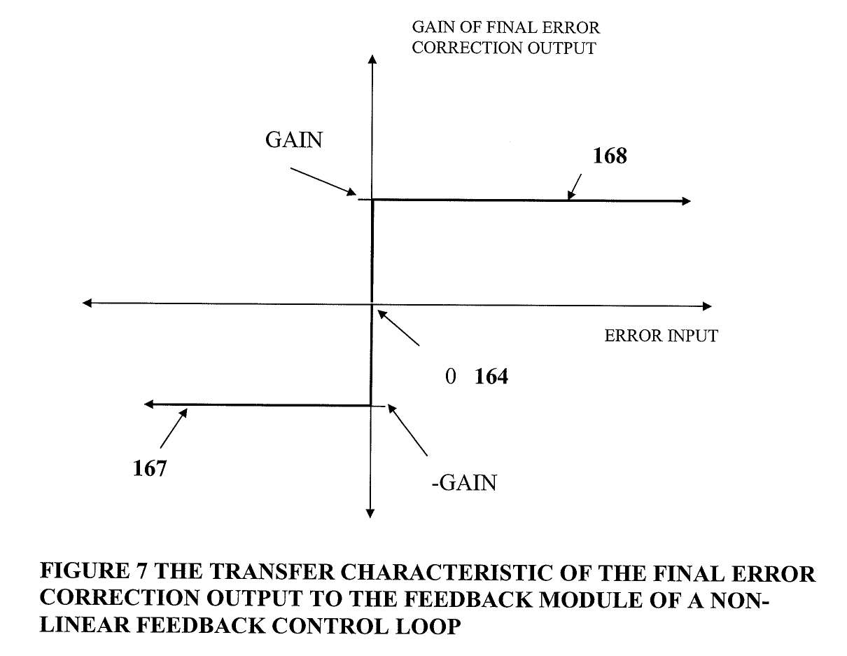

A linear feedback control loop 100 with infinite closed loop gain becomes a non-linear feedback control loop 116 and 120 as shown in FIGS. 5 and 6. The reason that it becomes a non-linear feedback control loop is because the final error correction output 115 to the feedback module 105 will have only two stable digital states, either H or L, as shown in FIG. 7. The transfer characteristic of the final error correction output 115 to the feedback module 105 as shown in FIG. 7 is obtained by comparing a single event from each of the two input signals to the non-linear error comparator 118 or linear error detector 101 when the non-linear feedback control loop is opened. For the design of non-linear feedback control loop 116 using non-linear error comparator 118 as shown in FIG. 5, since the non-linear error comparator 118 will remain at the current state forever until the polarity of the error input signal 114 is changed, the decision output 123 of the non-linear error comparator 118 will remain H when the error input signal 114 is positive and remain L when the error input signal 114 is negative, regardless of how large or small the error input signal 114 is. When a non-linear error comparator 118 is comparing a single event from both inputs, since the decision output 123 of the non-linear error comparator 118 will remain in either H or L state forever, there is nothing in the feedback control loop 116 to stop the non-linear error comparator 118 to prevent it from driving the final error correction output 115 to the rails of power supply so that the loop 116 becomes a non-linear feedback control loop. For the design of non-linear feedback control loop 120 using linear error detector 101 with an amplifier with infinite gain 130 as shown in FIG. 6, the decision output 123 of the amplifier 130 will remain H forever when the error input signal 114 is positive and remain L forever when the error input signal 114 is negative, so will the output of the final error correction output 115 just like the final error correction output 115 produced from non-linear error comparator 118.

As explained earlier, the transfer characteristic of the final error correction output 115 of a linear feedback control loop 100 is linear so that the final error correction output 115 is produced linearly according to polarity and magnitude of the error input 114 and the transfer characteristics of final error correction output 115 of non-linear feedback control loop 116 and 120 is binary and is produced according to the polarity of the error input signal 114 in two digital states. The transfer characteristics of both the linear feedback control loop as shown in FIG. 3 and non-linear feedback control loop as shown in FIG. 7 were obtained by comparing a single event from each of the two input to the non-linear error comparator 118 and linear error detector 101 while the loop is opened so that in theory we can identify whether if the feedback control loop is linear or non-linear by simply supplying a single input signal to both of the reference input 110 and feedback input 112 and examining the final error correction output 115. If the final error correction output 115 can only stay at either the positive or negative power rails, then the loop must be a non-linear feedback control loop; if the final error output 115 can stay at any level other than the positive or negative power rails, then it must be a linear feedback control loop. By definition, the final error correction output 115 of a linear feedback control loop 100 will never reach either the positive or negative power rails. Unfortunately, if there is a leakage current around the loop filter that produces and maintains the final error correction output signal 115, the leakage current can push the final error correction 115 output to reach either one of the power rails if given enough time, regardless of how small the leakage current is; or if the linear dynamic range of the linear error detector 101 is so small that the linear error detector 101 is saturated easily even with a large error input 114. As a result, a linear feedback control loop 100 can actually become a non-linear feedback control loop, if given enough time or given a large enough error input signal 114. On the other hand, if the operating frequency of a non-linear feedback control loop is so high that the both the decision output 123 and final error correction output 115 never has a chance to reach the rails of power supply due to the slew rate limit of the device, then the non-linear feedback control loop will become a linear feedback control loop. So, a linear feedback control loop can become a non-linear feedback control if given enough time or a large enough error input signal 114 and a non-linear feedback control loop can also become a linear feedback control loop if given less time. As a result, we should apply a time limit as well as a limit on the error input signal 114 when examining and producing the transfer characteristics in FIGS. 3 and 7 for a feedback control loop. The time limit should be adequate to the actual operating frequency of the loop and the error input signal 114 should be the actual maximum error input signal that can occur in the system. We will never be able to determine the type of the feedback control loop correctly unless a proper time limit and a limit on the error input signal 114 is used in performing the measurement of the final error correction output 115.

It is important to determine whether if the feedback control loop is linear or non-linear when operating or designing a feedback control loop because the feedback control loop behaves quite differently in each situation. It is especially critical for a linear feedback control loop using a small capacitor for the loop filter and being operated at a low comparison frequency because a small capacitor will not be able to hold up the charges on the loop filter for too long and the final error correction voltage 115 can be discharged or charged quickly after the error correction has ended and the linear feedback control loop can become a non-linear feedback loop unknowingly.

The non-linear feedback control loop as shown in FIG. 5 is made of three modules, the non-linear error comparator 118, the forward module 163 and the feedback module 105. The non-linear error comparator 118 produces a decision output signal 123 in two digital states, either H or L, based on the difference between the reference input signal 110 and the feedback signal 112 from the feedback module 105. We can also describe the two digital states at the decision output 123 of the non-linear error comparator 118 as positive output or negative output, in two polarities. The polarity of the decision output signal 123 is determined by the polarity of the error input signal 114 which is also the difference signal between the reference input signal 110 and feedback signal 112 from the feedback module 105. If the error input 114 is positive, the decision output 123 of the non-linear error comparator 118 will be H and if the error input 114 is negative, the decision output 123 of the non-linear error comparator 118 will be L. The decision output 123 of the error comparator 118 can only be affected by the polarity of the error input signal 114 but not the amplitude of the error input signal 114. The non-linear error comparator 118 is very different from the linear error detector 101. For a linear error detector 101 as shown in FIG. 6, both the polarity and amplitude of the error output signal 117 at the output of the linear error detector 101 are affected by the polarity and amplitude of the error input signal 114. As a result, we need an amplifier with infinite gain 130 to convert the linear error output signal 117 from the linear error detector 101 into a bipolar digital decision output 123. A linear error detector 101 with an amplifier with infinite gain 130 thus effectively becomes a non-linear error comparator 118. As a result, a non-linear feedback control loop 120 can also be made with four building blocks as shown in FIG. 6 including a linear error detector 101, an amplifier with infinite gain 130, a forward module 163 and a feedback module 105.

The decision output 123, after passing through the forward module 163, becomes the final error correction output 115 to control the feedback module 105. The feedback module 105 will then produce a corrected feedback output signal 112 back to the non-linear error comparator 118 and linear error detector 101 to close the loop. When the reference signal 110 is larger than the feedback signal 112, the non-linear error comparator 118 and linear error detector 101 will produce a positive decision output 123 to cause the feedback module 105 to increase the feedback signal 112 to reduce the difference between the reference input signal 110 and the feedback signal 112. When the reference signal 110 is smaller than the feedback signal 112, the non-linear error comparator 118 and linear error detector 101 will produce a negative decision output 123 to cause the feedback module 105 to decrease the feedback signal 112 to reduce the difference between the reference input signal 110 and the feedback signal 112. The feedback corrections of the non-linear feedback control loop will continue forever even when the two input signals to the non-linear error comparator 118 and the linear error detector 101 are equal and the error input signal 114 is zero due to the intrinsic noises and due to the fact that the decision output 123 can only stay at either H or L state. As a result, the feedback signal 112 of the non-linear feedback control loop 116 and 120 will never be truly equal to the reference input signal 110. Instead, the feedback signal 112 will be always oscillating around the reference input signal 110 randomly due to the intrinsic broadband noise. In contrast, the error input signal 114 of a first order linear feedback control loop 100 will be very small when loop is locked. The two input signals to the linear error detector 101 will never be truly equal for a first order linear feedback control loop because a finite error input signal 114 is needed to produce the feedback signal 112.

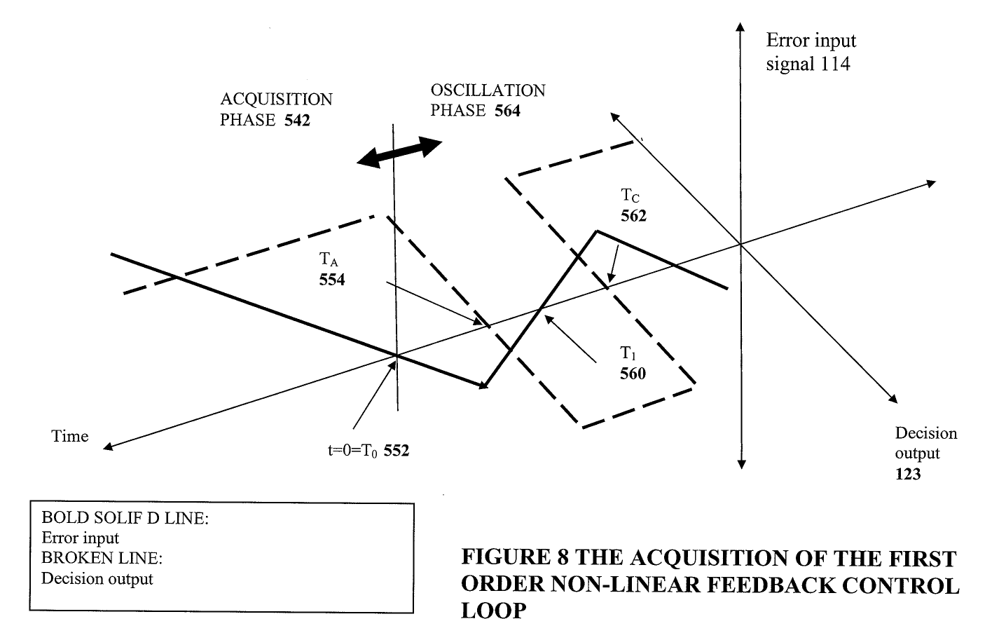

It is really difficult to understand the fact that the polarity of the closed loop gain is irrelevant when the closed loop gain is infinite. How could that possibly be? The reason that the polarity of the closed loop gain is irrelevant is because when the closed loop gain is infinite, the feedback control loop becomes a non-linear feedback control loop 120 and 116 and it will oscillate due to the inherent loop delay which includes both the propagation delay time and latency delay time from all the components of the non-linear feedback control loop. To see why the non-linear feedback control loop oscillates, we need to understand the acquisition behavior of the non-linear feedback control loop 116 and 120 as shown in FIG. 8. In this figure, the horizontal axial represents time and the first vertical axial is the error input signal 114 to represent the difference between the reference input signal 110 and the feedback signal 112 shown in solid line and the second vertical axial represents the binary decision output 123 shown in dotted line.

In the beginning of the acquisition process, the non-linear feedback control loop 116 and 120 is not locked and the difference between the two input signals is large. Assuming that the reference input signal 110 is much larger than the feedback signal 112 in the beginning of the acquisition process so that the decision output 123 is positive in the beginning of acquisition process to force the feedback module 105 to increase the feedback signal 112 to reduce the difference between the reference input 110 and feedback input 112. As the difference between the two input signal is being reduced, eventually the two input signals will be same occurring at time=T₀ 552. Ideally, right after passing the time at T₀ 552, the correction to feedback module 105 should be stopped immediately; however, since the decision output 123 of a non-linear feedback control loop 116 and 120 can only either stay at H or L in two digital states and there is an inherent propagation delay time and latency delay time for the components of the loop, the decision output 123 will remain H even after passing the T₀ 552 to continue to cause the feedback module 105 to increase the feedback signal 112 so that the difference between the reference signal 110 and feedback signal 112 becomes negative after t=T₀ 552. As a result, the decision output 123 should become negative right away; however, due to the inherent loop delay time, the decision output 123 can become negative only after the loop delay time is over at t=T_{A} 554 and the loop always continues to push the feedback module 105 into the wrong direction after time=T₀ 552 until the total loop delay time T_{A} 554 is finally over. At the time=T_{A} 554, the decision output 123 is finally switched to negative to cause the feedback module 105 to reduce the feedback signal 112. The loop will start to correct the mistake that has already been made between the period between T=0 T₀ 552 and T_{A} 554. It will take the loop the same amount of time as T_{A} 554 just to correct the mistake that has already been made during the loop delay time period, assuming that the non-linear error comparator 118 and the amplifier with infinite gain 130 pump up and pump down the final error correction output 115 at the same rate. After the mistake has been corrected at time around T₁ 560 which is approximately equal to twice of T_{A} 554, the error input signal 114 will now be almost near the decision threshold 164 of zero and the non-linear error comparator 118 and linear error detector 101 can make a new decision to switch the polarity of its output at any moment and the new decision can be affected by the noise easily. Once again, due to the loop delay time, the decision output 123 will not change direction to correct the feedback signal 112 after a new decision is made at t=T₁ 560 immediately, instead, the decision output 123 will continue to reduce the feedback signal 112 until T_{C} 562 when the loop delay time is finally over. As a result, the feedback signal 112 will continue to be reduced between t=T₁ 560 and T_{C} 562 when the loop pushed the feedback module 105 into the wrong direction during the loop delay period between T₁ 560 and T_{C} 562. The same behavior will then repeat itself. As a result, the decision output 123 for a non-linear feedback control loop 116 and 120 will always oscillate between positive and negative all the time and the time to switch the polarity of decision output 123 is determined by the noise around the decision threshold 164 of the non-linear error comparator 118 and the linear error detector 101 and the time to switch the polarity of decision output 123 will be different for every cycle of the oscillation.

The forward module 163 of the non-linear feedback control loop 116 and 120 is usually made of a low pass filter to reduce the noisy digital decision output 123 from the non-linear error comparator 118 and the amplifier with infinite gain 130 to become the linear final error correction output 115 for the feedback module 105. As a result, the bouncing decision output 123 will cause the final error correction output signal 115 to ramp up and down linearly. The ramping of the final error correction output 115 will change the direction randomly determined by the noise around the decision threshold 164 of the non-linear error comparator 118 and the linear error detector 101 and the ramping of the final error correction output 115 will change direction at a different time for every oscillation cycle so that the non-linear feedback control loop 116 and 120 will produce a feedback output signal 112 modulated by a random ramping on the final error correction output 115. The feedback output signal 112 will then be ramping up and down around the reference input signal 110 randomly and is thus the desired spread spectrum clock output signal 109.

The inherent loop delay time will cause the non-linear error comparator 118 and linear error detector 101 to make a mistake to pump the final error correction output 115 into the wrong direction for half of the oscillation period so that it needs the other half of the oscillation period to correct the mistake that was made during the loop delay period. As a result, every oscillation cycle of the modulation signal on the ramping of the final error correction output 115 is contributed by two approximately equal parts, by an incorrect decision output 123 during the loop delay period and by a correct decision output 123 when the loop delay time is over. When the polarity of the closed loop gain is reversed, the non-linear error comparator 118 and linear error detector 101 will still make a mistake for half of the oscillation period. But during the loop delay period when the non-linear error comparator 118 and linear error detector 101 is making a mistake, the non-linear error comparator 118 and linear error detector 101 will actually pump the final error correction output 115 into the right direction by mistake and when the loop delay time period is over, the non-linear error comparator 118 or linear error detector 101 will start to make a correct decision to pump the final error correction output 115 into the wrong direction. As a result, it really does not matter what the polarity of the closed loop gain is when the closed loop gain is infinite. The non-linear feedback control loop will always produce a correct final error correction output 115 for half of the time and incorrect final error correction output 115 for the other half of the time of the oscillation period.

The oscillation of the first order non-linear feedback loop 116 and 120 will cause the final error correction output 115 to ramp up or down as shown in the FIG. 8 to modulate the feedback module 105 and the feedback output signal 112 will be modulated by the oscillation of the loop. The acquisition behavior of the first order non-linear feedback control loop 120 and 116 as shown in FIG. 8 can be divided into two phases, the acquisition phase 542 and the oscillation phase 564. The loop will enter the oscillation phase 564 once the error input signal 114 becomes zero for the first time. Although the polarity of the closed loop gain is irrelevant for the non-linear feedback control loop 120 and 116 when the non-linear feedback control loop 120 and 116 is operated in the oscillation phase 564, the polarity of the closed loop gain still must be correct during the acquisition phase 542 otherwise the non-linear feedback control loop 120 and 116 will never enter the oscillation phase 564 and will stay in either the H or L state forever.

The non-linear feedback control loop 120 and 116 always requires a reference input signal 110 to start the oscillation and the loop 120 and 116 will produce a modulated feedback output signal 112 from the reference input signal 110. Without the reference input signal 110, the final error correction output 115 of the non-linear feedback control loop 116 and 120 will stay in the L state forever. With the arrival of the reference signal input 110, the non-linear feedback control loop 116 and 120 will start to oscillate and the period of the oscillation will be determined by the total loop delay time and the oscillation signal of the loop 116 and 120 will be affected by the broadband noises inside the loop 116 and 120 around the decision threshold 164 of the non-linear error comparator 118 and linear error detector 101 so that the start and stop point of each cycle of the modulation signal is determined by the noise and is different. In contrast, the oscillation of a linear feedback control loop 100 can only occur to the frequency that produces a closed loop gain of precisely −1 and when a linear feedback control loop 100 oscillates, it does not require any reference input signal 110 and the oscillation is narrowband since it is usually very difficult, if not impossible, to maintain a close loop gain of −1 over a wide bandwidth.

The oscillation of the non-linear feedback control loop 116 and 120 is broadband in nature. This is because the ramping of the final error correction output 115 will change direction to modulate the feedback module 105 randomly due to the intrinsic noises of the non-linear feedback control loop 116 and 120. The ramping of final error correction output 115 will change direction at a different time for every cycle of the modulation signal. The bandwidth of the oscillation of the non-linear feedback control loop 116 and 120 is determined by the bandwidth of the loop filter. Although the oscillation frequency of the non-linear feedback control loop 116 and 120 is determined by the total delay time around the loop 116 and 120, the spread of the oscillation is mainly determined by the loop filter.

The oscillation behavior of the non-linear feedback control loop 116 and 120 is also determined by the characteristic of the decision threshold 164 of the non-linear error comparator 118 and linear error detector 101. If the decision threshold 164 of the non-linear error comparator 118 and linear error detector 101 is precise without ambiguity, then the ramping of the final error correction output 115 can only cause the non-linear error comparator 118 and linear error detector 101 to change the polarity of the decision output 123 after the feedback signal 112 has caused the error input signal 114 to cross over the decision threshold 164. Since the error input signal 114 must cross over the decision threshold 164 of the non-linear error comparator 118 and linear error detector 101 to trigger a change of decision output 123, the final error correction output 115 must ramp longer or at least for the same amount of time as the ramping during the previous loop delay time period to correct the feedback signal 112 by at least the same amount of error that was made during the previous loop delay time period. As a result, the time period of the second ramping of final error correction output 115 will be very likely to last longer than the first ramping and the third ramping of the final error correction output 115 will also be very likely to last longer than the second ramping. Likewise, every subsequent ramping will be very likely to last longer than the previous ramping so that the period of the ramping of the final error correction output 115 will very likely grow longer cycle after cycle all the time.

If the non-linear error comparator 118 and linear error detector 101 is not precise and has a large uncertainty window, then the decision output 123 from the non-linear error comparator 118 and linear error detector 101 can abruptly change the polarity whenever the error input signal 114 falls within the uncertainty window. The output of the non-linear error comparator 118 and linear error detector 101 can be H even though the error input signal 114 is still negative and can be L even though the error input signal 114 is still positive. Since these kinds of erroneous decision is usually very short-lived because the probability that the next decision output 123 from the non-linear error comparator 118 and linear error detector 101 is still in error is low, the output from the non-linear error comparator 118 and linear error detector 101 can bounce between H and L quickly when the error input signal 114 is within the uncertainty window. As a result, a non-linear error comparator 118 and linear error detector 101 with an uncertainty decision window can produce a lot of hasty, noisy and erroneous decision outputs 123 and the final error correction output 115 will not be able to grow easily because these erroneous decisions will cancel out each other and also because each ramping of the final error correction output 115 does not need to last longer than the previous ramping to cause the non-linear error comparator 118 and linear error detector 101 to switch the decision output 123. The non-linear error comparator 118 and linear error detector 101 can now switch the decision output 123 whenever the error input signal 114 is within the uncertainty window. In contrast, for a precise non-linear error comparator 118 and linear error detector 101 without decision ambiguity, the error input signal 114 must always cross over the decision threshold 164 to cause the non-linear error comparator 118 and linear error detector 101 to switch the decision output 123. As a result, it will be much harder for a non-linear error comparator 118 and a linear error detector 101 with a large uncertainty window to grow the final error correction output 115 to modulate the feedback module 105.

The effectiveness of spreading on the spread spectrum clock output 109 depends totally upon the modulation waveform on the final error correction output 115 to module the feedback module 105. Ideally, the modulation waveform on the final error correction output 115 should be random in amplitude, frequency and phase. Only a modulation signal with random amplitude, frequency and phase can produce the highest possible spreading loss for the spread spectrum clock output. This ideal modulation waveform has been very difficult to produce until now. The next best alternative is to produce a modulation signal with random amplitude, frequency and phase on top of a deterministic modulation signal on the final error correction output 115 signal. The effectiveness of this solution depends totally upon the ratio of the amplitude of the random signal to the amplitude of the deterministic signal. The least effective alternative is to use a constant deterministic modulation signal on the final error correction output 115 which is also currently the most popular technology. So it is quite evident that our goal to design a perfect spread spectrum clock generator with a non-linear feedback control loop 116 and 120 is to control the modulation waveform on the final error correction output 115 so that the modulation signal becomes as much as random in amplitude, frequency and phase as possible.

A growing modulation signal on the final error correction output 115 can produce a perfect spreading for the spread spectrum clock generator easily because the growing of modulation signal can not last forever and at some point of time, the growing process will either be reset or stopped. If the growing process is stopped, the modulation signal on the final error correction output 115 will then fluctuate within some level due to the intrinsic noise of the loop. Since the amplitude of the modulation signal on the final error correction output 115 can only fluctuate within some range, the spreading of the clock will not be perfect. If the growing process of the modulation signal on the final error correction output 115 is reset, then a new growing process can restart again from small amplitude; as a result, the amplitude, frequency and phase of the modulation signal on the final error correction output 115 can become completely random. A growing modulation signal, that is reset regularly and randomly, on the final error correction output 115 can produce a perfect modulation signal on the final error correction output 115 to modulate the feedback module 105 to produce a perfect spread spectrum output signal 112.

The growing of the modulation signal on the final error correction output 115 is determined by two factors. The first factor is the accuracy and precision of the decision threshold 164 as explained earlier. The second factor is the slew rate of the ramping of the final error correction output 115. If the slew rate of the ramping on final error correction output 115 is slow, then the changes occur to the feedback signal 112 during the loop delay time period can be smaller than the amount of random noise around the decision threshold 164. As a result, the noise around the decision threshold 164 can easily wipe out the changes occurred to the feedback signal 112 during the loop delay time period; the growing of modulation signal on the final error correction output 115 will then be difficult. To produce a growing modulation signal on the final error correction output 115, we need to increase the slew rate of the ramping on the final error correction output 115 so that the feedback signal 112 will be changed by an amount larger than the uncertainty caused by the noise around the decision threshold 164. The ratio of the amount of noise around the decision threshold to the amount of changes occurred during the loop delay period determines whether if the growing of the modulation signal on the final error correction output 115 will continue to be long enough to produce a reset signal to reset the modulation signal on the final error correction output 115.

As explained in great detail in the PCT application “Arrival-time Locked Loop”, for a second order feedback control loop that tracks two variables, such as an arrival-time locked or PLL, the multiplication product of the open loop gain and the feedback module determines how fast the loop can steer the feedback signal 112 or how fast the feedback signal 112 can slew. The acquisition behavior of the second order non-linear feedback control loop is slightly different from the first order non-linear feedback control loop as explained above and the acquisition behavior of the second order non-linear feedback control loop will be discussed in the section of the non-linear arrival-time locked loop.

For most applications, the linear feedback control loop 100 is all we ever need. The linear feedback control loop 100 can help us regulate a noisy input signal or to reduce the fluctuation of a system. The linear feedback control loop 100 can provide us a clean signal from a noisy source. The application of linear feedback control loop 100 is everywhere in our daily life.

The concept of non-linear feedback control loop 120 and 116, however, is relatively new and is just the opposite of the linear feedback control loop 100. A non-linear feedback control loop 120 and 116 is always unstable and it can provide us an unpredictable feedback output signal 112 from a clean stable reference signal 110. The non-linear feedback control loop 116 and 120 has been quite useless to us only until now when the spread spectrum technology becomes popular and useful to help the electronic products satisfying the FCC regulations. The non-linear feedback control loop 116 and 120 is the best method to generate a true spread spectrum clock signal with random modulation due to its unstable nature and the availability of intrinsic broadband random noises.

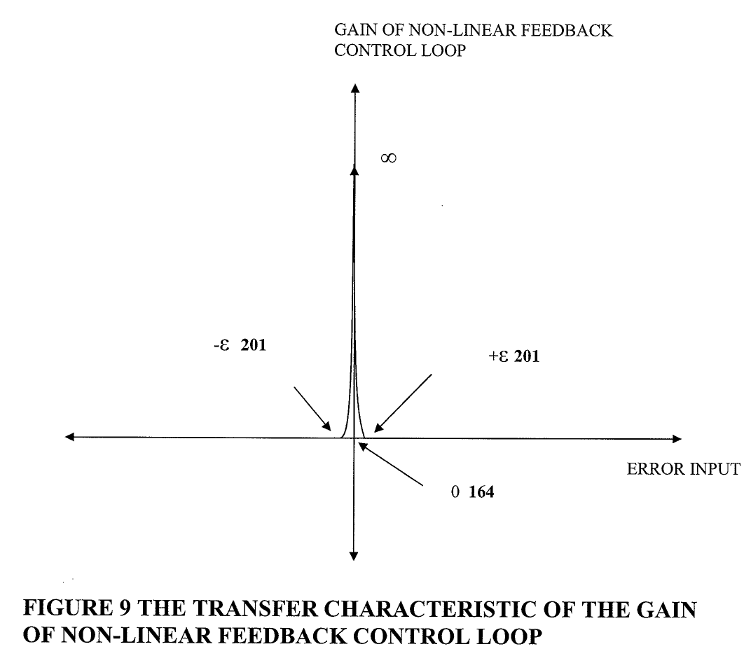

For a non-linear feedback control loop 116 as shown in FIG. 5 using a non-linear error comparator 118 or a non-linear feedback control loop 120 as shown in FIG. 6 using a linear error detector 101 with an amplifier with infinite gain to produce a non-linear final error correction output 115 with the transfer characteristics as shown in FIG. 7, since the gain of a system can be obtained by taking the derivative of the output of the system with respect to the input of the system, we can plot the gain of the non-linear feedback control loop 116 and 120 by taking the derivative of the final error correction output 115 as shown in FIG. 7 with respect to the derivative of error input signal 114 and the result is plotted in FIG. 9. Since the non-linear feedback control loop 116 and 120 can only produce positive loop gain within a very small range of +/−201 of error input signal 114, the non-linear feedback control loop 116 and 120 will always produce a feedback signal 112 that tracks the reference input signal 110 within this small error range of +/−201. The size of 201 is completely determined by the noise bandwidth of the system. The feedback signal 112 will always fluctuate around the reference input signal 110 within the small error range of +/−201.

Since the non-linear error comparator 118 can only produce an output in either an H or L state regardless of the amount of error input signal 114, the non-linear error comparator 118 can be treated as a linear error detector with infinite gain and the output of the non-linear error comparator 118 can be named as the decision output 123 to better describe its bipolar nature. As a result, the feedback module 105 will always be either pushed in one way or pulled in another way and the final error correction output 115 to the feedback module 105 will be always ramping up and down and the system 116 and 120 will never be stable. Although using a loop filter with a large time constant as the forward module 163 can prevent the non-linear error comparator 118 and linear error detector 101 from correcting the feedback module 105 quickly so that the noise bandwidth of the loop is small and the non-linear feedback control loop 116 and 120 can actually behave like a linear feedback control loop 100 to produce a stable feedback signal 112 because the error range of +/−201 is so small; but in essence, the non-linear feedback control loop 116 and 120 is still unstable. Since the loop gain of the non-linear feedback control loop 116 and 120 is infinite, the feedback signal 112 will always track the reference input signal 110 precisely as shown in equation 2. This unique feature makes the non-linear feedback control loop 116 and 120 very attractive and makes the non-linear feedback control loop 116 and 120 far superior to the linear feedback control loop 100. For example, a linear automatic frequency control circuit (AFC) will never produce a feedback signal 112 at the same frequency as the reference input signal 110 but a non-linear frequency locked loop can do that easily, just like a regular second order arrival-time locked loop. Since the non-linear frequency locked loop is a first order loop that needs to track only a single variable, it will take much less time for a non-linear frequency locked loop to acquire and lock the reference signal 110 than a second order arrival-time locked loop.

Since a signal has three independent variables, the amplitude, frequency and phase, we can produce a first order non-linear feedback control loop 116 and 120 by regulating any one of the three independent variables. Or we can produce a second order non-linear feedback control loop by regulating the arrival-time of the signal. As a result, there are four different ways to produce a spread spectrum clock signal from a stable reference input clock signal 110 by using the non-linear feedback control loop. Since a non-linear feedback control loop can be built in two different ways by either using a non-linear error comparator 118 or a linear error detector 101, there could be a total of eight different designs for the spread spectrum clock generator by using the non-linear feedback control loop. Since the principles of the non-linear error comparator 118 and the principles of the linear error detector 101 with an amplifier with infinite gain are the same, we will only address the design using non-linear error comparator 118 due to its simplicity unless the design using linear error detector 101 produces a different result.

### Non-Linear Amplitude Locked Loop

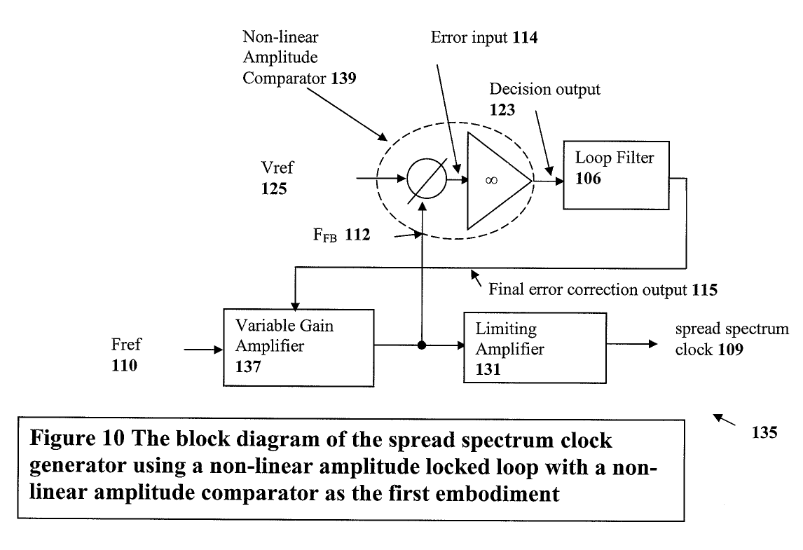

The block diagram of the non-linear amplitude locked loop 135 using non-linear amplitude comparator 139 as a spread spectrum clock generator can be shown in FIG. 10 as the first embodiment. The non-linear amplitude locked loop 135 is made of four building blocks, the non-linear amplitude comparator 139, the variable gain amplifier 137, loop filter 106 and the amplitude limiting amplifier 131. The non-linear amplitude comparator 139 compares the amplitude of the feedback signal 112 with a constant reference voltage 125. If the amplitude of the feedback signal 112 is less than the constant reference voltage 125, the non-linear amplitude comparator 139 will send out H output to increase the gain for the variable gain amplifier 137; if the amplitude of the feedback signal 112 is larger than the constant reference voltage 125, the non-linear amplitude comparator 139 will send out L output to reduce the gain for the variable gain amplifier. Since it takes time from the moment the decision output 123 is generated from the non-linear amplitude comparator 139 until the amplitude of the feedback signal 112 at the input of non-linear amplitude comparator 139 is updated, the variable gain amplifier 137 will always be over-corrected and oscillations at the decision output 123 from the non-linear amplitude comparator 139 is inevitable. After passing through the loop filter 106, the digital decision output signal 123 from the non-linear amplitude comparator 139 becomes the analog final error correction output 115 to modulate the variable gain amplifier 137. The gain of variable gain amplifier 137 will always be pumped up or down by the final error correction output 115 and the time that the gain of the variable gain amplifier 137 changes the direction of pumping totally depends upon the noises in the loop around the decision threshold 164 of the non-linear amplitude comparator 139. The decision threshold 164 of the non-linear amplitude comparator is determined by the voltage reference 125. Since a small noisy perturbation around the decision threshold 164 of the non-linear amplitude comparator 139 can trigger the non-linear amplitude comparator 139 to switch the direction to pump the variable gain amplifier 137, the non-linear amplitude comparator 139 will not switch the direction at the same time for every oscillation cycle. As a result, the final error correction voltage 115 to the variable gain amplifier 137 will always be ramping up and down linearly to produce a feedback output signal 112 with amplitudes always ramping up and down and the moment the amplitude of the feedback output signal 112 changing the direction of ramping is random. An amplitude limiting amplifier 131 can then be used to translate the amplitude variations of the feedback output signal 112 into phase variations so that the output of the amplitude limiting amplifier 131 is the desired spread spectrum clock signal 109 which has the same frequency as the reference input signal 110 but the phase of the spread spectrum clock signal 109 is always slewing between ahead and behind the phase of reference input signal 110. The time constant of the loop filter 106 determines how fast the phase of the spread spectrum clock output 109 can vary and also how much the phase of the spread spectrum clock 109 can spread.

It is difficult to produce a perfect spread spectrum clock output 109 from the non-linear amplitude locked loop 135 because the growing of modulation signal on final error correction output 115 to modulate the feedback module 137 of the non-linear amplitude locked loop 135 is very limited since the whole loop can only be operated at the same frequency and using an amplitude limiting amplifier 131 to generate the phase modulation through AM-PM conversion is also very inefficient because the range of phase modulation output is limited. Since the propagation delay time and latency delay time around the non-linear amplitude locked loop 135 is relatively short, the modulation signal of the final error correction output 115 on the feedback module 137 usually has a very high frequency to produce small phase spread.

There are two ways to increase the phase spread for the non-linear amplitude locked loop 135, by either using a voltage comparator with hysteresis as the non-linear amplitude comparator 139 or using a digital switch to sample the output from the non-linear amplitude comparator 139 so that the decision output 123 from the non-linear amplitude comparator 139 can only be updated at a certain rate, preferably at the rate of reference input signal 110. Using a voltage comparator with a hysteresis as the amplitude comparator 139 will prevent the decision output 123 to be changed too quickly so that the final error correction output 115 must force the error input signal 114 to travel across some range before the decision output 123 can be switched. Using a digital switch to sample the output from non-linear amplitude comparator 139 is the more effective way to produce longer loop delay time since the decision output 123 can only be updated at a fixed rate. Once a new decision output 123 is generated, it will remain at the same state until when non-linear amplitude comparator 139 of the non-linear amplitude locked loop 135 produces a different result in the next comparison cycle. Both solutions can greatly increase the loop delay time for the non-linear amplitude locked loop 135 and to slow down the modulation signal on the final error correction output 115 to the feedback module 137 to produce more spread for the spread spectrum clock output 109. Since the whole non-linear amplitude locked loop 135 is operated at the same frequency, it is very easy to sample the output from the non-linear amplitude comparator 139.

The non-linear amplitude locked loops 135 as shown in FIG. 10 is very similar to the traditional AGC circuit to produce an output signal with stable amplitude from an input signal with large amplitude fluctuations. The only differences between the AGC circuit and spread spectrum clock generator 135 as shown in FIG. 10 are the reference input signal 110 and the loop filter 106. For an AGC circuit, the amplitude of the reference input signal 110 is fluctuating and the time constant of the loop filter 106 is usually moderate to large depending upon the nature of the amplitude fluctuations of the reference input signal 110 so that the amplitude of the feedback output signal 112 does not fluctuate. In contrast, for a spread spectrum clock generator 135, the amplitude of the reference input signal 110 is very stable and the time constant of the loop filter 106 is usually small so that the amplitude of the feedback output signal 112 can fluctuate rapidly and randomly.

The transfer characteristic of the variable gain amplifier 137 is normally linear so that the gain of the amplifier 137 is controlled by the linear ramping of the final error correction output 115 linearly. With a linear variable gain amplifier 137, the non-linear amplitude locked loop 135 can only produce random phase spread for the spread spectrum clock output signal 109. Since the phase of a signal is equal to the integration of frequency of the signal over time, a frequency spread will always provide far more spread than the phase spread. As a result, the spreading of the spread spectrum clock output signal 109 generated from the non-linear amplitude locked loop 135 using a linear variable gain amplifier 137 will be very small as compared to the system that produces frequency spread.

To improve the spreading of the spread spectrum clock 109 generated from the non-linear amplitude locked loop 135, we need improve the transfer characteristic of the variable gain amplifier 137. If the transfer characteristic of the variable gain amplifier 137 is a square function of the final error correction output 115, instead of linear function, then the linear ramping on the final error correction output 115 will produce a feedback output 112 from the variable gain amplifier 137 with amplitude that varies according to the square function of time. Since the accumulated phase change of a signal with linear frequency ramping over a time period is proportional to the square function of time, the variable gain amplifier 137 with a square function transfer characteristic can effectively improve the spreading of the spread spectrum clock output 109 of the non-linear amplitude locked loop 135 from phase spread into frequency spread and significantly improve the effectiveness of the spreading.

### Non-Linear Arrival-Time Locked Loop

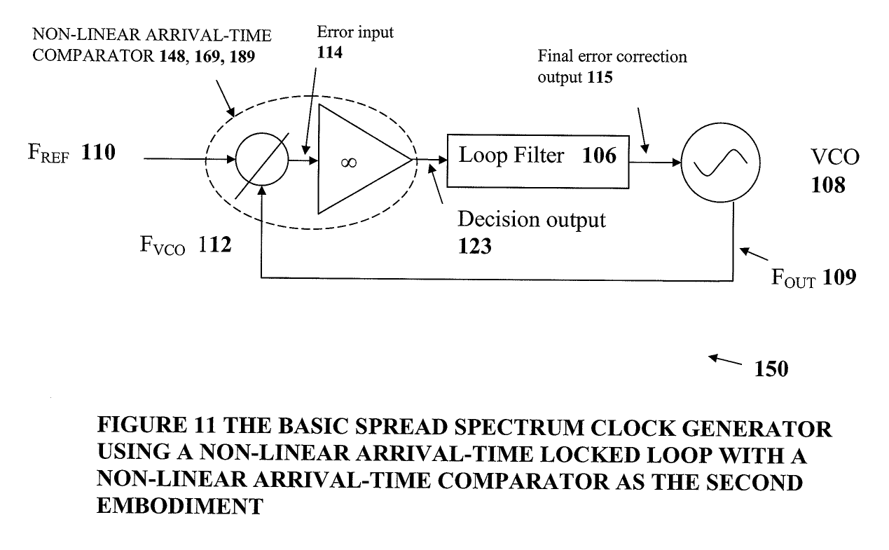

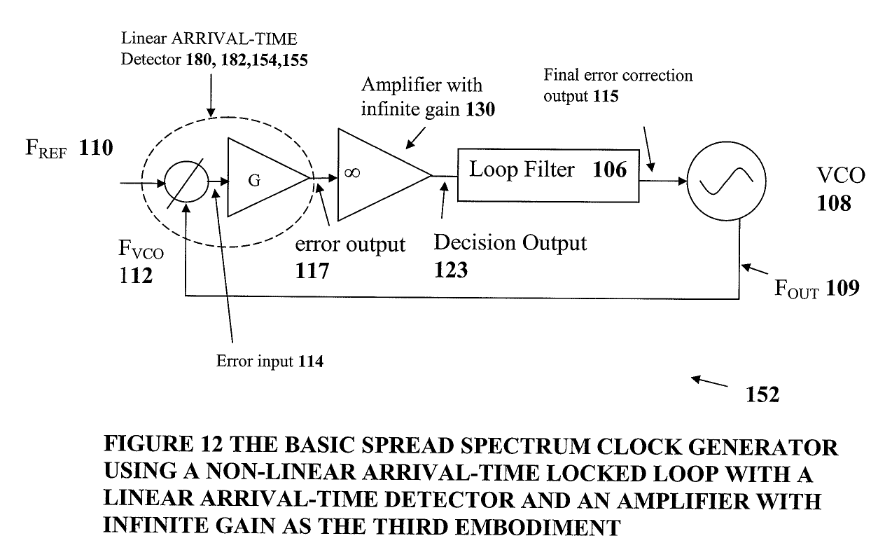

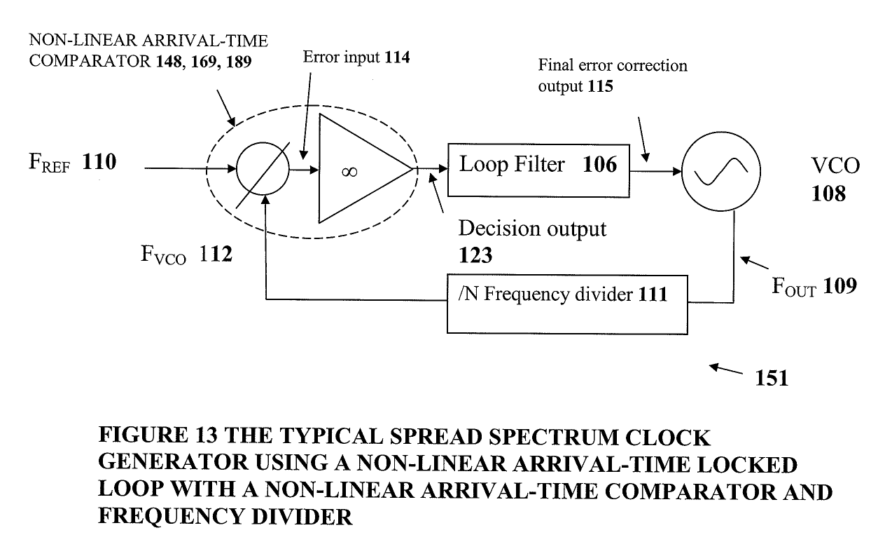

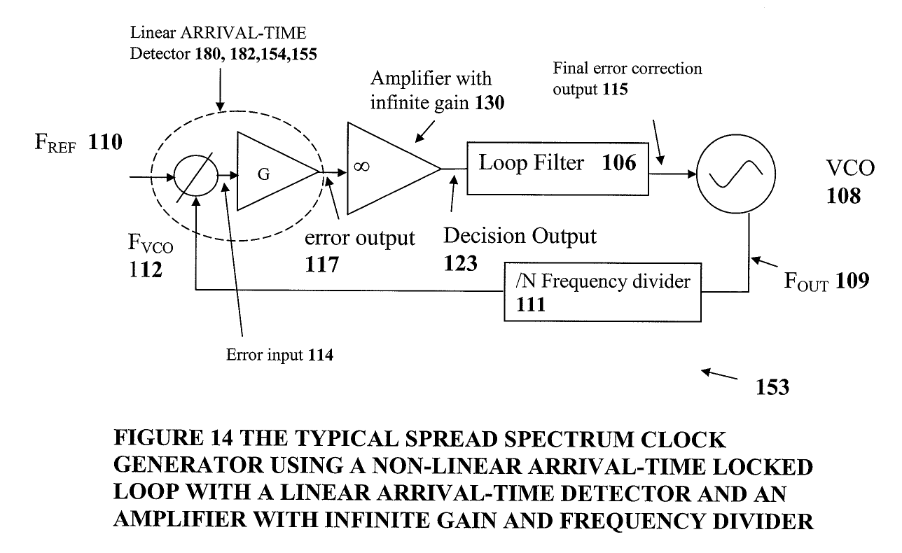

The block diagrams of a spread spectrum clock generator 150 using a basic non-linear arrival-time locked loop with a non-linear arrival-time comparator is shown in FIG. 11 as the second embodiment and the block diagram of a spread spectrum clock generator 152 using a basic non-linear arrival-time locked loop with a linear arrival-time detector and an amplifier with infinite gain is shown in FIG. 12 as the third embodiment. The basic non-linear arrival-time locked loop 150 is made of three functioning blocks, the non-linear arrival-time comparator (148, 169 and 189), the loop filter 106 and the VCO 108 and the basic non-linear arrival-time locked loop 152 is made of four functioning blocks, the linear arrival-time detector (180, 182, 155 and 154), the loop filter 106, the amplifier with infinite gain 130 and the VCO 108. Both of the basic non-linear arrival-time locked loops 150 and 152 are rarely used for spread spectrum clock generation because the frequency of the spread spectrum clock output signal 109 must be always equal to the frequency of the reference input signal 110; however, the frequency of the spread spectrum clock output signal 109 usually needs to be adjustable in most spread spectrum clock applications. To satisfy this requirement, a divide-by-N frequency divider 111 can be used to produce a lower frequency feedback comparison signal 112 to be compared with the reference input signal 110 so that the frequency of the spread spectrum clock output signal F_{OUT} 109 is N times the frequency of the reference input signal 110 and the frequency of the spread spectrum clock output signal 109 can be changed easily. The typical non-linear arrival-time locked loop with a frequency divider 151 and 153 as shown in FIGS. 13 and 14 are thus more useful as a spread spectrum clock generator to produce a spread spectrum clock output signal 109. The use of divide-by-N frequency divider 111 can also add more propagation delay and latency delay to the feedback signal path so that the frequency of modulation signal on the final error correction output 115 to the VCO is lower and produces more spreading for the spread spectrum clock output 109.

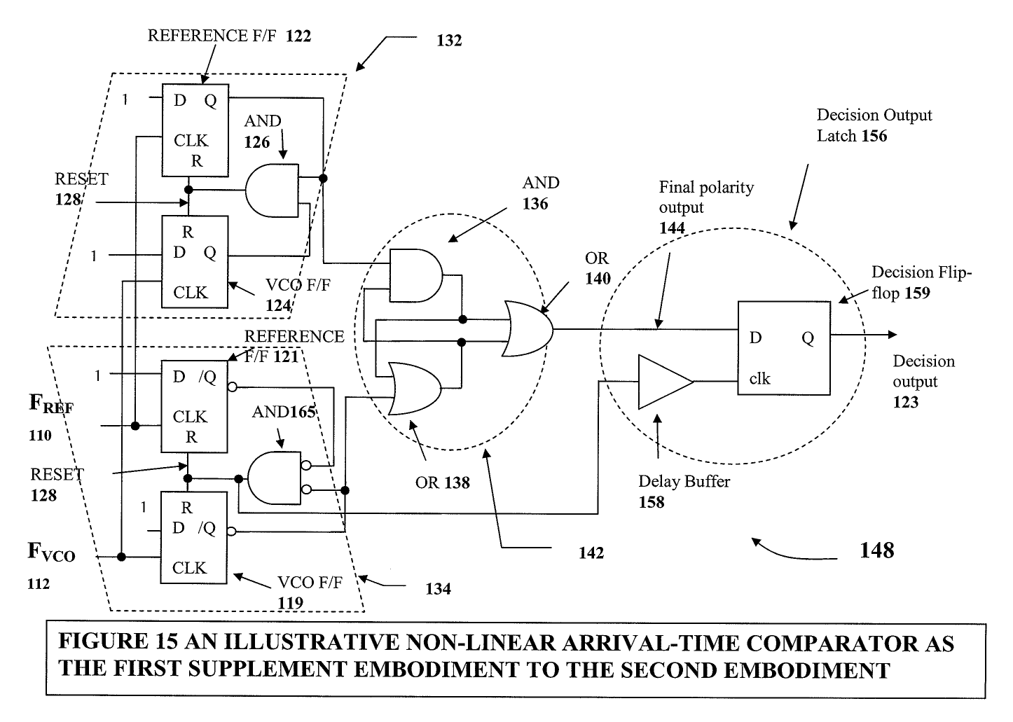

A typical non-linear arrival-time comparator 148 can be shown in FIG. 15 as the first supplement embodiment to the second embodiment and it is made of four building blocks, the PFD 132, the complementary PFD 134, the polarity selection circuit 142 and the decision output latch 156. The principle of the non-linear arrival-time comparator 148 is to use a PFD 132 and a complementary PFD 134 to detect the arrival of each input signal and provide two arrival signals, a positive arrival signal generated from PFD 132 trigger by the arrival of the reference input signal 110 and a negative arrival signal generated from the complementary PFD 134 trigger by the arrival of the feedback signal 112 from VCO, for the polarity selection circuit 142 to choose from. The polarity selection circuit 142 then selects the first arrival signal as the final polarity output signal 144. Once a final polarity output signal 144 is selected and after the arrival of both input signals, the final polarity output signal 144 will be stored into the output latch 156 to become the decision output 123 and the decision output 123 will remain at the same state until when the next comparison cycle produces a different result. The arrival-time comparison cycle begins when the first arrival signal arrives and it ends when the late arrival signal arrives. Both the PFD 132 and complementary PFD 134 will be reset after the arrival-time comparison cycle is completed. The presence of reset signal 128 indicates the end of arrival-time comparison cycle.

The use of reset output signal 128 to trigger the decision output latch 156 can be safe and precise without error since the final polarity output signal 144 always lasts longer than the reset output signal 128. The reset output signal 128 will occur when a complete comparison cycle has occurred and the late arrival signal has arrived and a final polarity output 144 has been determined. The reset output signal 128 can then safely clock out the final polarity decision output 144 from the decision output latch 156 without error. The delay buffers 158 provide the needed delay for the clock signal to the decision output latch 156 to ensure that the safe triggering condition for the decision output latch 156 is not violated. The delay buffer 158 can guarantee that the rising edge of the clock input at the decision flip-flop 159 is always happening about half-way between the end of the final polarity signal 144 and the beginning of the reset signal 128.

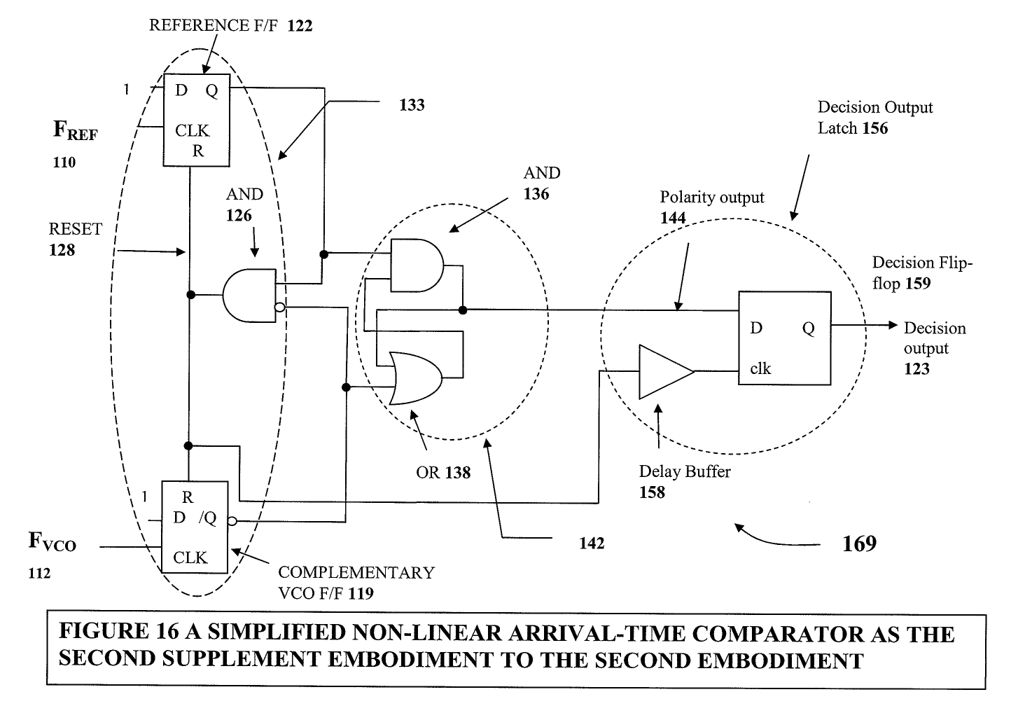

The two PFDs used in the design of FIG. 15 can be merged together into a mixed PFD 133 as shown in FIG. 16 as the second supplement embodiment to the second embodiment 169 to save some hardware. The saving of hardware is possible because although each of the PFD 132 and the complementary PFD 134 in FIG. 15 produces two arrival output signals so that a total of four arrival output signals are produced, only two of these four arrival output signals are needed for the polarity selection circuit 142 to choose from. The other two of the arrival output signals are simply redundant and can be eliminated. Since both the PFD 132 and the complementary PFD 134 are triggered by the same input signals, we can simply merge them together without affecting the operation of each other.

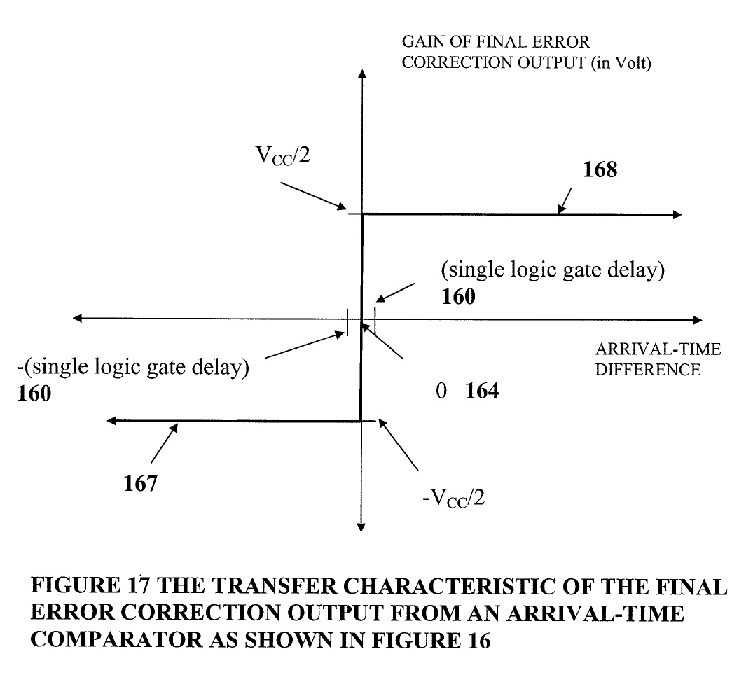

The transfer characteristic of the final error correction output 115 of the non-linear arrival-time locked loop 150 with a non-linear arrival-time comparator 169 can be shown in FIG. 17 having a decision threshold 164 located at the zero arrival-time difference point with an uncertainty window of +/−(propagation delay time of a single logic gate) 160. The uncertainty window around the decision threshold 164 is caused by the feedback arrangement between the AND logic gate 136 and the OR logic gate 138 of the polarity selection circuit 142.

The feedback arrangement between the AND 136 and OR 138 logic gate of the polarity selection circuit 142 can do two things. First, it can block the late arrival signal to prevent it from switching the final polarity output 144 once the final polarity output 144 is asserted by the first arrival signal. When the positive arrival signal from the PFD 132 arrives first, the output of the AND 136 becomes H and it will force the OR 138 to become H. Likewise, when the negative arrival signal from the complementary PFD 134 arrives first, the output of the OR 138 logic gate becomes L and it will force the AND 136 to become L. As a result, the late arrival signal can't change the final polarity output 144 once the first arrival signal has determined the state for the output of AND 136 and OR 138 logic gates. The first arrival signal will determine the polarity of the final polarity output signal 144 of the polarity selection circuit 142 and the final polarity output signal 144 will stay that way until the flip-flops are reset at the end of the arrival-time comparison cycle. The final polarity output 144 will also be stored into the decision output latch 156 as the decision output 123 before the flip-flops are reset and the decision output 123 will remain the same state until the new comparison cycle produces a different final polarity output 144. Secondly, the feedback arrangement provides a final polarity output signal 144 that lasts as long as the arrival output signal from the flip-flop of the PFDs so that the time period of the final polarity output signal 144 will be always longer than the actual arrival-time difference between the two input signals. Since the arrival-time difference between the two input signals can be anywhere from zero to infinity, it will be very difficult to clock the final polarity output signal 144 if the final polarity output signal 144 has a time period exactly equal to the difference of arrival-time between the two input signals and when the arrival-time difference between the two input signal is near zero. Luckily, since the arrival output signal from the flip-flops of PFD always lasts longer than the arrival-time difference between the two input signals by the delay time which is equal to the sum of the propagation delay time of the flip-flop from the reset input and the propagation delay of AND gate 126, the arrival output signal of the flip-flop is guaranteed to have a minimum time period so that it is ideal to be used as the final polarity output signal 144.

The feedback mechanism in the polarity selection circuits 142 chooses the first arrival signal, either the positive arrival output from the normal flip-flop 122 triggered by the arrival of the reference signal 110 or the negative arrival output from the complementary flip-flop 119 triggered by the arrival of feedback signal from VCO 112, as the final polarity output signal 144. So the final polarity output signal 144 will have a minimum width that is equal to the sum of the propagation delay of the flip-flop from the reset input plus the propagation delay of the AND 126 gate. With this minimum width, the final polarity decision output signal 144 will thus be safer to be clocked out by the reset signal 128 from the decision output latch 156.

The feedback mechanism of the polarity selection circuit 142 nevertheless produces an uncertainty window of +/−(propagation delay time of a single logic gate) 160 around the decision threshold 164 for the non-linear arrival-time comparator 169. This is because when the arrival-time difference between the two input signals is within the propagation delay of a single logic gate, the output from the AND 136 and OR 138 logic gate is not ready to block the late arrival signal completely so that the final polarity output 144 of the polarity selection circuit 142 can bounce throughout the whole period of the final polarity output signal 144. During this uncertain bouncing period, the safe triggering condition for the decision output latch 156 no longer exists and the output of the decision output latch 156 becomes random especially when the arrival-time difference is approaching the decision threshold 164. This randomness of decision around the decision threshold 164 can produce many hasty, incorrect final polarity decision outputs 123.

The polarity selection circuit 142 as shown in FIG. 15 includes an extra OR logic gate 140. This OR 140 logic gate can reduce the uncertainty range of the polarity decision by half because the final polarity output 144 will always remain H all the time as long as the reference input signal 110 arrives earlier. When the reference input signal 110 arrives earlier and the arrival-time difference between the two input signals is less than the propagation delay time of a single logic gate, the output from the AND 136 and OR 138 logic gates will still bounce; nevertheless, the final polarity output 144 at the OR 140 gate will remain H all the time since it can remain H as long as either one of the input to the OR logic gate 140 is H. As a result, the decision threshold 164 of the polarity selection circuit 142 as shown in FIG. 15 is shifted to the negative side by the amount of half of the propagation delay time of a single logic gate and the decision uncertainty is limited to the range of arrival-time difference between 0 and −(propagation delay time of a single logic gate) 160.

The randomness of the decision output 123, when the error input signal 114 is within the uncertainty window around the decision threshold 164 of the non-linear error comparator 118 and the linear error detector 101, is the source of the spread spectrum clock generation. Nevertheless, when the error input signal 114 is within the decision uncertainty window of the non-linear error comparator 118 and the linear error detector 101, the randomness of the decision output 123 should only affect the time to switch the polarity decision output 123 and the non-linear error comparator 118 and linear error detector 101 should not produce an incorrect polarity decision output 123 to affect the final error correction output 115. But in the design of the non-linear arrival-time comparator 169 as shown in FIG. 16, the polarity decision output 123 can be H when the error input signal 114 is negative and L when the error input signal 114 is positive. In the design of non-linear arrival-time comparator 148 as shown in FIG. 15, although the polarity decision output 123 will be guaranteed to be in the correct H state when the reference input signal 110 arrives earlier, the polarity decision output 123 can be either H or L when the reference signal 110 is behind the feedback signal 112. In both cases, the non-linear arrival-time comparators 148 and 169 can produce an erroneous decision output 123 to affect the final error correction output 115.

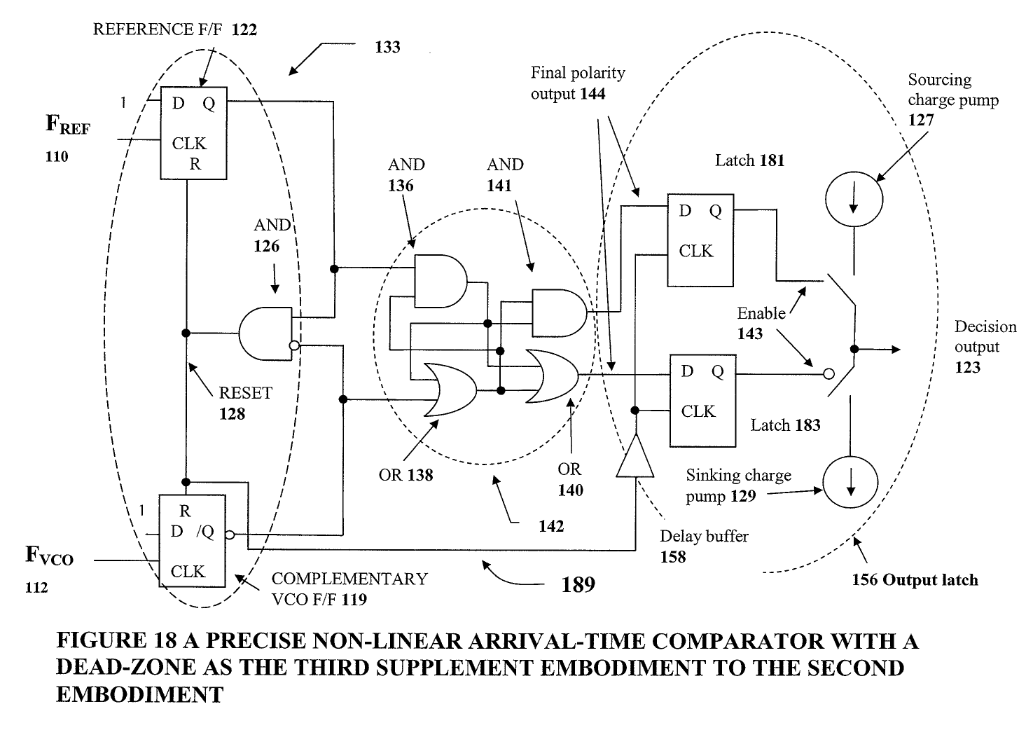

In order to overcome the accuracy problem of the decision output 123 from the non-linear arrival-time comparators in the designs as shown in FIGS. 15 and 16, a new non-linear arrival-time comparator 189 as shown in FIG. 18 is presented as the third supplement embodiment to the second embodiment. This new non-linear arrival-time comparator is made of three building modules, the mixed PFD 133, the polarity selection module 142 and the output latch 156. In this new design, two output latches 181 and 183 are driven by a polarity selection circuit 142 with an additional AND 141 and OR 140 gates to produce accurate final polarity outputs 144 for the polarity output latches 181 and 183. The final polarity output 144 of the OR 140 logic gate will remain in the default H state until when the feedback signal from VCO 112 arrives earlier. Likewise, the final polarity output 144 of the AND logic gate 141 will remain in the default L state until when the reference input signal 110 arrives earlier. With these two additional logic gates, the polarity of the decision output signal 123 is guaranteed to be always precise and will not generate erroneous decision output 123 to affect the final error correction output 115 even when the final polarity outputs 144 of the polarity selection circuit 142 are still bouncing.

When the feedback signal 112 from VCO is leading and the arrival-time difference between the two input signals to the non-linear arrival-time comparator 189 is less than the propagation delay of a single logic gate, the final polarity output 144 from the AND logic gate 141 will remain in the default L state so that the output latch 181 is guaranteed to produce no output and the final polarity output 144 from the OR logic gate 140 will bounce between H and L. Since the feedback signal 112 from VCO is the leading signal, the correct final polarity output 144 from the OR logic gate 140 should be L to enable the sinking charge pump 129. Fortunately, even if the final polarity output 144 from the OR logic gate 140 is clocked out incorrectly due to the uncertainty of bouncing decisions and the decision output latch 183 produces an erroneous H output instead of the correct L output, this mistake still produces no error for the decision output 123 since only an L output from the polarity latch output 183 can enable the sinking charge pump output 129.

When the reference input signal 110 is leading and the arrival-time difference between the two input signals to the non-linear arrival-time comparator 189 is less than the propagation delay of a single logic gate, the final polarity output 144 from the OR logic gate 140 will remain in the default H state so that the output latch 183 is guaranteed to produce no output and the final polarity output 144 from the AND logic gate 141 will bounce between H and L. Since the reference input signal 110 is the leading signal, the correct final polarity output 144 from the AND logic gate 141 should be H to enable the sourcing charge pump 127. Fortunately, even if the final polarity output 144 from the AND logic gate 141 is clocked out incorrectly due to the uncertainty of bouncing decisions and the decision output latch 181 produces an erroneous L output, this mistake still produces no error for the decision output 123 since only an H output from the polarity output latch 181 can enable the sourcing charge pump output 127.

As a result, when the error input signal 114 is slewing from positive side of the decision threshold 164 to negative side, the polarity of the decision output 123 of the non-linear arrival-time comparator 189 is guaranteed to remain in the H state until the error input signal 114 has crossed over the decision threshold 164 and into the negative side. After the error input signal 114 has crossed over the decision threshold 164, the decision output 123 can then turn to the correct L state randomly at any moment. Likewise, when the error input signal 114 is slewing from the negative side of the decision threshold 164 to positive side, the polarity of the decision output 123 of the non-linear arrival-time comparator 189 is guaranteed to remain in the L state until the error input signal 114 has crossed over the decision threshold 164 and into the positive side. After the error input signal 114 has crossed over the decision threshold 164, the polarity of decision output 123 can then turn into the correct H state randomly at any moment. In a conclusion, when the error input signal 114 is slewing across the decision threshold 164, the switching of the decision output 123 from the non-linear arrival-time comparator 189 will always take place after the error input signal 114 has crossed over the decision threshold 164 but never before. In contrast, for the non-linear arrival-time comparators 148 and 169 as shown in FIGS. 15 and 16, the switching of the decision output 123 can take place any moment when the error input signal 114 is within the uncertainty window. The non-linear arrival-time comparator 189 as shown in FIG. 18 is thus an accurate and precise arrival-time comparator without decision ambiguity and is the most desirable design for the non-linear arrival-time comparator.

When the final polarity output 144 from the polarity selection circuit 142 is bouncing and causing the non-linear arrival-time comparator 189 to produce an erroneous output at the polarity output latch 181 or 183, although this error is benign and it does not produce an erroneous decision output 123 to affect the final error correction output 115, the non-linear arrival-time comparator 189 is also unable to produce a correct decision output 123 to affect the final error correction output 115, neither. In other words, the non-linear arrival-time comparator 189 is literally dead when a wrong decision output is generated from the decision output latch 181 or 183. The non-linear arrival-time comparator 189 can thus be dead for half of the time when the error input signal 114 is within the decision uncertainty window since the chance that the polarity output latch 181 or 183 produces an erroneous output when the final polarity output 144 is bouncing is 50%. The effective size of the dead-zone of the non-linear arrival-time comparator 189 is thus equal to half of the decision uncertain window and is equal to +/−½(propagation delay time of a single logic gate) 160.

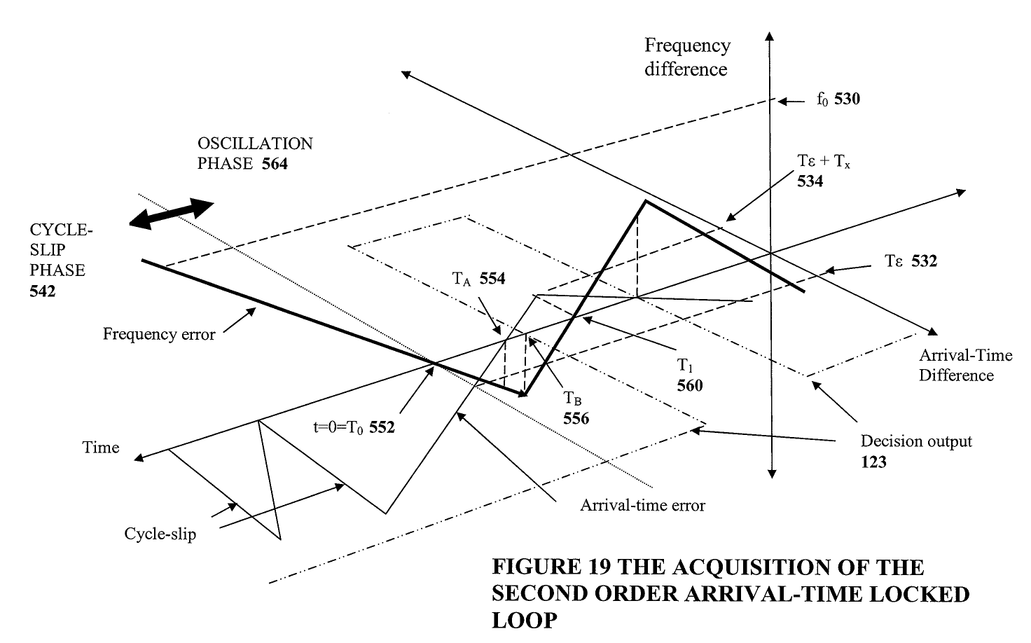

The acquisition process of the second order non-linear arrival-time locked loop 150 with non-linear arrival-time comparator 189 can be shown in FIG. 19. Since the non-linear arrival-time locked loop 150 is a second order loop, there are two variables to be tracked, the frequency and the arrival-time. The acquisition behavior of the second order arrival-time locked loop can only be presented in a 3-D plot with two vertical axial, one to indicate the acquisition of frequency and the other for the acquisition of arrival-time. The acquisition process of the non-linear arrival-time locked loop 150 can be divided into two phases, the acquisition phase 542 and oscillation phase 564. The acquisition phase 542 can be called as the cycle-slip phase 542 because there will be many cycle-slips occur during this period for the arrival-time locked loop. Assuming the initial frequency of the feedback signal from VCO 112 is way below the frequency of the reference signal 110 in the beginning of the acquisition process so that the initial frequency difference f₀ 530 is positive. The non-linear arrival-time comparator 189 will send out positive decision output 123 most of the time initially to speed up the frequency of VCO 108 to reduce the frequency difference. The arrival-time correction output to the VCO during the cycle slip phase 542 is in mostly H state because the reference signal 110 is running faster and arrives earlier all the time so that the decision output 123 of the non-linear arrival-time comparator 189 is H most of the time. As the frequency difference between the two input signals is being reduced during the cycle-slip phase 542, cycle slips can occur occasionally and the non-linear arrival-time comparator 189 can flip the polarity of decision output 123 into the negative side briefly when the cycle-slip occurs. Since the frequency of the reference signal 110 is always faster than the frequency of the feedback signal from VCO 112 during the cycle-slip phase 542, the duration that polarity output 123 becomes negative during the cycle-slip phase is always very brief so that the cycle-slip does not affect the acquisition of the signal.

When the frequency of the feedback signal from VCO 112 finally becomes the same as the frequency of the reference signal 110 for the first time occurring at time=T₀ 552, the acquisition process enters the oscillation phase 564. In this phase, the polarity of the arrival-time difference and the frequency difference will bounce between positive and negative all the time. In the beginning of the acquisition process when the polarity of the frequency difference between the two input signals is changed for the first time at t=T₀ 552, the arrival-time difference between the two input signals can be anywhere between 0 to the period of the feedback signal from VCO 112.

Assuming that the arrival-time difference between the two input signals is a positive T 532 when the frequency difference is zero for the first time at t=0 552, since the arrival-time difference is still positive, the non-linear arrival-time comparator 189 will continue to produce H output to speed up the feedback signal from VCO 112 to correct the arrival-time difference of T 532 which is completely random and can be anywhere between 0 and the period of the feedback signal from VCO 112. As a result, the frequency difference will now become negative after t=0 552 so that the feedback signal from VCO 112 is now running faster than the reference input signal 110. The final error correction output 115 to the VCO will continue to ramp up the frequency of the feedback signal from VCO 112 until eventually when the feedback signal from VCO 112 arrives at the same time as the reference signal 110 at T_{A} 554. After T_{A} 554, the frequency of VCO will still continue to be sped up due to the total loop delay time. When the total loop delay time is over, the frequency of the signal from VCO 112 may still continue to be sped up until the arrival-time difference at the input of the non-linear arrival-time comparator 189 finally crosses over the decision threshold 164 at t=T_{B} 556 and triggers the non-linear arrival-time comparator 189 to change the polarity of decision output 123. Only until this moment, which is determined by the noise around the decision threshold 164 of the non-linear arrival-time comparator 189, the non-linear arrival-time comparator 189 will now start to slow down the frequency of the feedback signal from VCO 112 by ramping down the final error correction 115 to the VCO. So before the non-linear arrival-time comparator 189 starts to slow down the frequency of feedback signal from VCO 112, the arrival-time difference between the two input signals has been over-corrected for at least the amount of total loop delay time and the time that the non-linear arrival-time comparator 189 starts ramping in the other direction is completely determined by the noise around the decision threshold of the non-linear arrival-time comparator 189.

Since the frequency of the VCO has been sped up all the time between t=0 552 and t=T_{B} 556 to correct the arrival-time difference of T 532, the frequency of the feedback signal from VCO 112 at t=T_{B} 556 is now much higher than the frequency of the reference signal 110 so that the feedback signal from VCO 112 will arrive earlier than the reference signal 110. As a result, the arrival-time difference will now remain in the negative side and the polarity of decision output 123 of the non-linear arrival-time comparator 189 is also switched to the negative side. The arrival-time difference between the two input signal will actually continue to increase and become more negative even as the frequency difference is being reduced between t=T_{B} 556 and T₁ 560 when the frequency difference finally becomes zero again for the second time. This is because since the frequency of the feedback signal from VCO 112 always runs faster than the reference signals 110 during the entire period between t=T_{B} 556 and t=T₁ 560, the arrival-time difference between the two input signals can only grow even more negative during this period and the arrival-time difference will reach the maximum at t=T₁ 560.

At t=T₁ 560, the frequency difference between the two input signal finally becomes zero again, but the arrival-time difference is now negative. Since the arrival-time difference was over-corrected before the non-linear arrival-time comparator 189 started to ramp down the final error correction output 115 at t=T_{B} 556, the arrival-time difference at the second time frequency difference becomes zero at t=T₁ 560 will be very likely more than the arrival-time difference T 532 when the frequency difference was zero for the first time at t=T₀ 552.

From the time t=T₀ 552 to t=T₁ 560, the frequency difference between the two input signals starts from zero and ends at zero again while the arrival-time difference starts from a positive difference and ends up with a negative difference, makes up the first oscillation cycle.

The same process will then repeat itself and every time the frequency difference becomes zero again, the polarity of arrival-time difference will alternate between positive and negative and the amount of arrival-time difference at the beginning of each oscillation cycle is very likely to increase slightly. The amount of increase in arrival-time difference at the new frequency synchronization point at the beginning of each oscillation cycle is equal to the sum of the arrival-time change occurred during the total loop delay time period and the random arrival-time error caused by the noises around the decision threshold 164. If the total loop delay time is long enough to cause a large arrival-time change that is much larger than the random arrival-time error caused by the noises around the decision threshold 164, then the arrival-time difference at the beginning of each new oscillation cycle will keep increasing cycle after cycle. If the arrival-time change during the loop delay time period is smaller than the random arrival-time error caused by the noises around the decision threshold 164, then the arrival-time difference at the beginning of each new oscillation cycle will not likely to increase but instead will simply fluctuate. So depending upon the how much the arrival-time of the feedback signal 112 from VCO can be changed during the loop delay period and how long the loop delay period is, eventually the arrival-time difference at the beginning of each oscillation cycle can be either stabilized to oscillate at a certain amount or the arrival-time difference becomes so long that a complete cycle of the feedback signal 112 is skipped and cycle-slip occurs. Once the cycle-slip occurs, the arrival-time difference at the beginning of the new oscillation cycle will become very small and the whole process of growing of arrival-time difference will repeat itself. When cycle-slip occurs to the feedback signal from VCO 112, since the arrival-time difference for each oscillation cycle now can vary from zero to a certain level, every cycle of the modulation signal on the final error correction output 115 will be very different. With the occurrence of cycle-clip, the non-linear arrival-time locked loop 150 with the non-linear arrival-time comparator 189 thus becomes a perfect spread spectrum clock generator because every cycle of the modulation of the clock signal starts from a random amplitude, frequency and phase and ends at another random amplitude, frequency and phase.

Whether if a non-linear arrival-time locked loop 150 can become a perfect spread spectrum clock generator or not depends totally upon its ability to grow the amount of arrival-time difference whenever the frequency difference becomes zero during the oscillation phase 564 until cycle-slip occurs. As explained earlier, the ability of to grow the amount of arrival-time difference totally depends upon the total loop delay time and the noise around the decision threshold 164 and the slew rate of the VCO 112. The non-linear arrival-time loop 150 can grow the amount of arrival-time difference easily if the decision threshold of non-linear arrival-time comparator is precise without ambiguity. Erroneous decision due to decision ambiguity can cancel each other so that it is harder to grow the arrival-time difference. The total loop delay time allows the non-linear arrival-time locked loop 150 to over-correct the arrival-time difference before the non-linear arrival-time comparator (148, 169 and 189) changes the direction of ramping for the final error correction output 115. As a result, a long loop delay time can guarantee the growth of arrival-time difference. Even if a non-linear arrival-time comparator (148 and 169) with a large decision uncertainty window is used, the growth of the arrival-time difference can still be sustained as long as the total loop delay time can produce more arrival-time difference than the decision uncertainty window. The slew rate of the VCO determines the amount of frequency change, or more precisely the arrival-time change, that the feedback signal 112 can occur during a fixed delay time period. If the arrival-time change during the loop delay period is less than the uncertainty range of the noise, then the growing process of the arrival-time difference will not be productive so that the arrival-time difference will simply fluctuate around a certain value at the beginning of each oscillation cycle.

Since the response time of the non-linear arrival-time comparator (148, 169 and 189) is fast and a decision output 123 can be generated as soon as the late arrival signal arrives, the non-linear arrival-time locked loop 150 inherently has a short propagation delay time which is approximately equal to the propagation delay of two flip-flops and three logic gates. The latency delay time of the non-linear arrival-time locked loop 150 is primarily determined by the period of the slower arrival-time comparison signal and the latency delay time is usually the dominant factor for the total loop delay time. As a result, the frequency spread of the spread spectrum clock output signal 109 from the basic non-linear arrival-time locked loop is usually small and cycle-slip to the feedback signal 112 from VCO will be difficult to produce because the frequency of the arrival-time comparison signals is usually high. The typical non-linear arrival-time locked loop 151 is thus a better design to produce a perfect spread spectrum clock output 109 due to the longer latency delay time through the frequency divider 111.

The non-linear arrival-time comparator 189, since it will never produce a new decision output 123 prematurely when the error input 114 is slewing across the decision threshold 164, can produce a large ramping to the final error correction output 115 easily to produce cycle-slips to the feedback signal 112 from VCO if it is given enough time. A long loop delay time for the non-linear arrival-time locked loop 151 can always effectively force the loop to produce cycle-slip to the feedback signal 112.

The easiest way to add more loop delay time to the non-linear arrival-time locked loop 150 is by adding frequency divider 111 in the feedback path. The simplest frequency divider to use is the asynchronous divide-by-two frequency divider by using a self-toggling flip-flop. Unfortunately, for every additional divide-by-two frequency divider we use, the latency delay time is also doubled and it is very difficult to obtain the desired delay time precisely by using simple divide-by-two frequency dividers. A programmable frequency divider is thus a better solution. As a result, a programmable frequency divider 111 in the feedback path of the non-linear arrival-time locked loop 151 can become a programmable frequency spread controller for the spread spectrum clock generator. We can adjust the amount of frequency spread easily by adjusting the amount of frequency division and of course, we also need to use the same programmable frequency divider for the reference signal 110 path as well so that the frequency of the arrival-time comparison signals remains the same when the frequency spread is adjusted. An automatic frequency spreading control system can thus be implemented easily.

The other alternative to add more loop delay time to the non-linear arrival-time locked loop 150 to increase the frequency spread for the spread spectrum clock output is to use a digital filter to delay the generation of a new decision. For example, we can store each decision output 123 from the non-linear arrival-time comparator 189 into an N bit shift registers sequentially and use an N bit adder to sum up all the stored decisions. We then make a final decision based on the result of the sum. For example, if the current final decision is H, we will turn the final decision into L only when the result of the sum becomes 0 and if the current final decision is L, we will turn the final decision into H only when the result of the sum become N. By this way, we build a delay into the decision making so that a new decision output change from H to L or L to H can only occur after at least N arrival-time comparison cycles have occurred. We can adjust the number of shift registers or decision threshold until the desired total loop delay time is produced. This technique allows us to use a high frequency comparison clock for the non-linear arrival-time comparator (148, 169 and 189) and still allows us to control the frequency spread of the clock signal in smaller step.

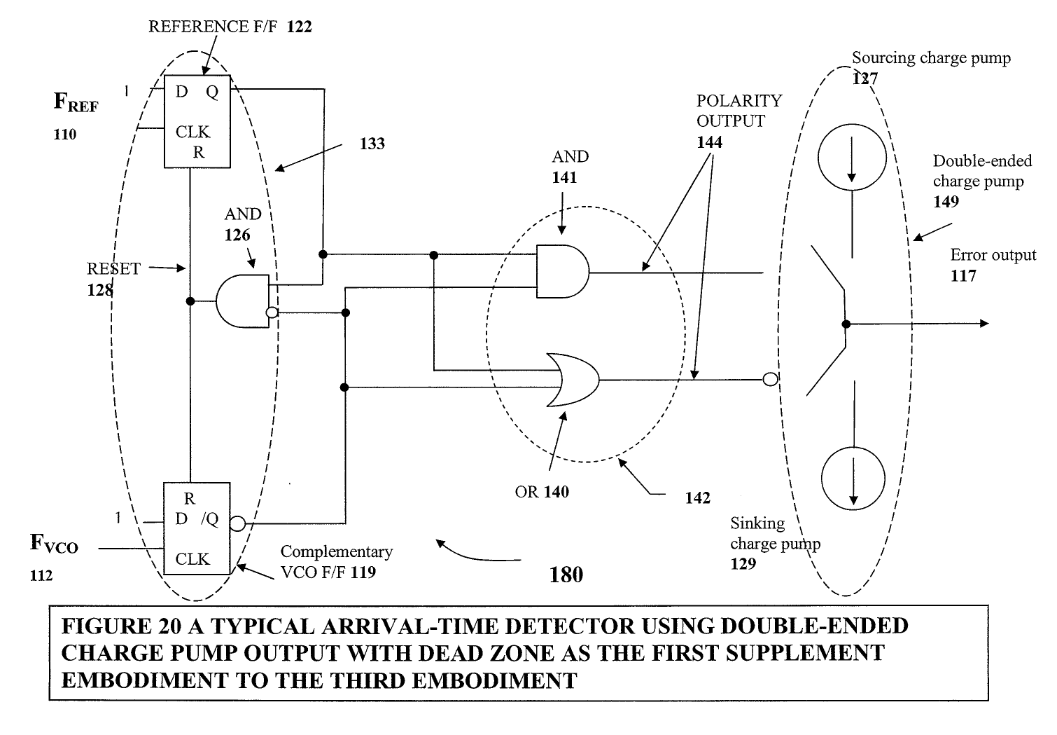

Four linear arrival-time detectors as illustrated in FIG. 20 to 23 can be used with an amplifier with infinite gain 130 as the non-linear arrival-time locked loop to become a spread spectrum clock generator 152. The linear arrival-time detectors can produce an error output 117 signal with the polarity determined by which signal arrives first and the error output 117 signal will be enabled for a period determined by the arrival-time difference between the two input signals so that the error output signal 117 of the linear error arrival-time detector will be charged up when the reference signal 110 arrives first and discharged down when the feedback signal from VCO 112 arrives first. Since the error output signal 117 can only be activated for a very brief moment and the stray capacitance at the error output node 117 holds the error output voltage 117 at the current voltage until the next comparison cycle, the charge pump output drivers must provide enough slew rate to ensure that the error output signal 117 can rise quickly. The leakage current of the stray capacitance must be controlled so that the leakage current will not discharge the error output voltage 117 when the charge pump output driver is not enabled. A larger capacitor might be needed to hold up the error output signal 117; however, a larger capacitor will slow down the slew rate of the charge pump and may create a dead zone. With the help of the amplifier with infinite gain 130, the decision output 123 at the output of the amplifier 130 as well as the final error correction output 115 can only stay in either H or L state and the loop becomes a non-linear arrival-time locked loop 152. The operation and the acquisition behavior of the non-linear arrival-time locked loop 152 using linear arrival-time detector 180, 182, 154 and 155, and an amplifier with infinite gain 130 is exactly the same as the non-linear arrival-time locked 150 using a non-linear arrival-time comparator 148, 169 and 189.

The arrival-time detector 180 as shown in FIG. 20 is made of three function blocks, the mixed PFD 133, the polarity selection circuit 142 and the double-ended charge pumps outputs 149. The mixed PFD 133 provides two arrival signals for the polarity selection circuit 142 to choose from as the final polarity output 144 to enable the charge pumps 149. With the use of a single-logic gate, AND 141 and OR 140, as the polarity selection circuit 142, the duration of the final polarity output signal 144 inevitably will be always equal to arrival-time difference between the two input signals. Since the arrival-time difference between the two input signals can be anywhere from 0 to infinity, the duration of the final polarity output 144 can also be 0 so that the double-ended charge pump output 149 will not be enabled until the arrival-time difference between the two input signals is longer than the time it needs to overcome the input threshold of the double-ended charge pump output driver 149 and a dead zone is produced for the error output 117 of the linear arrival-time detector 180.

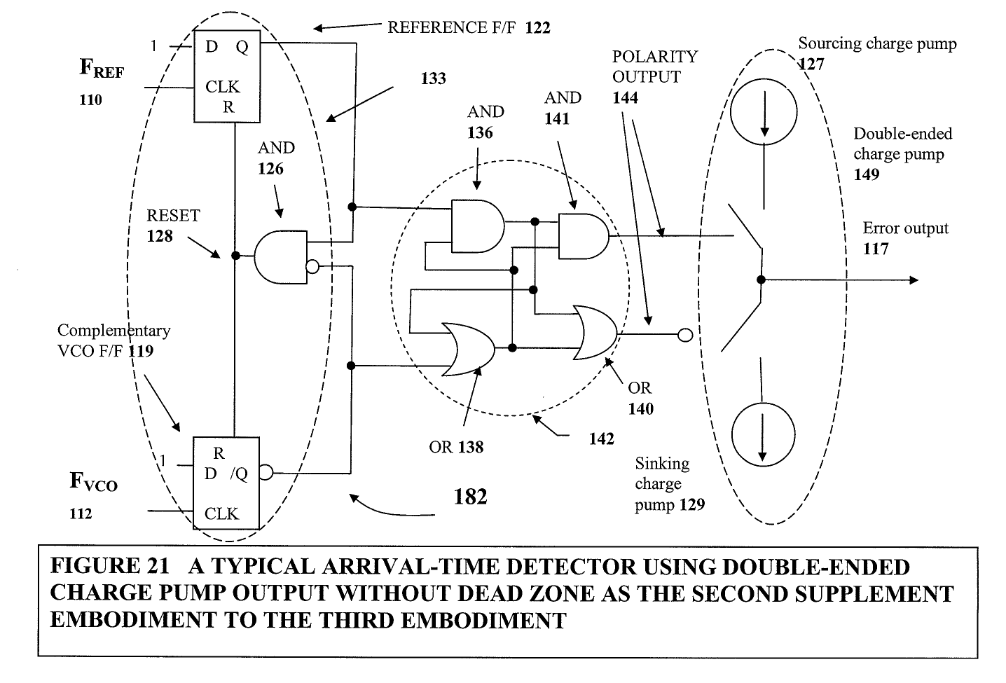

The dead zone of the linear arrival-time detector 182 as shown in FIG. 21 is completely eliminated by the adding of the feedback mechanism made of AND 136 and OR 138 logic gates to the polarity selection circuit 142. These two logic gate will produce a final polarity signal 144 with a minimum duration that is equal to the sum of the propagation delay time of the flip-flop from the reset input and the propagation delay of the AND 126 logic gate. This minimum duration is usually long enough to overcome the input threshold of the charge pump output 149 so that the dead zone does not exist anymore. Without the dead zone, the error output 117 from the arrival-time detector 182 can be enabled as soon as the error input signal 114 is crossing over the decision threshold 164. Without a dead-zone, the linear arrival-time detector 182 is thus more precise and is the best of all designs of the linear arrival-time detectors and non-linear arrival-time comparators.

Although the dead-zone can increase the latency delay time of the non-linear arrival-time comparator and linear arrival-time detector, the dead-zone is an undesired state of the linear error detector and non-linear error comparator since no output is generated during this period. Since the amount of phase shift a signal has traveled is equal the integration of frequency over the time period traveled, the accumulation of phase shift is a linear function of time when the frequency is a constant and the accumulation of phase shift will become a square function of time when the frequency itself is a linear function of time, such as the output signal from a VCO with a ramping tuning voltage. As a result, when the slewing of the final error correction output 115 is about to cause the error input signal 114 to cross over the decision threshold 164, the phase error between the two input signals is accumulated at the rate of T² before the error input signal 114 crosses over the decision threshold 164. After the error input signal 114 has crossed over the decision threshold 164 and during the dead zone period, the phase error can only be accumulated at the slower rate of T since no output is generated from the non-linear error comparator and linear error detector to speed up or slow down the frequency of the feedback signal from VCO 112. The rate of the spreading of phase is thus slowed before the direction of frequency slewing is changed. Without the presence of dead zone, the phase error will continued to be accumulated at the same faster rate of T² all the time, as a result, a linear arrival-time detector and a non-linear arrival-time comparator without dead-zone can produce a better and more evenly spread clock output 109. The presence of dead-zone can thus deteriorate the smoothness of power density of the clock spectrum so that the clock energy may have peaks and the spreading loss may become lower.

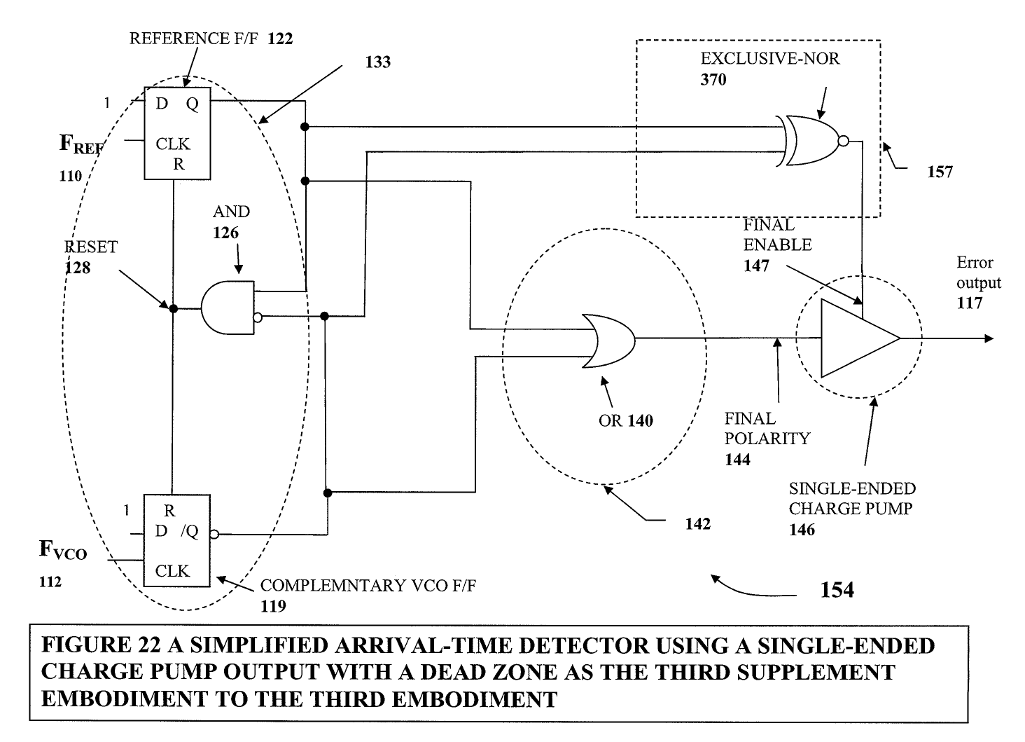

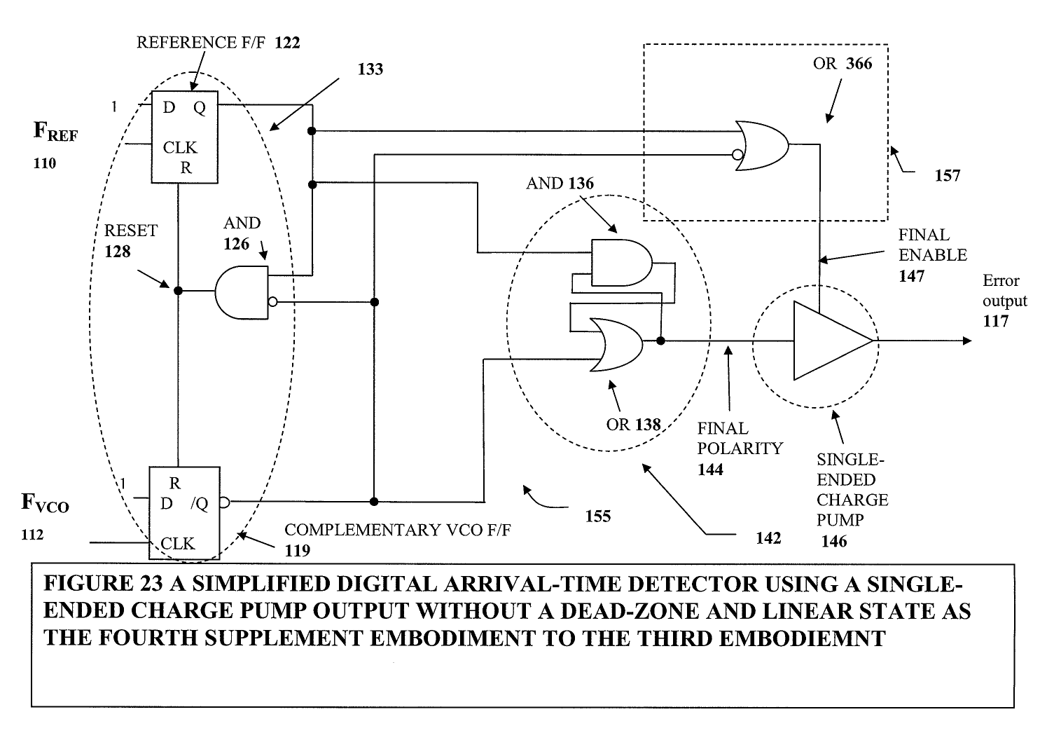

The design of the linear arrival-time detector 154 as shown in FIG. 22 is very much the same as the design as shown in FIG. 20 except that a single-ended charge pump output driver 146 is used instead of the double-ended charge pump 149. And the design of the linear arrival-time detector 155 as shown in FIG. 23 is also very much the same as the design as shown in FIG. 21 except that a single-ended charge pump 146 output driver is used instead of the double-ended charge pump output 149. The use of single-ended charge pump 146 does not affect the operation of the arrival-time detector in any way differently. The single-ended charge pump output driver requires two input signals, a polarity signal and an enable signal. The polarity signal determines the polarity of the output current while the enable signal determines how long to enable the output current.

### Non-Linear Phase Locked Loop

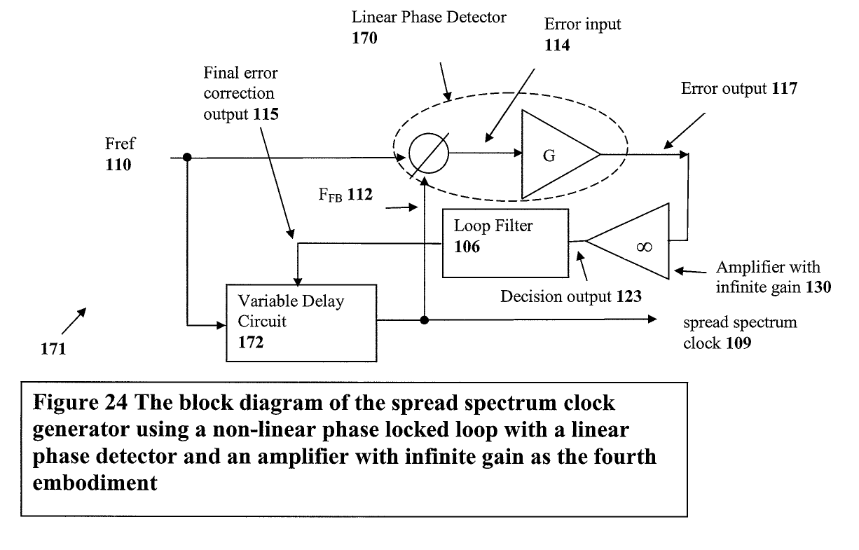

The block diagram of the non-linear phase locked loop 171 including a linear phase detector 170, loop filter 106, an amplifier with infinite gain 130 and a variable delay circuit 172 is shown in FIG. 24 as the fourth embodiment. Traditionally, in most linear phase locked loop applications, a VCO is usually used as the feedback module 105; however, the use of VCO will make the linear phase locked loop into an arrival-time locked loop because a VCO can change both the phase and frequency of the feedback signals 112 at the same time so that the arrival-time of the feedback signal 112 is the variable to be compared with by the error comparator, instead of the phase. A phase locked loop using a VCO as the feedback module 105 is no longer a phase locked loop any more! For a phase locked loop to be a pure phase locked loop, a variable delay circuit 172 should be used as the feedback module 105 to control the phase shift of the feedback signal 112 and the whole phase locked loop system can only be operated at the same frequency. This kind of pure phase locked loop is commonly known as delay locked loop.

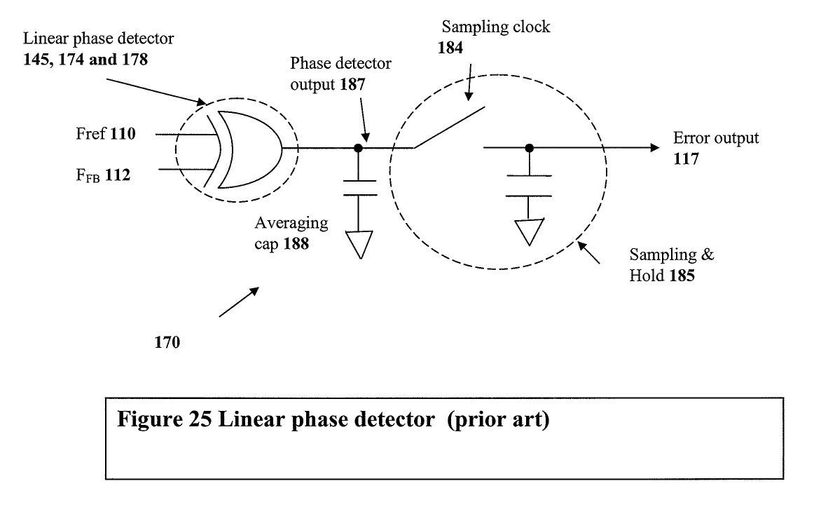

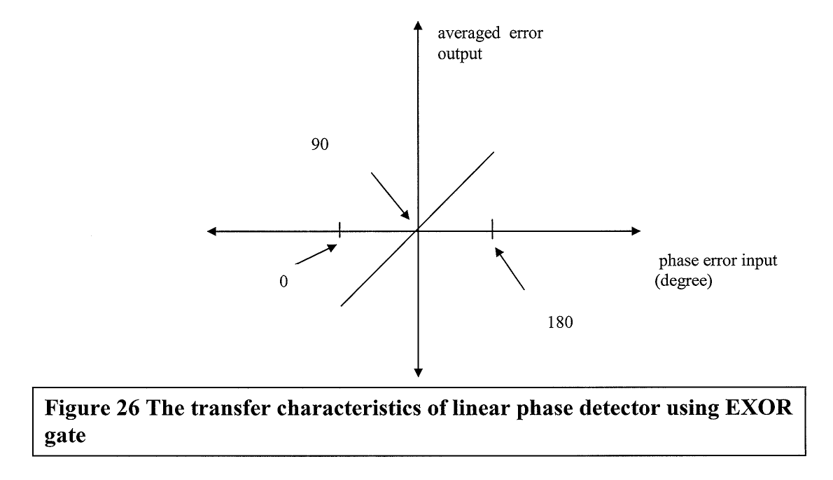

The simplest way to produce the non-linear phase locked loop 171 is to use a linear phase detector 170 with an amplifier with infinite gain 130 as shown in FIG. 24. The linear phase detector 170 can be built in many ways and the simplest way is to use an exclusive-OR gate 145 as shown in FIG. 25 as an analog linear phase detector. The exclusive-OR gate 145 provides a multiplication product from the two input signals and the averaged phase detector output 187 of the multiplication product at the end of phase comparison cycle indicates the phase relationship between the two input signals as shown in the FIG. 26. When the phase difference between the two input signals to the exclusive-OR gate 145 is 90 degrees, the averaged phase detector output voltage 187 on the averaging capacitor 188 is zero at the end of phase comparison cycle and the averaged phase detector output voltage 187 on the averaging capacitor 188 will become more positive at the end of phase comparison cycle as the phase difference is getting more than 90 degrees and more negative at the end of phase comparison cycle as the phase difference is getting smaller than 90 degrees. A sampling-and-hold circuit 185 is needed to produce the averaged error output voltage 117 at the end of the phase comparison cycle. A non-linear amplitude comparator 139 can then be used to the check the polarity of the averaged error output 117 and to determine whether if the phase difference between the two input signals is greater than 90 degrees or less than 90 degrees. A non-linear amplitude comparator 139 can be used as an amplifier with infinite gain 130 to produce the decision output 123 since it can only produce an output in two digital output states, either H or L. The non-linear amplitude comparator 139 can also be replaced by an OPAMP configured as an active low pass filter to provide the infinite DC gain for the loop.

The linear phase detector 170 as shown in FIG. 25 is very easy to understand and implement; however, the two input signals to the EXOR 145 must have a perfect 50% duty cycle all the time. A deviation of duty cycle from 50% will produce a net DC voltage at the phase detector output 187 on the averaging capacitor 188 so that the deviation of duty cycle from 50% can affect the accuracy of phase comparison. The other disadvantage of the analog linear phase detector 170 is that it requires many linear components and can take a lot of room inside an IC. And the most severe limit of the traditional analog linear phase detector 170 is that it has a small phase detection range of +/−90 degrees. A better phase detector is thus very desirable.

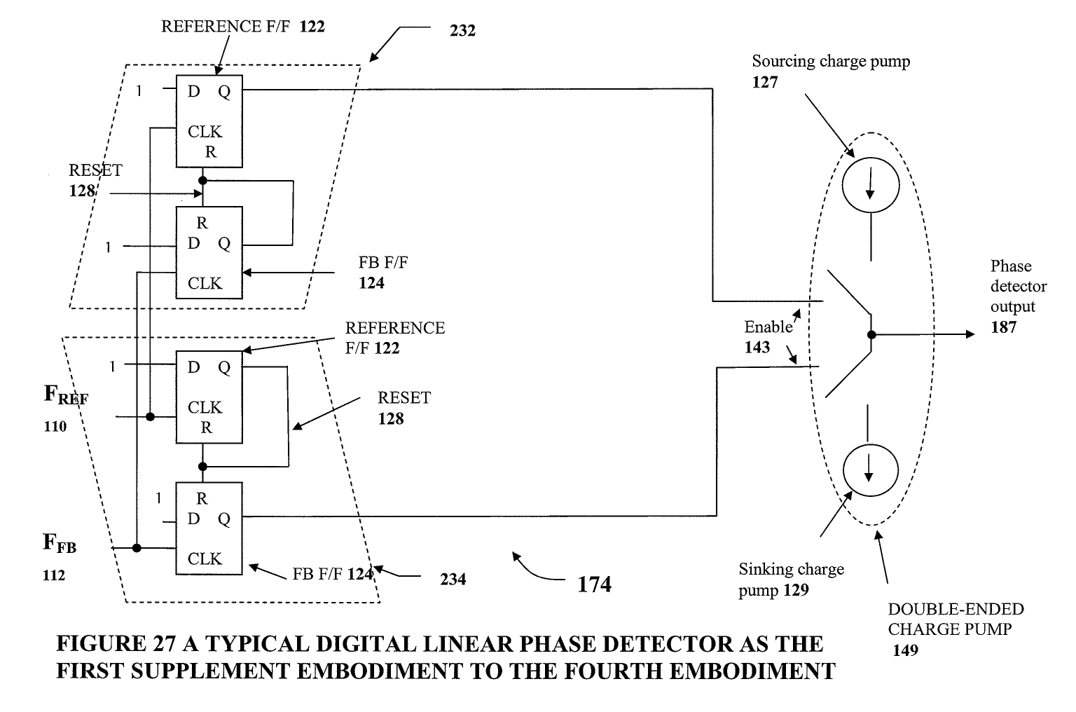

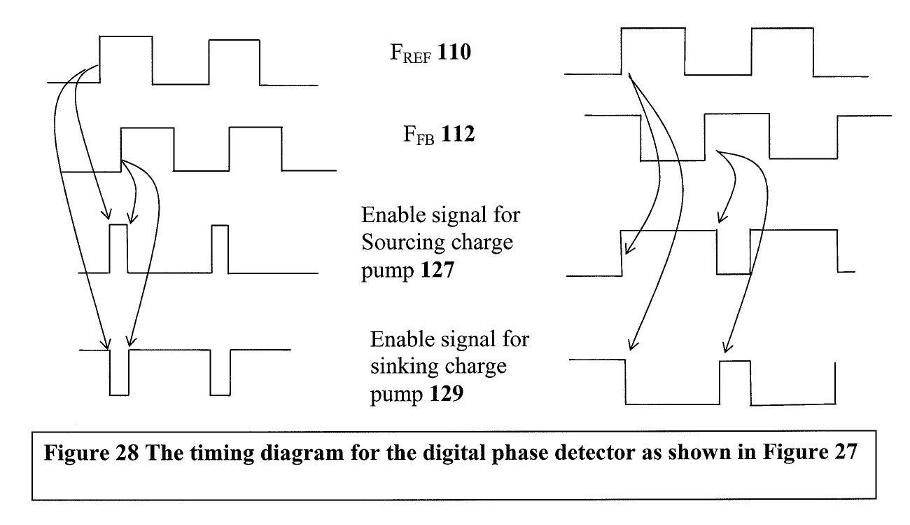

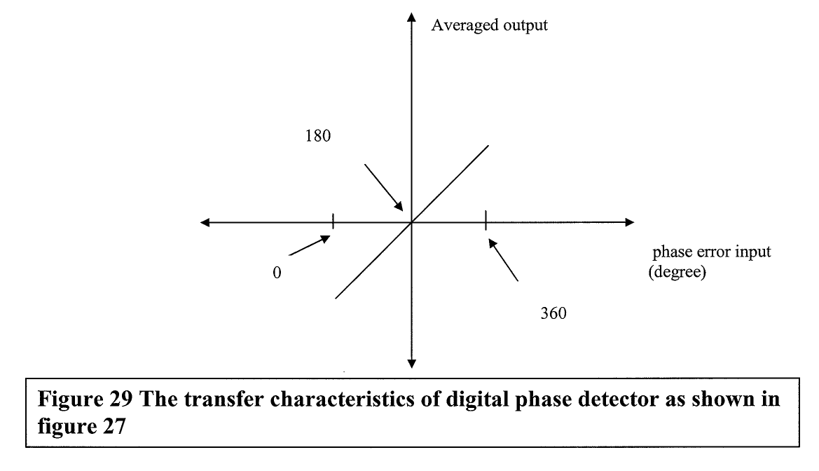

A new digital linear phase detector 174 as shown in FIG. 27 is presented to solve some of the problems of the analog linear phase comparator 170 due to the Exclusive-OR gate 145 as the first supplement embodiment to the fourth embodiment. The new digital linear phase detector 174 is made of four flip-flops and two charge pumps. The four flip-flops are grouped into two special PFD modules 232 and 234. These special PFD modules do not need an AND gate to reset the flip-flops. In a normal PFD, an AND logic gate is needed to generate the reset signal for the flip-flops so that both flip-flops are reset at the end of comparison cycle when the late arrival signal finally arrives. Without using the AND gate but using one of the output signals from the flip-flops as the reset signal for the PFD, we are forcing that signal to be the late arrival signal. For the PFD module 234, the reference signal 110 is always the late signal and for the PFD module 232, the feedback signal 112 is always the late signal. The operation timing diagram of this new digital linear phase detector 174 can be shown as in FIG. 28. Since the feedback signal 112 is the reset signal for the PFD 232, the sourcing charge pump 127 will be enabled for a time period equal to the phase difference between the feedback signal 112 and the previous reference signal 110. Since the reference signal 110 is the reset signal for the PFD 234, the sinking charge pump 129 will be enabled for a time period equal to the phase difference between the feedback signal 112 and the current reference input signal 110. When the feedback signal 112 is behind the reference input signal 110 by more than 180 degrees, the sourcing charge pump 127 will pump up the averaged phase detector output voltage 187 for a period longer than the sinking charge pump 129 to sink down the averaged phase detector output voltage 187 so that the averaged phase detector output voltage 187 is positive at the end of phase comparison cycle. When the feedback signal 112 is behind the reference signal 110 by less than 180 degrees, the sinking charge pump 129 will sink down the average phase detector output voltage 187 for a period longer than the sourcing charge pump 127 to pump up the averaged phase detector output voltage 187 so that the averaged phase detector output voltage 187 is negative at the end of the phase comparison cycle. Since the flip-flops are operated by the edges of the clock input, the duty cycle of the clock is irrelevant and the digital linear phase detector 174 can detect all the phase error of +/−180 degrees as shown in FIG. 29.

The digital linear phase detector 174 is thus a better design than the analog linear phase detector using EXOR gate 145 as the linear phase detector 170. This kind of digital linear phase detector 174 is commonly known as type II phase detector. Nevertheless, in both the analog 145 and digital 174 designs for the linear phase detector 170 as presented above, the decision of phase error can be made only at the end of the phase comparison cycle. This is because in both designs, we actually used two reference signals 110 with different phases to measure the phase of the feedback signal 112. In the design of analog linear phase detector using Exclusive-OR gate 145, the rising edge and falling edge of the reference signal 110 are the phase references and the decision threshold 164 of the analog linear phase comparator 145 is half way between the rising edge and falling edge of the reference signal 110. Since the rising edge of the reference signal 110 is 0 degree and the falling edge of the reference signal 110 is 180 degrees, assuming the reference input signal 110 has a perfect 50% duty cycle; the decision threshold 164 of the analog linear phase comparator 145 is precisely 90 degrees in phase. In the design using digital linear phase detector 174, the rising edge of the current reference signal 110 and the rising edge of the previous reference signal 110 are the two reference signals. Since the rising edge of the current reference signal 110 is 360 degree and the rising edge of the previous reference signal 110 is 0 degrees, the decision threshold 164 of the phase comparison is half way between these two signals and is precisely 180 degrees in phase. In both designs, the decision threshold 164 of the phase comparison was never generated explicitly. The decision for the error output 117 can be produced only after the outputs from both reference signals are averaged out by the averaging capacitor 188. As a result, both phase detectors 145 and 174 requires a long latency delay time since a decision can't be made until the phase detector's output is averaged out at the end of the phase comparison cycle and both the analog 145 and digital 174 linear phase detectors with an amplifier with infinite gain 130 are analog phase comparators and require a sample-and-hold circuit 185 to produce the final phase comparison error output 117 at the end of the phase comparison cycle. The sampling clock 184 for the sampling-and-hold circuit 185 can be produced from the reference input clock 110 since it determines the phase references. The sampling clock 184 also provides the latency delay time to the non-linear phase locked loop.

We can improve the latency delay time of the analog phase comparators if we can make the decision of phase by comparing only a single reference signal 110 with a single feedback signal 112 with a non-linear phase comparator 176. The non-linear phase comparator 176 is not very popular because it is harder to define the phase references for phase comparison. The phase of the signal is quite different from the other characteristics of the signal. The phase of the signal can only be ranged from 0 to 360 degrees and the phase of a signal can be interpreted differently. For example, a signal A that is behind another signal B by 100 degrees can also be interpreted as a signal A is ahead of the other signal B by 260 degrees. In order to prevent confusion, the phase difference between two signals is usually limited to be no more than 180 degrees so that, as in the previous example, the signal A is declared to be behind the signal B by 100 degrees.

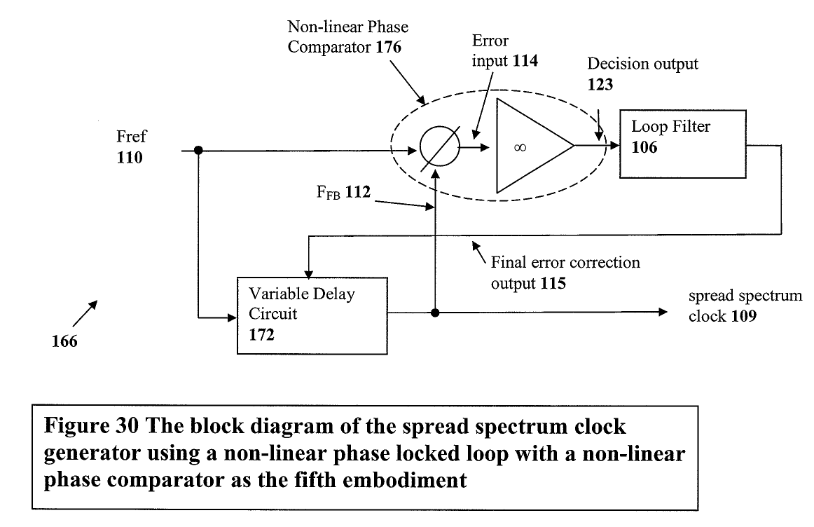

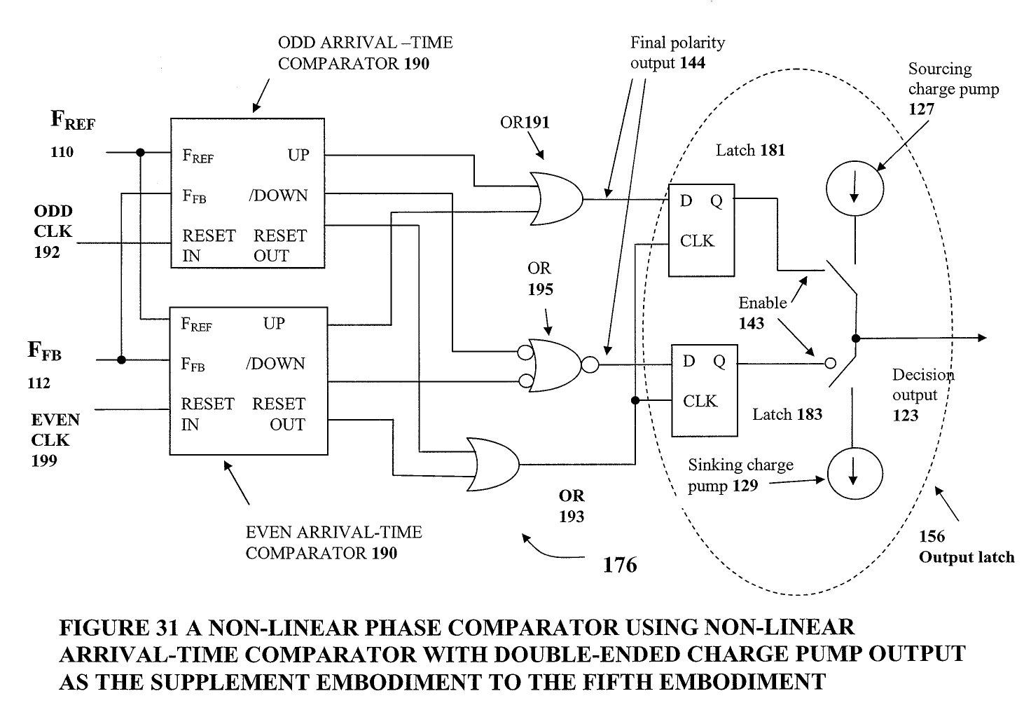

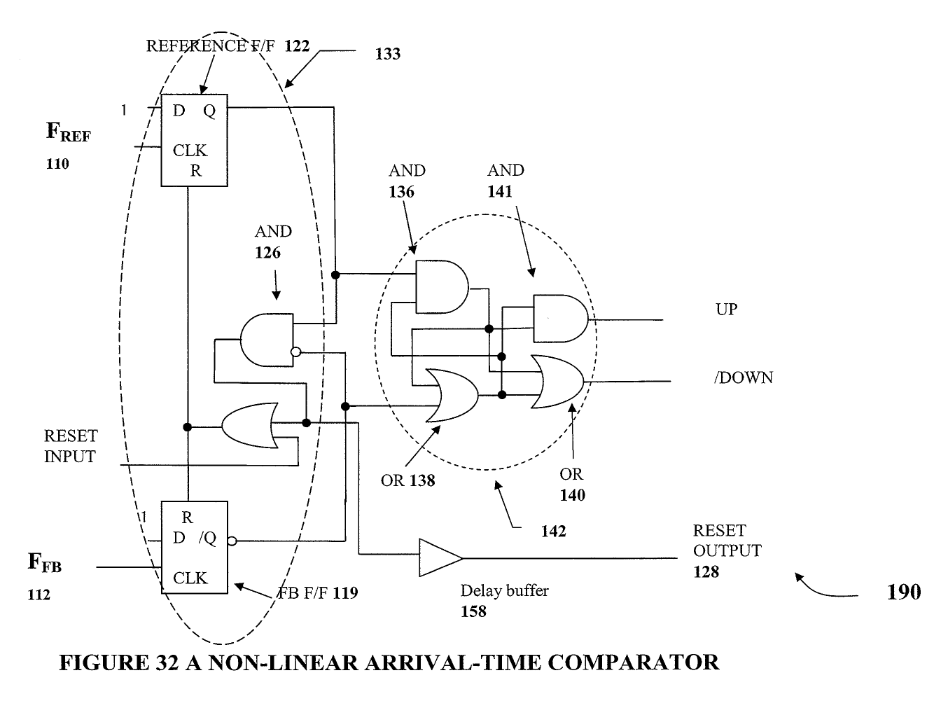

The block diagram for a non-linear phase locked loop using non-linear phase comparator 176 as a spread spectrum generator 166 is shown in FIG. 30 as the fifth embodiment. Since a non-linear arrival-time comparator is also capable of detecting the phase difference between two signals easily, it is ideal to be used for the non-linear phase comparator 176. Nevertheless, we need to clearly define the range of phase for the non-linear arrival-time comparator so that the non-linear arrival-time comparator is always properly reset before making the phase comparison. A new digital design of non-linear phase comparator 176 capable of detecting phase difference in the whole range of +/−180 degrees with minimum latency delay time and can be made completely with digital components is presented as shown in FIG. 31 as the supplement embodiment to the fifth embodiment. This new non-linear phase comparator 176 is built with two non-linear arrival-time comparators 190 shown in FIG. 32.

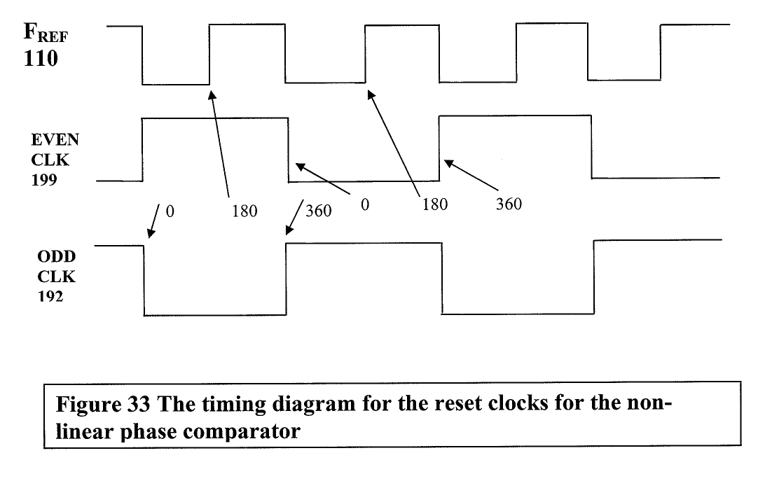

In this new design, we need to provide two streams of reset clock with opposite phase for each of the two arrival-time comparators 190. The reset clock should be generated from the falling edges of the reference signal input 110 so that the rising edge of the reference signal input 110 is located exactly half way between the edges of the reset clocks as shown in FIG. 33. We will call the two reset clocks, the even clock 199 and the odd clock 192. When the even clock 199 is H, the even arrival-time comparator will remain in the default state while the odd clock will be L and the odd arrival-time comparator will produce the decision output 123 for the phase comparison and when the odd clock 192 is H, the odd arrival-time comparator will remain in the default state and the even clock will be L and the even arrival-time comparator will produce decision output 123 for the phase comparison. The even and odd arrival-time comparators will take turns to produce a decision output 123 for phase comparison and only either one of the two arrival-time comparators 190 can produce a decision output 123 at any given time.

In each phase comparison cycle, the reference input signal 110 always arrives at 180 degrees of phase and the beginning of the phase comparison cycle is always 0 degree and the end of phase comparison cycle is always 360 degrees. With two reset clock streams, the phase of each of the arrival-time comparison cycle can be very well defined and both flip-flops of the arrival-time comparator 190 are always in the default state when a new phase comparison cycle begins and the decision output 123 will remain in the current state until the new phase comparison cycle produces a different result. As a result, we have clearly defined the phases of 0 degree, 180 degrees and 360 degrees of the phase references for the phase comparison so that the arrival-time comparator can produce a phase comparison decision output 123 very quickly in every comparison cycle with just an arrival signal from each of the two input signals. If the feedback signal 112 leads the reference input signal 110 which always arrives at 180 degrees, the arrival of reference input signal 110 will turn the decision output 123 to L immediately when it arrives. Otherwise, the feedback signal 112 will turn the decision output 123 to H when the feedback signal 112 arrives. The design of non-linear phase comparator 176 is thus a precise design of phase comparator without ambiguity. Nevertheless, the output of the non-linear phase comparator 176 does have a dead-zone just like the dead-zone of the non-linear arrival-time comparator 189.

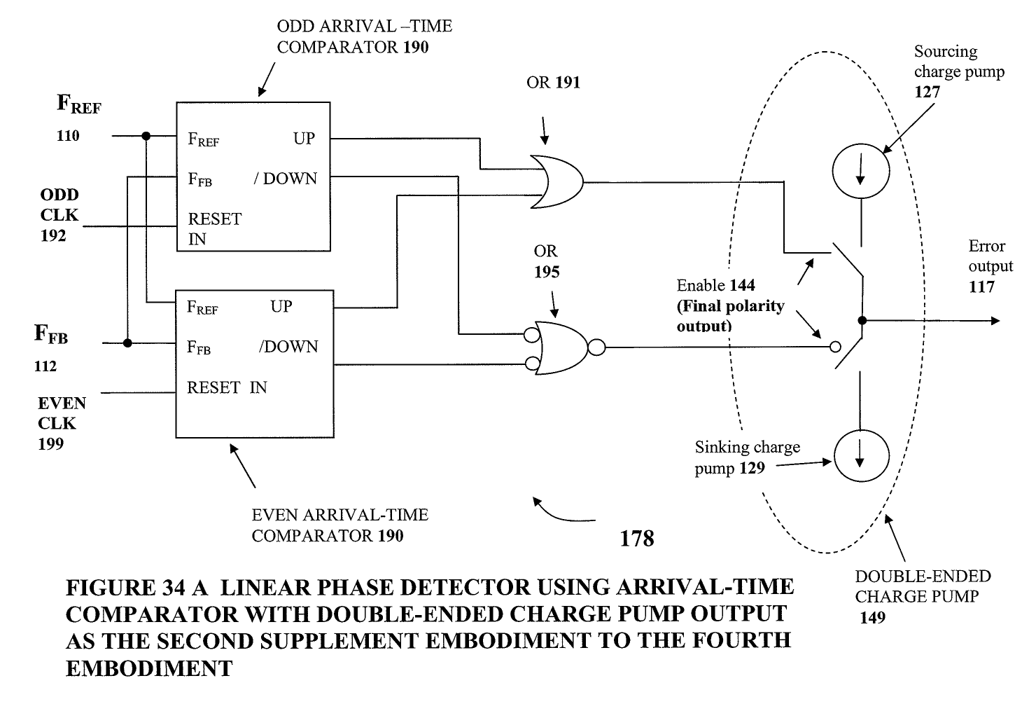

To eliminate the dead-zone, we will need to use a linear arrival-time detector 178 as shown in FIG. 34 to replace the non-linear arrival-time comparator 176 as the second embodiment to the fourth embodiment and this design is thus the best design among all the non-linear phase comparators. This new linear phase detector 178 using non-linear arrival-time comparators 190 is far superior to the previous two designs of linear phase detector 145 and 174 because this new linear phase detector is fast, precise and it is capable of generating a new decision with a single arrival event without any ambiguity. It can also produce an error output signal 117 without dead-zone so that a decision can be made swiftly as soon as the error input signal is crossing over the decision threshold 164 and the sampling-and-hold circuit 185 is no longer needed so that the output of the linear phase detector 178 can be used as the error output 117 directly. Since the error output signal 117 is held by the stray capacitance which is usually very small, an extra capacitor might be needed to hold the error output 117 so that the error output can remain at the same level until the next arrival-time comparison begins.

The transfer characteristic of the variable delay circuit 172 is normally linear so that the phase delay of the feedback signal 112 is controlled by the ramping of the final error correction output 115 linearly. With a linear variable delay circuit 172, the non-linear phase locked loop 166 and 171 can only produce random phase spread for the spread spectrum clock output signal 109, just like the non-linear amplitude locked loop 135. As a result, the spreading of the spread spectrum clock output signal 109 generated from the non-linear phase locked loop 166 and 171 using a linear variable delay circuit will be very small as compared to the system that produces frequency spread.

To improve the spreading of the spread spectrum clock generated from the non-linear phase locked loop 166 and 171, we need improve the transfer characteristic of the variable delay circuit 172. If the transfer characteristic of the variable delay circuit 172 is a square function of the final error correction output 115, instead of linear function, then the linear ramping on the final error correction output 115 will produce an output from the variable delay circuit 172 with phase that varies according to the square function of time. Since the accumulated phase change of a signal with linear ramping frequency over a time period is proportional to the square function of time, the variable delay circuit 172 with a square function transfer characteristic can effectively improve the spreading of the spread spectrum clock output 109 of the non-linear phase locked loop 135 from phase spread into frequency spread and significantly improve the effectiveness of the spreading

### Non-Linear Frequency Locked Loop

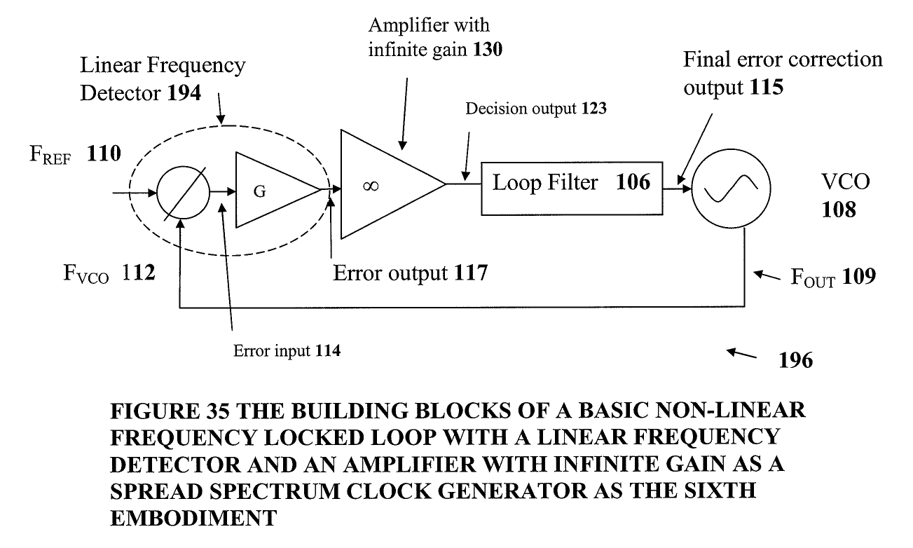

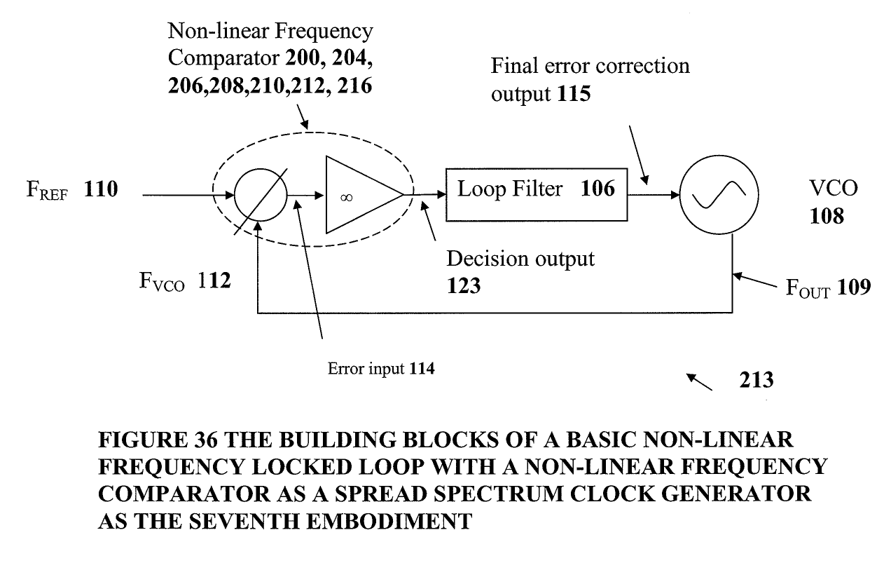

The spread spectrum clock generator can also be produced by using non-linear frequency locked loop in two ways either as shown in FIG. 35 by using a linear frequency detector 194 and an amplifier with infinite gain 130 as the sixth embodiment 196 or as shown in FIG. 36 by using a non-linear frequency comparator as the seventh embodiment 213.

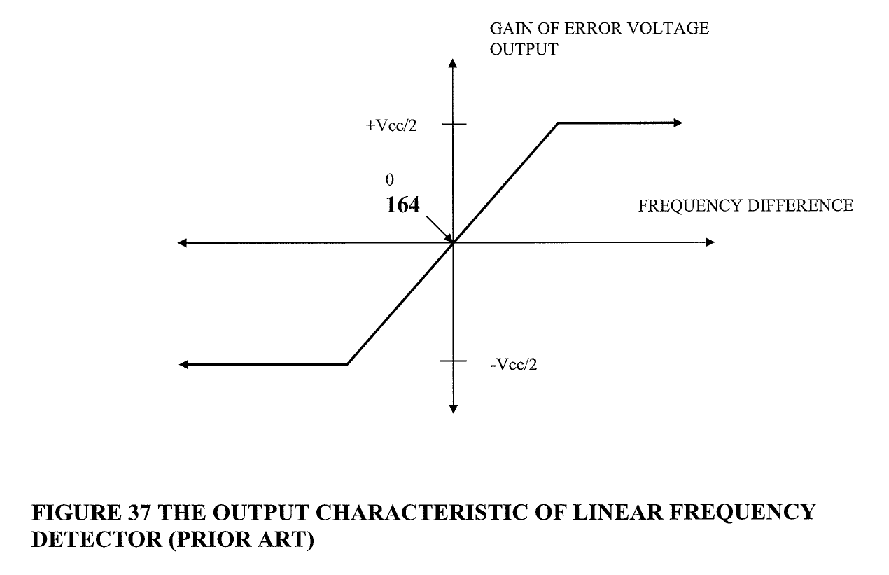

The linear frequency detector 194 is a linear device that generates an analog output with transfer characteristics as shown in FIG. 37 from the frequency difference between two input signals. Most of the current linear frequency detectors are built by analog components, such as a ratio detector or a quadrature detector to produce an S curve for the transfer characteristics. The gain of these analog linear frequency detectors is usually very low and it is usually very difficult to use these analog linear frequency detectors because a large transformer or coil is usually required. As a result, it is very difficult to implement the complete analog linear frequency detector inside the IC. There are also many ways to implement the linear frequency detector by using digital design. These digital designs for the linear frequency detector can be implemented inside the IC easily; however, since the current design of the digital linear frequency detector 194 is either very slow or inaccurate and is far inferior to the phase detector or phase-frequency detector, the current digital linear frequency detector is not very useful at all. Currently, the only use for a digital linear frequency detector is to produce a linear frequency locked loop to help the phase-locked-loop acquiring the reference input signal 110 initially. Once the frequency difference between the two input signals to the phase-locked-loop is reduced to be within the capture range of the phase-locked-loop, the linear frequency locked loop is then retired. A linear frequency locked loop is rarely used by itself today because the current design of linear frequency locked loop is good for nothing and it can't even produce a signal with accurate frequency.

There are many drawbacks in the current designs for the digital linear frequency detector 194. First, most of them are slow to detect the frequency difference. In order to tell the frequency difference, the duty cycle and the frequency of the beat signal between the two input signals are usually measured. The duty cycle of the beat signal tells us which signal has a higher frequency and the frequency of the beat signal tells us how far apart the two frequencies are. Unfortunately, the smaller the frequency difference between the two input signals, the lower the frequency of the beat signal. Since the duty cycle can only be measured when a complete cycle of beat signal has passed, it can take a very long time to determine the duty cycle when the frequency of beat signal is low. Usually, in order to speed up the decision making process, a frequency window is needed so that the two frequencies are considered in locked condition when the frequency of the beat signal is within the window. This frequency window, sometimes is called the dead band, brings up the second difficulty for the frequency detector—namely that it can not detect the frequency difference accurately. Thirdly, in order to measure the frequency with flip-flops, the feedback signal from VCO 112 is clocked asynchronously by the reference input signal 110 or vice versa and it will certainly cause the metastability problem for the flip-flop. This problem occurs to a flip-flop when the clock and data inputs arrive at the flip-flop at the same time because the flip-flop does not know what to do. For a flip-flop to register a data input signal without error, the data input signal should arrive at the data input port of the flip-flop earlier than the clock signal to arrive at the clock input port of the flip-flop by a sufficient amount of time to satisfy the set-up time requirement and the data input signal should remain at the same level for a period of time longer than the hold time requirement of the flip-flop after the clock signal has arrived in order to maintain an error-free output. The output of the flip-flop can become unpredictable if either the setup time or hold time requirement is violated and this problem is commonly known as the metastability problem. The metastability problem is the fundamental design flaw for many of the current frequency detectors and this problem greatly limits the accuracy and usefulness of the current frequency detector so that the frequency locked loop technology has not made much progress during the past forty years.

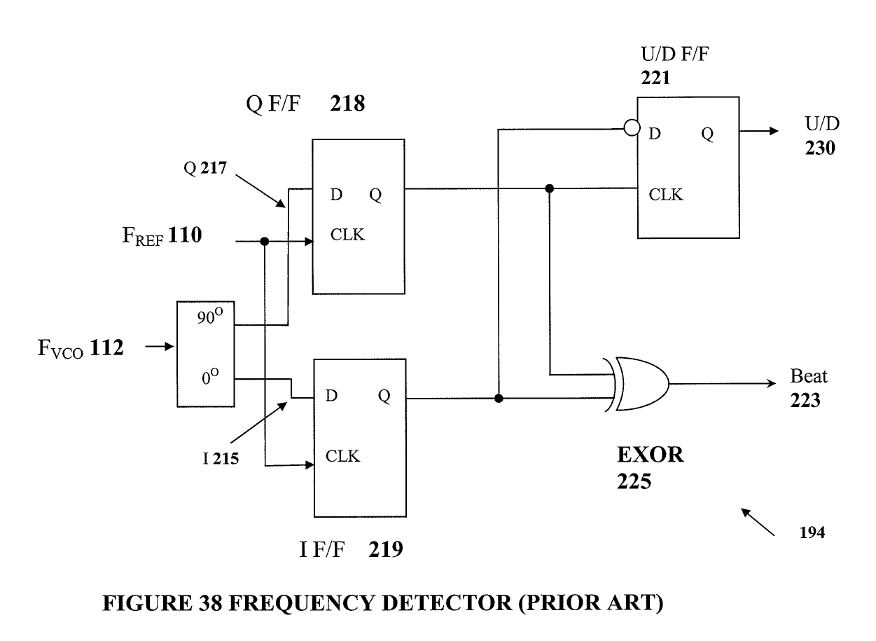

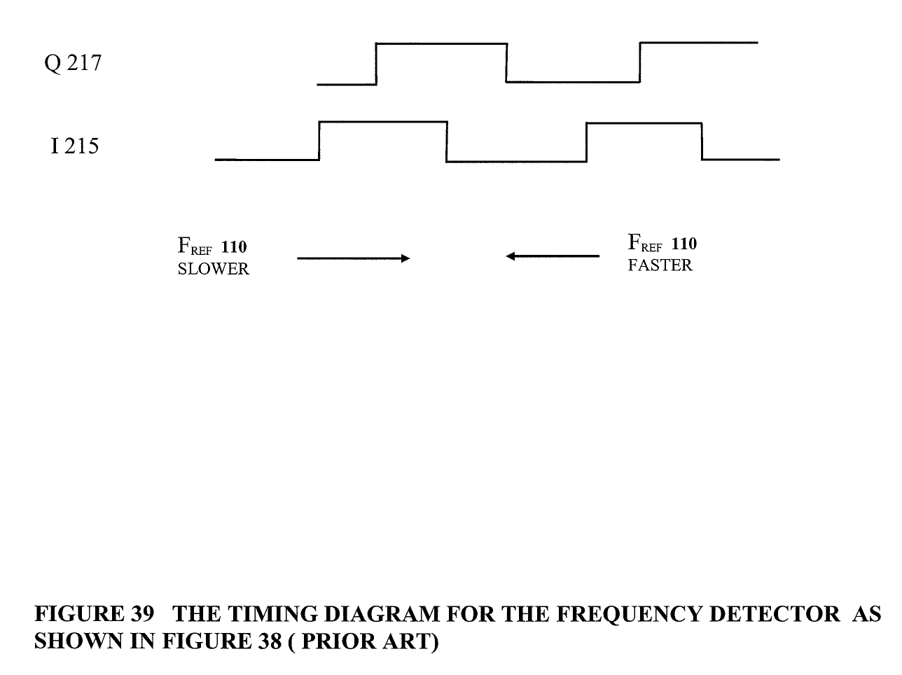

One of the most popular traditional digital linear frequency detectors is as shown in FIG. 38. In this design, the signal from VCO 112 is split into two paths, I path 215 and Q path 217, that are orthogonal 90 degrees out-of-phase to each other. Two flip-flops, 218 and 219 arranged in I 215 and Q 217 paths, are used to detect the frequency difference between the feedback signal from VCO 112 and reference input signal 110. The timing diagram for the operation of the traditional digital linear frequency detector 194 is as shown in FIG. 39. From the sequence of how the flip-flops change states, we can tell which signal has a faster frequency. When the frequency of the reference input signal 110 is faster, the reference input signal 110 will slide through the feedback signals from VCO, 215 and 217, from the right to left so that when the Q flip-flop 218 changes state from L to H, the I flip-flop 219 remains at L state. When the frequency of the reference input signal 110 is slower, it will slide through the feedback signals from VCO, 215 and 217, from the left to right so that when the Q flip-flop 218 changes state from L to H, the I flip-flop 219 remains at H state. As a result, we can tell whether if the frequency of the feedback signal from VCO 112 is running faster than the reference input signal 110 by using the output from Q flip-flop 218 to clock the output from the I flip-flop 219 to an UD flip-flop 221 to generate the U/D control 230 for the VCO correction. The amount of VCO correction is determined by the frequency of beat signal 223 generated by using an Exclusive-OR gate 225. The higher the frequency of the beat signal, the more correction to the VCO 108 is needed. This design is simple and easy to implement. However, since the reference input signal 110 and the feedback signal from VCO 112 are asynchronous, this design has a fundamental metastability problem. The flip-flops, 219 and 218, simply do not know what to do when both the reference input signal 110 and the feedback signals from VCO, 215 and 217, arrive at the flip-flops at the same time. As a result, this design can not accurately detect the frequency difference. The accuracy of the current digital frequency detector 194 as shown in FIG. 38 is typical only about 1000 ppm.

Another example of the frequency detector as shown in U.S. Pat. No. 6,842,049 presents a method to detect the frequency difference by measuring the beat signal. Unfortunately, since the frequency of the beat signal can be very low, the response time of this frequency detector can be very long. Another example as illustrated by another U.S. Pat. No. 6,834,093 presents a method to compare the frequency by using counters and its response time is also slow since a large divider is needed. There are many more designs for the digital linear frequency detector but all these current designs of the frequency detectors are very similar to the above three technologies and are simply unable to perform the frequency detection quickly and accurately.

An accurate and precise digital frequency detector is difficult to design, but it is not what we need to produce a spread spectrum clock generator. We can settle for less by using a non-linear frequency comparator for the spread spectrum clock generator as shown in FIG. 36. Unlike a linear frequency detector that needs to produce both an accurate polarity output and amplitude output for the frequency difference, since a non-linear frequency comparator only needs to produce an accurate polarity output for the frequency difference, it will be much easier to design. As will be demonstrated in this disclosure, there are many ways to build an accurate and precise non-linear frequency comparator to be used in the non-linear frequency locked loop to generate spread spectrum clocks.

For a non-linear frequency locked loop as shown in FIG. 36, the non-linear frequency comparator can only generate a final error correction voltage 115 for the VCO 108 in two stable states, either H or L, and the decision threshold 164 for the non-linear frequency comparator can be precisely at the zero frequency difference without ambiguity. It is possible to use the current design of frequency comparator with decision ambiguity for the spread spectrum clock generator but as explained earlier in the non-linear arrival-time locked loop, since decision ambiguity can produce erroneous polarity decisions to cancel out each other, it will be very difficult for a non-linear frequency comparator with a decision ambiguity to produce a growing modulation signal on the final error correction output 115 to modulate the VCO and to produce cycle-slips to the feedback signal 112 from VCO. As a result, a non-linear frequency comparator with decision ambiguity will not spread the feedback signal from VCO 112 as randomly as a non-linear frequency comparator without decision ambiguity.

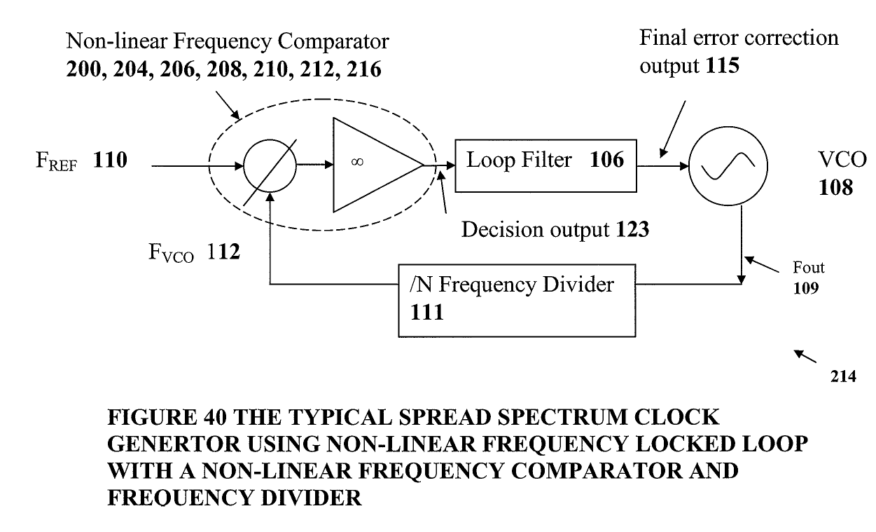

The block diagram for using a typical non-linear frequency locked loop as the spread spectrum clock generator 214 to generate a spread spectrum clock output signal with a frequency F_{OUT} 109 that is equal to N times the frequency of the reference input signal 110 is as shown in FIG. 40. The typical non-linear frequency locked loop 214 is more useful than the basic non-linear frequency locked loop as the spread spectrum clock generator 213 because it can change the frequency of the spread spectrum clock output signal 109 easily. The divide-by-N frequency divider 111 in the feedback path also adds more delay time to the feedback signal so that the oscillation frequency of the loop is lower and the frequency spread is wider. The extra delay time can help the loop to spread out the frequency of the clock signal more evenly.

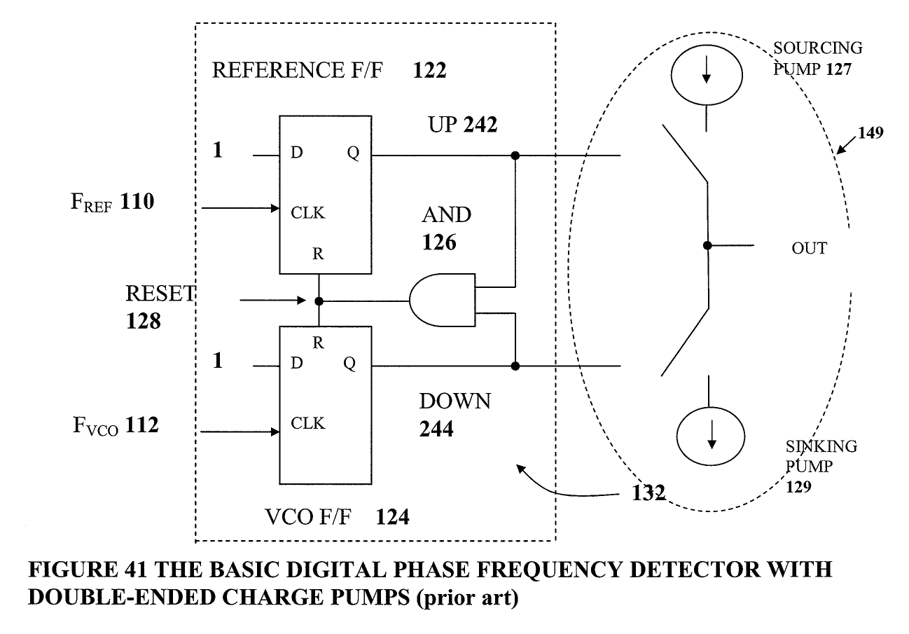

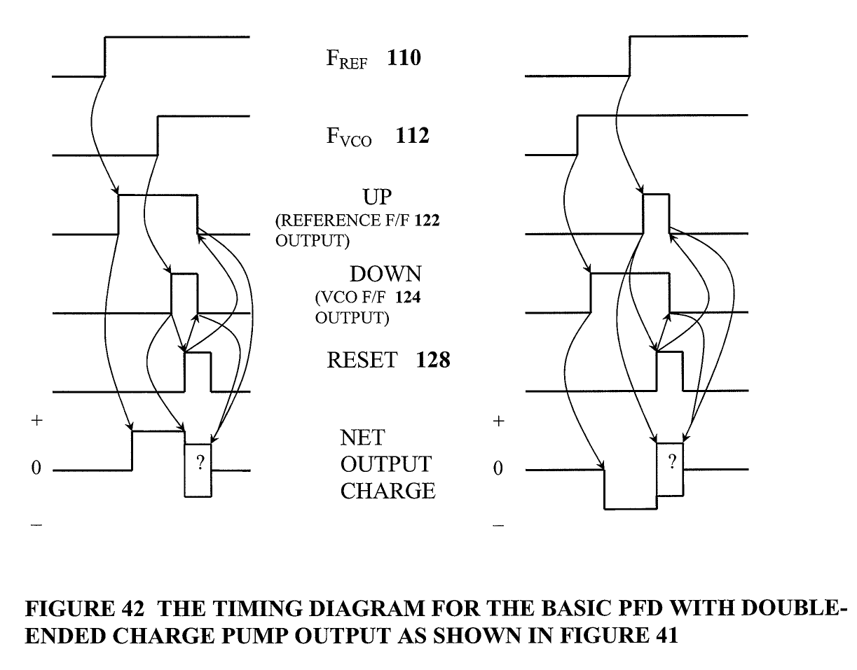

New designs for the non-linear frequency comparators that are fast and precise and are free from all the existing metastability problems are presented as follows. The best solution for the new digital frequency comparators is to improve the current design 194 as shown in FIG. 38 by fixing the metastability problem. The metastability problem can be solved by using a phase-frequency detector (PFD 132) as shown in FIG. 41 to detect the frequency difference, instead of using flip-flops. The timing diagram of the PFD driving a double-ended charge pump output is shown in the FIG. 42.

A PFD 132 is made of two flip-flops and an AND 126 gate to produce a reset signal for the flip-flops. One of the two flip-flops of the PFD 132 will be set when the first signal arrives and both flip-flops will be reset after the late arrival signal has arrived. When the reference input signal 110 arrives first, it will set the reference flip-flop 122 and the UP output 242 will be high and it will remain high until the feedback signal from VCO 112 finally arrives to set the VCO flip-flop 124 and to generate a reset signal 128 to clear both flip-flops by the AND gate 126. If the feedback signal from VCO 112 arrives first, it will repeat the same process except that the DOWN output 244 will be high first, instead. Since each of the flip-flops is triggered by only one signal all the time, there is no metastability problem with the PFD 132 whatsoever. And since both flip-flops of the PFD 132 are reset by the late arrival signal, the reset signal 128 generated from the AND logic gate 126 can be used as the indicator for the late arrival signal as shown in FIG. 42.

The easiest way to find out if there is any frequency difference between two signals is to see how one signal slides through the other one. If there is no frequency difference, the two signals will be stationary to each other so that there is no slide-through. If there is a slight frequency difference, then one of the signals will slide through the other at the rate of frequency difference. The difference of frequencies generates a beat signal. Since as a frequency comparator, we only need to know which signal is faster and we really don't need to know the amount of frequency difference between the two input signals. As soon as we find out how the two signals slide through each other, we will know which signal is faster right away. One single slide-through is enough to tell us which signal is faster. We don't need to wait a full cycle of beat signal to know which signal is faster and the latency delay time of the new non-linear frequency comparator will be short.

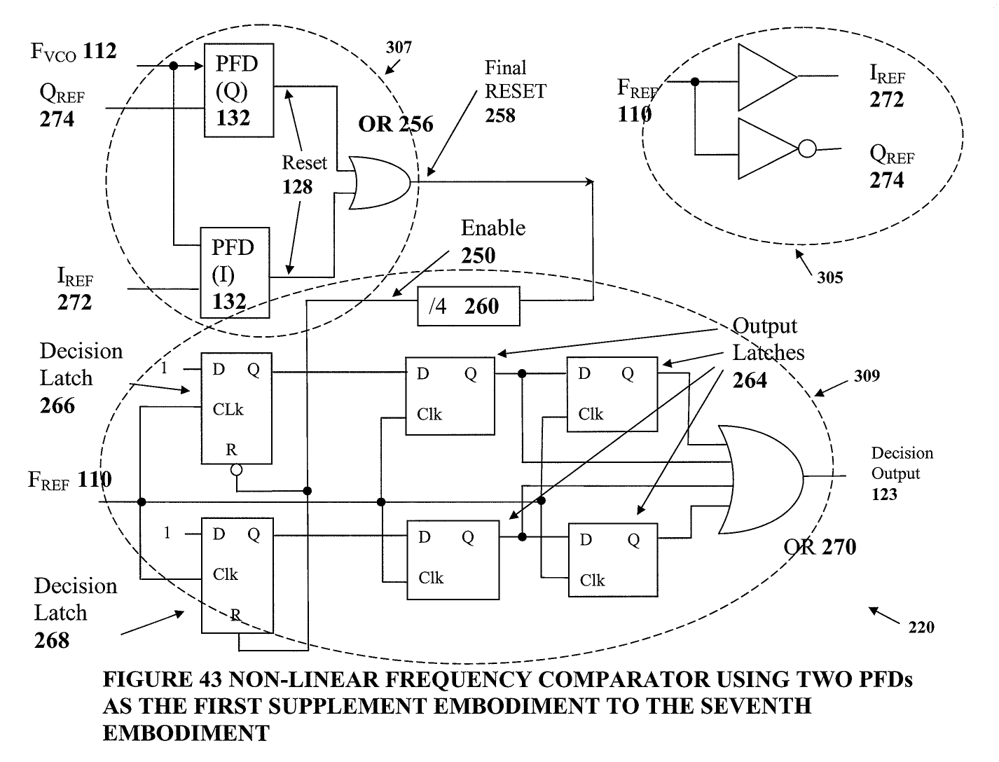

To find out how one signal slides through the other, one of two input signals needs to provide the orthogonal references for the other signal. We can choose the reference input signal 110 to be the orthogonal reference signals as shown in FIG. 43 of the schematic diagram of a non-linear frequency comparator 220 using two PFDs as the first supplement embodiment to the seventh embodiment. To do so, we need to split the reference signal 110 into two paths and use a separate PFD 132 for each path. We will call the two orthogonal reference signal paths, Iref 272 and Q ref 274, and we use an OR logic gate 256 to produce the final reset output 258 by combining the reset signal output 128 from each of the PFDs 132. For the best result, the phase relationship between the orthogonal signals should be equal to 360/N and N is equal to the number of PFD used for frequency comparison. Since the phase relationship between the two orthogonal signal is 180 degrees when N=2, we can implement the orthogonal reference easily by using an inverter. An unevenly spaced phase difference between the orthogonal signals will produce uneven frequency noises for the frequency comparison and should be prevented at all cost. The period of the orthogonal reference signals determines the period of the frequency comparison cycle.

In the design of the non-linear frequency comparator 220 as shown in FIG. 43, if the frequency of reference signal 110 is faster than the frequency of the feedback signal from VCO 112, the feedback signal from VCO 112 will be the late arrival signal to generate the reset signal for both PFDs 132. Since both of reference input signals of I ref 272 and Q ref 274 are compared with the same feedback signal from VCO 112, both the PFDs will be reset by the same feedback signal from VCO 112 so that there will be only one reset output signal at the final reset output 258 for every frequency comparison cycle. If the frequency of the feedback signal from VCO 112 is faster than the frequency of the reference input signal 110, the reference input signals will then be the late arrival signal to generate the reset signal for both PFDs. Since the two I, Q reference signals are out-of-phase, the rising edge of the reference input signals, Iref 272 and Qref 274, will occur at a different time. As a result, there will be two separate reset output signals at the final reset signal 258 of OR logic gate 256 output for every frequency comparison cycle. The pulse width of the reset signal 128 from the PFD 132 is determined by the sum of the propagation delay of the flip-flops from the reset input and the propagation delay of the AND logic gate 126 and the pulse width of the reset signal 128 is approximately equal to four times the propagation delay of a single logic gate.

It is thus clear that we can find out which signal is faster by counting the number of reset pulse at the final reset signal 258 of the OR logic gate 256 output. If the frequency of the reference input signal 110 is faster, there will be only one reset signal for every frequency comparison cycle. If the frequency of the feedback signal from VCO 112 is faster, there will be two reset signals for every frequency comparison cycle.

Since the two input signals are asynchronous, the final reset signal 258 at the OR logic gate 256 output can be generated by either the reference input signal 110 or the feedback signal from the VCO 112. The uncertainty of timing between the two asynchronous input signals can produce glitches at the output of the OR logic gate 256 especially when cycle-slip occurs. The cycle-slip occurs when the slower signal is falling behind the faster signal so much that the next faster signal arrives during the reset period of the flip-flop caused by the current slower signal and the next faster signal is not registered and is lost. As a result, the slower signal actually becomes the faster signal for the next frequency comparison cycle. The slower signal might even remain so for a short period until the faster signal finally catches up with the slower signal.

When the feedback signal from VCO 112 is the slower signal, the feedback signal from VCO 112 will generate a reset pulse for both of the PFDs. Since the two reset signals are both generated from the same feedback signal from VCO 112, the final reset output 258 at the OR logic gate 256 is always the same reset pulse 128 as from each PFD. But when cycle-slip occurs, one of the PFD will generate a reset signal 128 from the reference input signal 110 and the other PFD still generates the reset signal 128 from the feedback signal from VCO 112 and the final reset pulses 258 at the output of the OR logic gate 256 no longer come from the same source. Since the two reset pulses are generated from difference sources and these two final reset pulses are very close to each other in phase when cycle-slip occurs, the combined final reset pulse output 258 at the OR logic gate 256 output may become either one or two pulses and a glitch may be produced due to the timing uncertainty between two asynchronous input signals. So the cycle-slip can cause the number of reset pulse to increase by one when the feedback signal from VCO 112 is the slower signal.

When the reference input signal 110 is the slower signal, the reference input signals 110 will generate two reset pulses in every frequency comparison cycle. When the cycle-slip occurs, one of the reset pulses will be produced by the feedback signal from the VCO 112 while the other one is still produced by the reference input signal 110. Since the two reference input signals are spaced out in 180 degrees phase offset, the two final reset pulses 258 at the output of the OR logic gate 256 will also be spaced out around 180 degrees all the time even during the cycle-slip period and these two reset pulses will not interfere with each other. The cycle-slip can only affect the timing of the final reset pulse 258 slightly when the reference input signal 110 is the slower signal.

With this understanding, we can design a non-linear frequency comparator 220 by using only two PFDs as shown in FIG. 43 and is made of three building modules, the orthogonal module 305, the reset pulse module 307 and the decision module 309. The orthogonal modules 305 produces the reference orthogonal signals to be compared with the feedback signal from VCO 112 in the reset pulse module 307. The decision module 309 then determines the polarity of the frequency comparison by counting the number of reset pulses occurred in a frequency comparison cycle. In this circuit, an enable signal 250 is generated bypassing the final reset signal 258 through an asynchronous divide-by-four frequency divider 260 and the enable signal 250 is used as the reset signal to the frequency decision latches 266 and 268. The two frequency decision latches 266 and 268 will take turns to produce the frequency decision outputs to be stored in the four output latches 264. An OR logic gate with four inputs 270 is then used to produce the final decision output 123 by combining all the outputs from the output latches.

Since the frequency of the final reset pulses 258 can be either equal to the frequency of the reference input signal 110 or twice the frequency of the reference input signal 110, the frequency of the enable signal 250 can be either half of the frequency of the reference input signal 110 or a quarter of the frequency of the reference input signal 110. As a result, the enable signal 250 will stay at a level, either H or L, for the duration of either a period of the reference input signal 110 or two periods of the reference input signal 110. When the enable signal 250 stays at a level only for a period of the reference input signal 110, the frequency decision latch 266 and 268 will never produce an H output for the output latches 264 because it needs at least two clocks edges from the reference input signal 110 to clock an H output to the output latches 264. The enable signal 250 will produce an H output for the output latches 264 only when the feedback signal from VCO 112 is the slower signal and the frequency of the enable signal 250 is a quarter of the reference input signal 110 so that the enable signal 250 stays at a level, either H or L, for two periods of the reference input signal 110. As a result, as soon as we detect an H output at the decision output 123, we will know for sure that the feedback signal from VCO 112 is the slower signal.

This simple frequency comparator using only two PFDs, however, is unable to produce an accurate frequency comparison result when the cycle-slip occurs. When the feedback signal from VCO 112 is slower and cycle-slip occurs, the glitches of the final reset pulses 258 can increase the number of reset pulses to two and the frequency of enable signal 250 increases right away. As a result, the period of the enable signal 250 is less than two clock periods of the reference signal 110 and the output latch 264 produces an erroneous L decision output 123. The erroneous decision output 123 is more evident especially when the frequency difference between the two input signals is small so that it takes more time for the reference input signal 110 to get over the cycle-slip. As a result, the design of the non-linear frequency comparator 220 using two PFDs as shown in FIG. 43 produces inaccurate results when the frequency difference between the two input signals is small, just like all the other current frequency comparators.

One possible solution to reduce the impact of cycle-slip to the non-linear frequency comparator 220 using only two PFDs as shown in FIG. 43 is to stretch the pulse width of the final reset signal 258. Since the cycle-slip can only cause errors when the feedback signal from VCO 112 is the slower signal and since the two signals are not too far from each other in phase during the cycle-slip period when the feedback signal from the VCO 112 is the slower signal, it is possible to cover up the glitches if we stretch the final reset signal 258 long enough; however, the best strategy to handle the glitches is not to produce them in the first place. The glitches are produced by the design engineer and it does not worth the effort trying to cover up the glitches after they are produced. The design engineer should simply design the circuit without glitch, period.

The cycle-slip is inevitable and it occurs whenever two asynchronous signals slide through each other. To overcome the glitch problem, generated by the cycle-slip, which can increase the number of reset signal by one; we need to increase the number of PFD 132 used. If we use three PFDs for the frequency comparison, then there will be three reset signals per frequency comparison cycle when the frequency of the feedback signal from VCO 112 is faster. When the feedback signal from VCO 112 is faster, the reference input signal 110 will be the late arrival signal so that all the three final reset output signals 258 will be generated by the reference input signal 110. During the cycle slip period, one of the reset pulses at the final reset output 258 can be produced from the feedback signal from VCO 112 and the timing of the final reset pulse 258 can fluctuate. Since the three orthogonal reference input signals are spaced out with 120 degree phase shift, the reset pulses at the final reset output 258 will not interfere with one another even during the cycle-slip period. The timing uncertainty due to the cycle-slip, however, can cause uncertainty to the timing of the final reset pulses 258. Since we count the number of reset pulses in a fixed period of reference comparison signal 110, the number of reset pulse in the fixed frequency comparison period can be reduced to two due to the timing uncertainty when cycle-slip occurs.

When the frequency of the reference input signal 110 is faster, all the three PFDs will generate a reset signal from the same feedback signal from VCO 112 so that there will be only one reset pulse generated by the feedback signal from VCO 112 at the final reset output 258 in every frequency comparison cycle normally. During the cycle-slip, since one of the reset pulses now will be generated by the reference input signal 110 which is asynchronous to the feedback signal from VCO 112 and is very close the feedback signal from VCO 112 in phase, the number of reset pulses at the final reset output 258 can become two or one during the cycle-slip period due to the timing uncertainty of two asynchronous input signals. As a result, we can only know for sure which signal has a faster frequency when the number of reset output signal at the final reset output 258 is either one or three in a frequency comparison cycle. So the design of using three PFDs for the non-linear frequency comparator can produce an accurate frequency comparison result all the time. Since we can't make any decision when the number of reset pulses is two in a frequency comparison cycle, it will take more time for the non-linear frequency comparator to switch a decision. The latency delay time of the non-linear frequency comparator using three PFDs will thus be longer because the decision output 123 can only be changed when the number of reset pulses changes from 1 to 3 or 3 to 1 which requires at least two frequency comparison cycles.

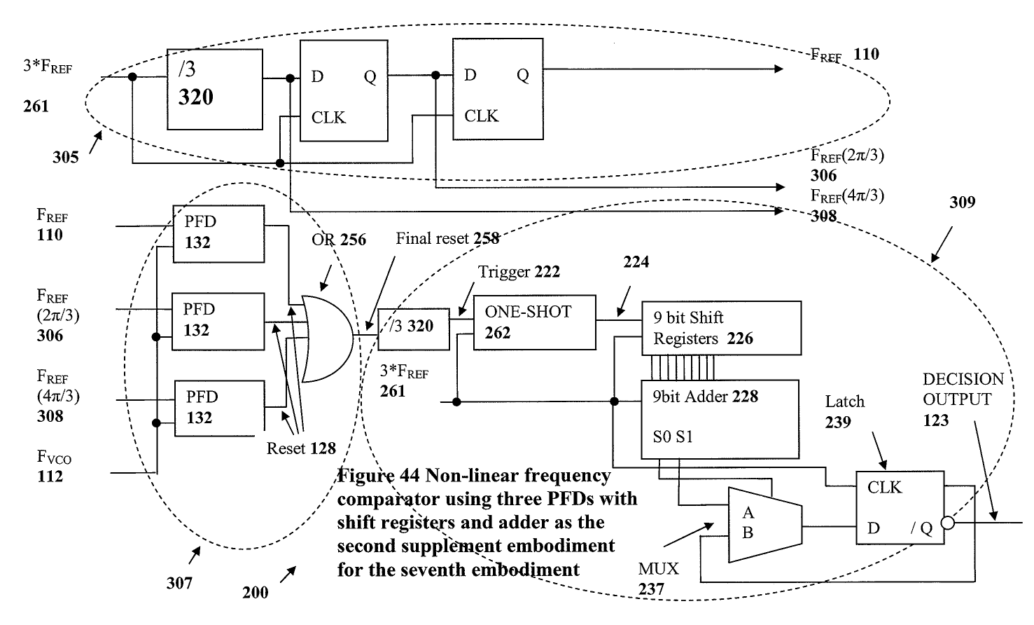

An illustrative non-linear frequency comparator 200 using three PFDs 132 is as shown in FIG. 44 as the second supplement embodiment to the seventh embodiment. The digital frequency comparator 200 can be built by three modules, the orthogonal module 305, the reset pulse module 307 and the decision module 309. The orthogonal module 305 produces the orthogonal reference signals for the frequency comparison that takes place in the reset pulse module 307. In order to generate the orthogonal signals with precise phase, a high frequency reference clock 261 with the frequency equal to the number of PFD used in the reset pulse module 307 times the frequency of the comparison reference input signal 110 is needed.

A high frequency reference clock 261 with a frequency equal to three times the frequency of reference input signal 110 can then generate three equally spaced orthogonal reference signals 110, 306 and 308 with a phase difference of precise 120 degrees between any two adjacent reference signals. The reset pulse module 307 generates the final reset pulses 258 for the decision module 309 by combining all the reset output signals 128 from each of the PFD 132 with an OR gate 256. The decision module 309 will determine which signal has a higher frequency by counting the number of reset pulses occurred in a period of reference input signal 110, which is also the frequency comparison period.

As shown in FIG. 44, an OR logic gate with three inputs 256 is used to combine the three reset signals 128 from the three PFDs to become the final reset output signal 258. There are many ways to design the decision module 309 to determine which signal is faster by counting the number of reset pulses from the final reset output 258 in a reference frequency comparison period 110. The easiest way to build the decision module 309 is as shown in FIG. 44 by using a divide-by-three frequency divider 320 to divide the final reset output signals 258 to become a lower frequency trigger signal 222 for the one-shot generator 262 and the output 224 of the one-shot is stored into a 9 bit shift registers 226 sequentially and finally, a 9 bit adder 228 is used to add all the results stored in the 9 bit shift register 226 and the sum of the 9 bit adder 228 is equal to the number of reset signals occurred in a period of reference frequency comparison signal 110. A decision can then be made precisely from the result of the 9 bit adder 228. If the sum of the 9 bit adder 228 is 3, the frequency of the VCO signal 112 must be faster than the frequency of reference signal 110. The frequency of the signal from VCO 112 must be slower than the frequency of the reference input signal 110 if the sum of the 9 bit adder 228 is equal to 1. This design is very simple, however, it requires a lot of hardware and the number of hardware will increase exponentially when the number of PFD used is increased. The number of flip-flops needed in this design increases at the rate of N² and N is the number of PFD used.

In this design as shown in FIG. 44, a divide-by-three frequency divider 320 is used to divide the final reset signals 258 by three. The final reset pulses 258 from the OR logic gate 256 output have a very short time period and the timing of the final reset pulses is synchronous to either the feedback signal from VCO 112 or the reference input signal 110 depending upon which signal arrived last. So the timing of the final reset pulses 258 can vary. The uncertainty of the timing and the short time period nature make it very difficult to process the final reset pulses 258 directly.

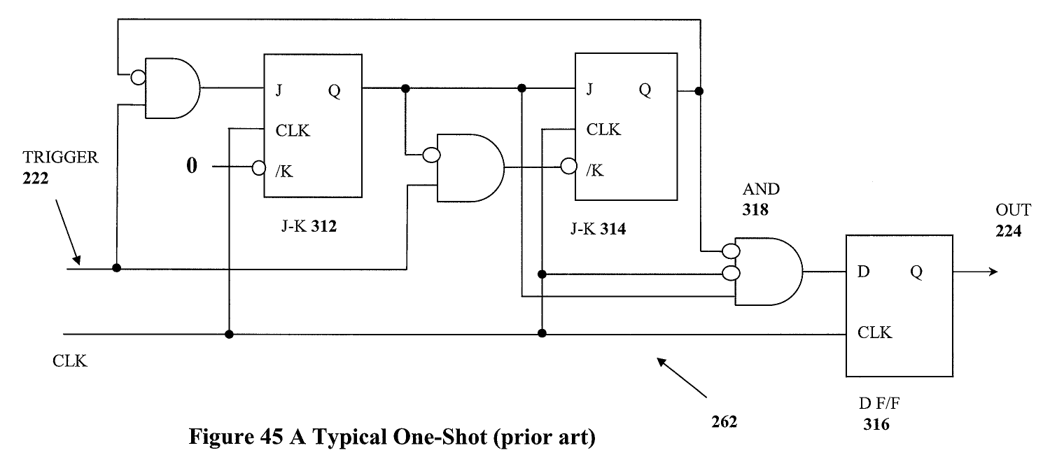

The short time period issue can be solved by using a frequency divider 320 to extend the time period of the reset pulses and the uncertainty of the timing issue can be solved by using a one-shot circuit 262 that is clocked by the high frequency reference clock 261. A typical one-shot 262 circuit is shown in FIG. 45. The one-shot circuit 262 generates an output signal 224 which is clocked by the high frequency reference clock 261 all the time and the time period of the H output from one-shot 262 is certain and fixed and is always equal to a clock period of the high frequency reference clock 261. The metastability problem is thus no longer an issue since the pulse width of the output pulse 224 from the one-shot 262 is always one clock period of the high frequency reference signal 261, although the timing of the output pulse 224 from the one-shot 262 can vary by a clock period of the high frequency reference clock signal 261 due to the timing uncertainty. In other words, the metastability problem still has an effect on this design but it causes no harm since the worst that the metastability problem can do to this design is to delay the output 224 from the one-shot 262 by a clock period of the high frequency reference clock signal 261.

There are two J-K flip-flops used in this one-shot 262 and the output 224 of the one-shot 262 will be generated when the output of the first J-K flip-flop 312 is H while the output of the second J-K flip-flop 314 is still L. The outputs from the two J-K flip-flops are logically ANDed with the non-trigger part of the high frequency reference clock 261 before being clocked out by the D flip-flop 316 to guarantee the accuracy of timing. The time period of the trigger signal 222 to the one-shot 262 must be longer than a clock period of the high frequency reference clock signal 261 to ensure the success of triggering. Since the maximum frequency of the final reset pulses 258 is three times the frequency of reference input frequency 110 so that the maximum frequency of the trigger signal 222 is the same as the frequency of the reference signal 110 which is ⅓ of the high frequency reference frequency 261. As a result, the trigger signal 222 for the one-shot 262 will always be longer than a clock period of the high frequency reference clock signal 261 so that the output 224 from one-shot 262 will be always error-free.

When the frequency of the feedback signal from VCO 112 is faster, the trigger signal 222 to the one-shot 262 will have the same frequency as the reference signal 110 and when the frequency of the feedback signal from VCO 112 is slower, the frequency of the trigger signal 222 to the one-shot 262 will be only ⅓ of the frequency of the reference input signal 110 in the steady state. The frequency of the trigger signal 222 can be ⅔ of the frequency of the reference signal 110 when the cycle-slip or metastability condition occurs.

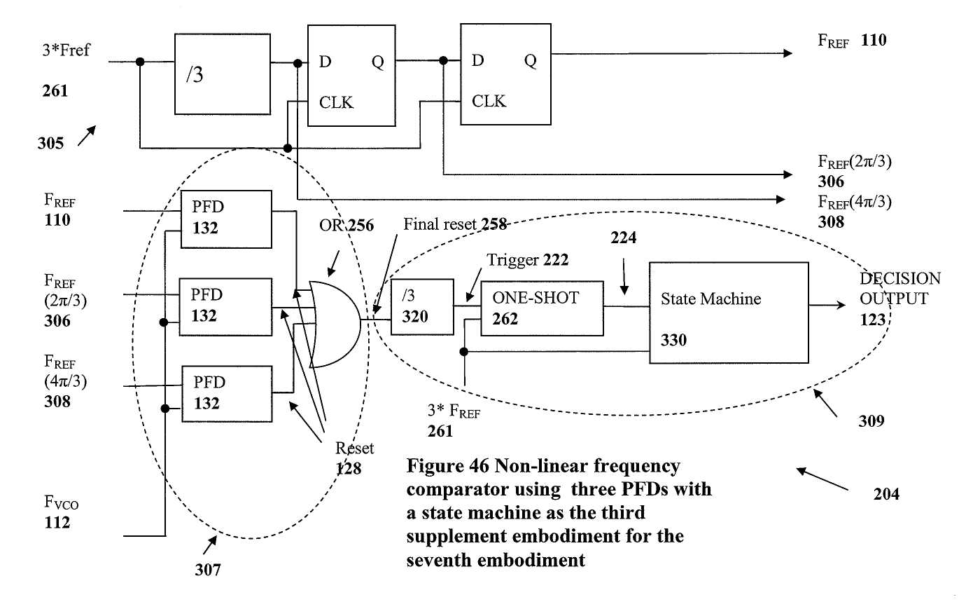

If we use a 9 bit shift registers 226 to store the output 224 from the one-shot 262 sequentially and a 9 bit adder 228 to add the pulses output from the one-shot circuit 262 stored in the shift registers 226 over three periods of reference frequency comparison signal 110, the output of the 9 bit adder 228 will indicate how many reset pulses have occurred within a period of reference frequency comparison signal 110. We basically divide the final reset pulses 258 by three first and then multiply it by three later to obtain the original count of the final reset pulses in a reference frequency comparison period 110 and we need a 9 bit shift register 226 to store the pulses from the output of one-shot 262 and a 9 bit adder 228 to add them up. The decision can be made precisely with this design. When the output of the 9 bit adder 228 is 3, we know that the frequency of the feedback signal from VCO 112 must be faster than the frequency of the reference input signal 110 so that a negative output is needed to slow down the frequency of VCO 112. If the output of the 9 bit adder 228 is 1, the frequency of the feedback signal from VCO 112 must be slower and a positive output is needed to speed up the frequency of VCO 112. A multiplexer 237 and a latch 239 can be used to produce the decision output 123 signal. Since the output of the latch 239 can only be changed when the sum of the 9 bit adder 228 is an odd number, the least significant bit S0 of the output of the 9 bit adder 228 can then be used as the enable signal for the multiplexer 237 so that the output of the latch 239 will remain the same when the least significant bit S0 of the output of the 9 bit adder 228 is false. When the least significant bit output S0 of the 9 bit adder 228 is true, then the output of the latch 239 will be determined by the second least significant output bit S1 of the 9 bit adder 228. The design to use shift registers and adders is very simple but a lot of hardware is needed especially when more PFDs are used. To save the amount of hardware, we may use a state machine 330 instead to determine which signal has a faster frequency for the decision module 309 as shown in FIG. 46 as the third supplement embodiment for the seventh embodiment 204.

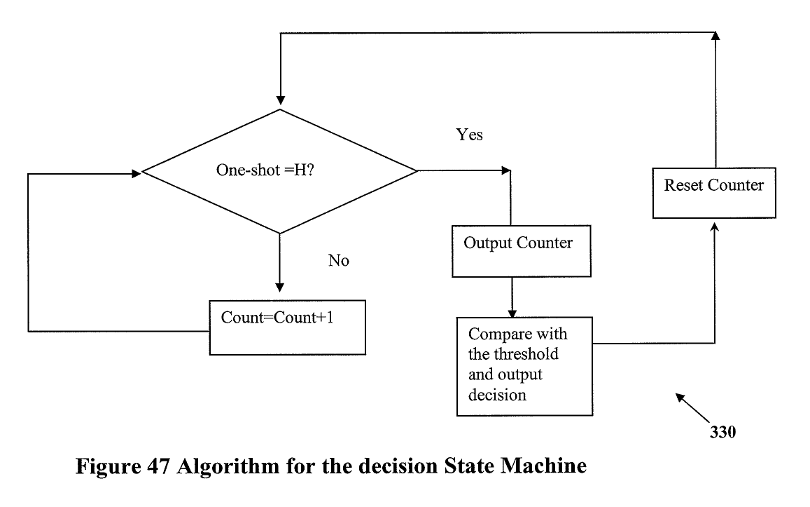

The algorithm of the state machine 330 is shown as in FIG. 47. The state machine 330 is clocked by the high frequency reference signal 261. Since the one-shot 262 is also clocked by the high frequency reference signal 261, its output can only stay H for a clock period of high frequency reference signal 261. As explained earlier, the frequency of the trigger signal 222 at the divide-by-three frequency divider output 320 is between one third of the frequency of the reference input signal 110 and the frequency of the reference input signal 110 and since the frequency of the reference input signal 110 is only one third of the high frequency reference signal 261, the time period between the H output from the one-shot output 224 can be either two high frequency reference clock periods when the frequency of the feedback signal from VCO signal 112 is faster or eight high frequency reference clock periods when the frequency of the feedback signal from VCO 112 is slower. So that we can make a decision precisely every time the H output from the one-shot 262 arrives by simply counting how many L states has passed before the new H output from the one-shot 262 arrives. If the current decision output 123 is L then we can only change it to H when the number of L states is higher than the High decision threshold and if the current decision output 123 is H then we can only change it to L when the number of L states is below the Low decision threshold. By this way, the decision output 123 can be made precisely and without ambiguity.

The state machine 330 method is simple and uses fewer logic gate, however, the decision is made at a rate slower than the previous shift registers and adder method as shown in the second supplement embodiment to the seventh embodiment 200 because the state machine 330 can change the state of the output only after the H output of the one-shot 262 arrives which occurs at the rate of ⅓ to 1/9 of the high frequency reference clock frequency 261. In contrast, the register and adder method can update the output at the rate of high frequency reference clock frequency 261. There are many other ways to implement the decision module 309 for the non-linear frequency comparator and each design has its merits and shortcomings as the two previous examples illustrated. The response time of the shift register and adder method 200 as shown in FIG. 44 is fast but it takes a lot of hardware to implement the circuits and the size of hardware grows exponentially as the number of PFD increases. The state machine method 204 as shown in FIG. 46 uses the least amount of hardware but its response can be slow.

In the above two designs, we can only change the decision output 123 when the sum of the adder is either 3 or 1 and it can take more time to change a decision output 123 since at least two reference frequency comparison periods 110 are needed to change the sum of the adder from 1 to 3 or from 3 to 1.

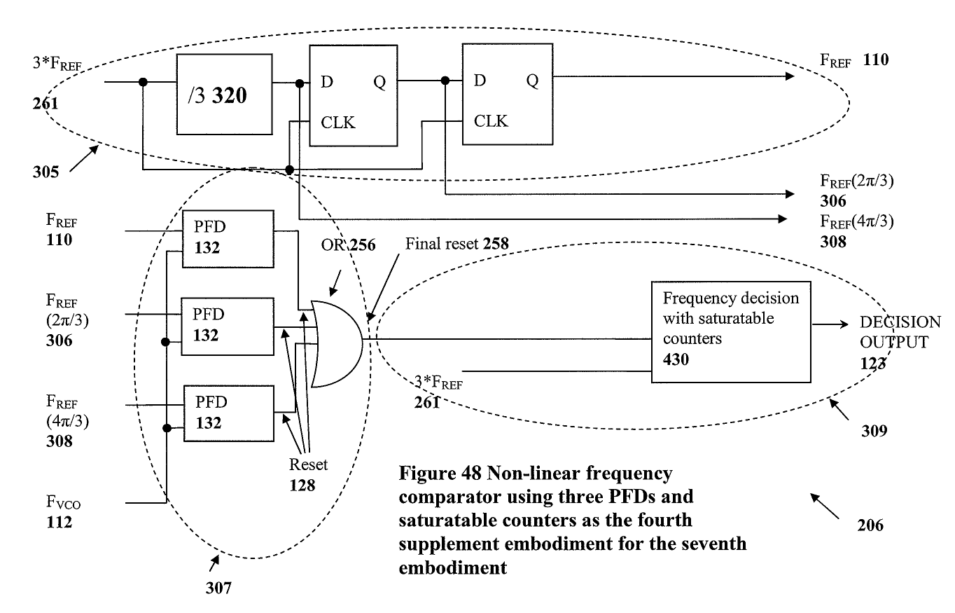

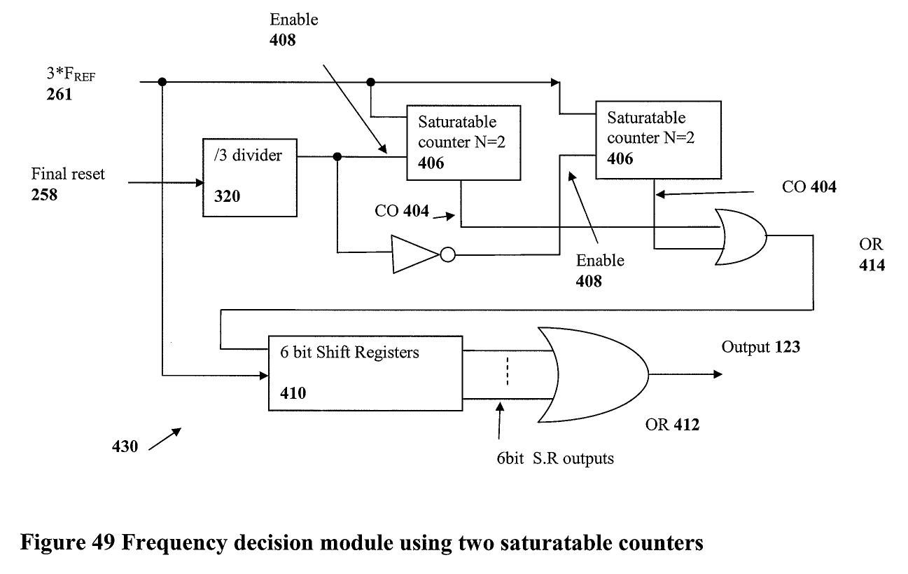

A new improved design 430 for the decision module 309 which can make a precise decision at the end of every frequency comparison cycle by using two saturatable counters is as shown in FIG. 48 as the fourth supplement embodiment to the seventh embodiment. The design of the decision module 430 is shown in FIG. 49. In this design, an enable signal 408 is generated by dividing the final reset output 258 from the reset pulse module 307 by a divide-by-three frequency divider 320. With the use of three PFDs in the reset module 307, there will be three reset pulses for every frequency comparison cycle when the feedback signal from VCO 112 has a higher frequency and one reset pulse for every frequency comparison cycle when the feedback signal from VCO 112 has a slower frequency. If we use a synchronous divide-by-three frequency divider 320 to divide the final reset pulses 258 to produce the enable signal 408 for the saturatable counters 406, the enable signal 408 will have the frequency either equal to the frequency of the reference input signal 110 or ⅓ of the frequency of reference input signal 110. When the frequency of the enable signal 408 is equal to the frequency of the reference input signal 110, the enable signal 408 can stay at a level, either H or L, for duration equal to either ⅓ or ⅔ of the period of the reference comparison frequency input signal 110 due to the synchronous divide-by-three frequency divider 320. When the frequency of the enable signal 408 is equal to ⅓ of the frequency of reference input signal 110, the enable signal 408 can stay at a level, either H or L, for duration equal to one or two period of the reference comparison frequency input 110 in the steady state due to the synchronous divide-by-three frequency divider 320. As a result, we can use the period of the reference signal 110 as the decision threshold to find out which signal is running faster. If we detect the enable signal 408 staying at either the H or L output level for duration longer than the period of reference signal 110, which is equal to three clock periods of the high frequency reference clock 261, it will guarantee that the frequency of the signal from VCO 112 is slower.

When the feedback signal from VCO 112 is faster and the cycle slip occurs, the duration of the enable signal 408 at the output of the synchronous divide-by-three frequency divider 320 can become slightly longer or shorter than ⅓ or ⅔ of the period of the reference input signal 110 due to the timing uncertainty between two asynchronous input signals. The timing uncertainty will not change the period of the enable signal 408 by too much because the three orthogonal reference signals are spaced out at 120 degree phase offset and the reset pulses will not interfere with one another even during the cycle-slip. So the period of the enable signal 408 remains about the same as ⅓ or ⅔ of the period of the reference input signal 110 and is still way below the threshold of the period of the reference input signal 110. As a result, the saturatable counters 406 will never go higher than 1 and the CO 404 is always false when the feedback signal from VCO 112 is the faster signal.

When the feedback signal from VCO 112 is slower and the cycle-slip occurs, the time period of the enable signal 408 will be shorten by half due to the glitch. As a result, the enable signal 408 will now stay at a level, either H or L, for either a period of the reference input signal 110 or half the period of the reference input signal 110 when the glitch is present, instead of either one or two periods of the reference input signal when the glitch is absent. So regardless of the presence or absence of the cycle-slip, the enable signal 408 will always stay at a level, either H or L, for a period of the reference input signal 110 to allow the saturatable counter 406 to always reach the top and enable the CO 404 output when the feedback signal from VCO 112 is the slower signal. As a result, the use of two saturatable counter 406 can solve the cycle-slip problem easily.

The design of digital frequency comparator 206 using two saturatable counters is thus the best design for the non-linear frequency comparator to provide a decision output 123 with the least latency delay time. Nevertheless, as we have learned from making a spread spectrum clock generator from digital arrival-time locked loop, the latency delay time of the error comparator can increase the frequency spread so that a longer latency time is not necessary a bad thing for a spread spectrum clock generator.

The CO 404 output from the saturatable counter 406 will be held at zero when the enable input 408 is false. When the enable input 408 is true, the counts of the saturatable counter 406 will start to increment whenever a new clock edge arrives. However, for the saturatable counter 406 with N=2, the counter output will not go higher than two regardless of how many clock edges have arrived and the output of the counter will be held at two and the Carry Out output CO 404 will be held at H when the top of the counter with N=2 has been reached. For the design 430 using two saturatable counters as the decision module 309, one of the saturatable counters is active only when the output of divide-by-three frequency divider 320 is H and the other saturatable counter is active only when the output of the divide-by-three frequency divider 320 is L. The principle of this design is that since there will be only one reset output at the final reset output 258 for every frequency comparison cycle when the frequency of the signal from VCO 112 is slower, the time period of the enable output signal 408 at the divide-by-three frequency divider output 320 will be very long when the frequency of the signal from VCO 112 is slower. Once we detect a long period from the output of divide-by-three frequency divider output 320, we can know for sure that the frequency of the signal from VCO 112 must be slower. The purpose of the two saturatable counters is to just look for a long period, either at H or L level at the output of divide-by-three frequency divider 320. Once a period from the divide-by-three frequency divider output 320 that is longer than three high frequency reference clock periods is detected, the saturatable counter will enable the CO 404 signal and the enabled CO 404 signal will be stored by the six bit shift registers 410 sequentially and the decision output 123 of frequency comparator will be locked by the OR gate with six inputs 412 for a time period of six clock periods of the high frequency reference clock 261 to prevent glitches generated by the cycle-slip and the switching of the saturatable counters in the decision circuit. As a result, this design offers a fast response time and consumes moderate amount of hardware and the number of the shift registers required will be increased only linearly at the rate of 2*N where the N is the number of PFD used.

In the design for a frequency comparator using three PFDs and two saturatable counters with N=2, in theory, we need a minimum of 6 bit shift registers and an OR gate with six inputs to prevent the glitch caused by the cycle-slip and switching between the two saturatable counters. The reason that we need so many shift registers is because the two saturatable counters will be reset alternatively. Once the saturatable counter is reset, we will lose the current H output immediately. In order to retain the current H output, since it can take at most six high frequency reference clock periods to generate a new H output again, we need a 6 bit shift registers to maintain the current H output. Suppose we name one of the two saturatable counters as the even counter and the other one as the odd counter and the even counter is currently producing an H output. Since it is possible that in the next cycle when the odd counter is enabled, the odd counter will not produce an H output due to the cycle-slip and we have to wait until the next time the even counter is enabled to produce the H output; since it can take at least three high frequency reference clocks for the even counter to produce a new H output and at most three high frequency reference clocks for the odd counter not to produce an H output due to cycle-slip, it can take at most six high frequency reference clocks before the new H output is produced again and a 6 bit shift register is thus needed.

One consequence of using an OR gate 412 with six inputs and six bit shift register 410 for the design of decision module 430 is that the response time of the decision module 430 is not equal between when the decision output 123 is changed from H to L and L to H because the OR gate 412 favors the H output. The decision output will become H immediately when an H is produced for the CO 404 from one of the saturatable counters. Since it takes three high frequency reference clocks to produce an H output for the CO 404 from the saturatable counter but it needs six high frequency reference clocks to get rid of an H output from the six bit shift register 410, the decision output 123 can change from L to H faster than from H to L. In contrast, the design of decision module using one-shot with shift registers and adder as shown in FIG. 44 needs four to six high frequency reference clocks to change the decision output 123 from H to L or six to nine high frequency reference clocks to change the decision output 123 from L to H and the design of state machine as shown in FIG. 46 requires nine high frequency reference clocks for the decision output to change from L to H and three high frequency reference clocks for the output to change from H to L.

If we increase the number of PFD 132 to four then there will be four reset signals per frequency comparison cycle when the frequency of the feedback signal from VCO 112 is faster or one reset signals per frequency comparison cycle when the frequency of the reference input signal 110 is faster. When the cycle-slip occurs, the number of reset pulses in each frequency comparison cycle can become three when the frequency of the feedback signal from VCO 112 is faster and the number of reset pulses becomes either two or one when the frequency of the reference input signal 110 is faster due to the uncertainty caused by the metastability problem. As a result, we can still know for sure which signal is faster even with the presence of cycle-slip and metastability problem. It is thus clear that the use of four or more PFD 132s can determine which of the two input signals has a faster frequency without error or ambiguity at the end of every frequency comparison cycle. So the latency delay time of the frequency comparator using four or more PFDs will be short since every comparison cycle can produce a new comparison result immediately.

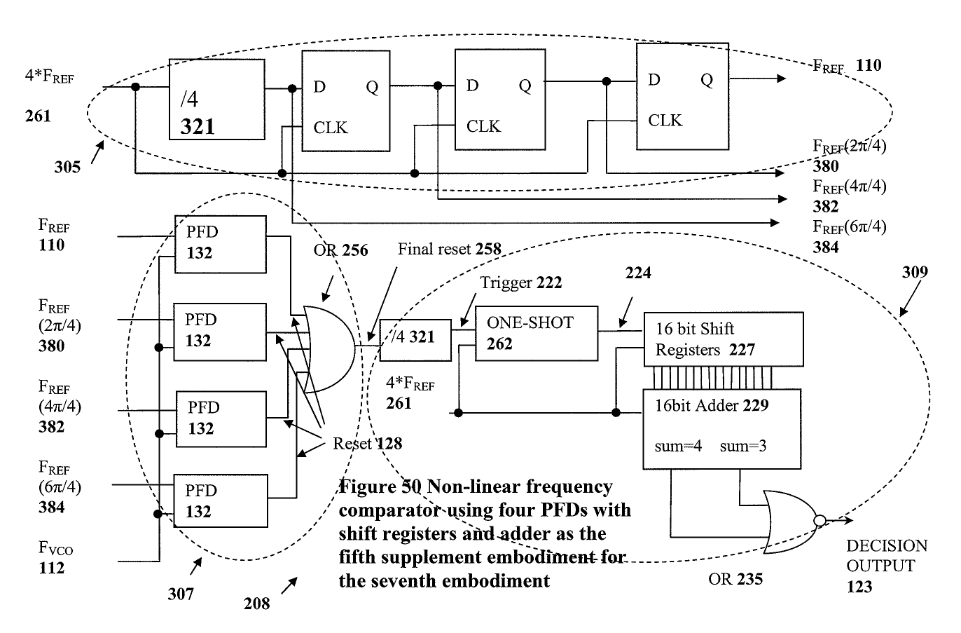

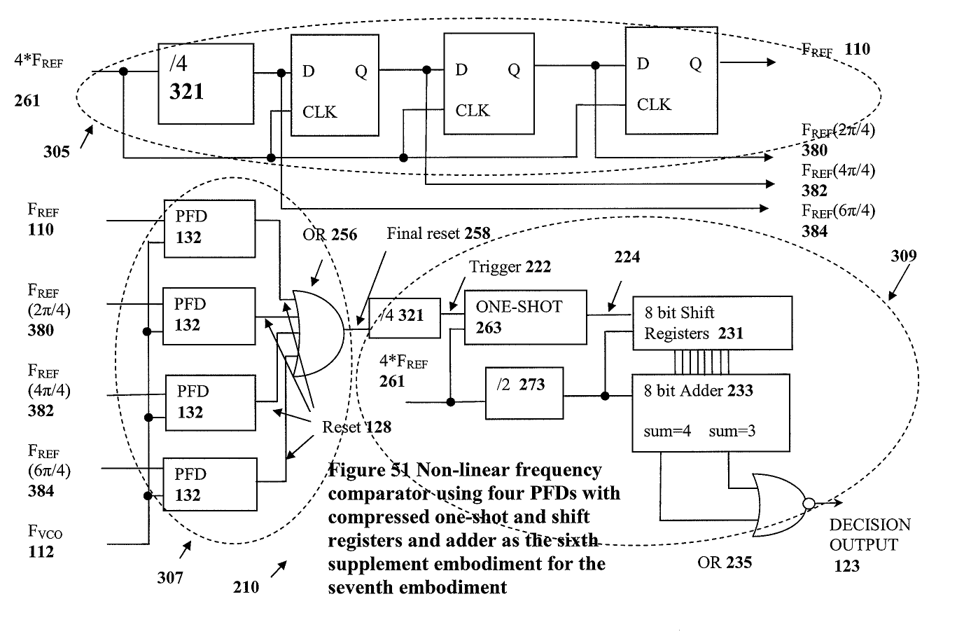

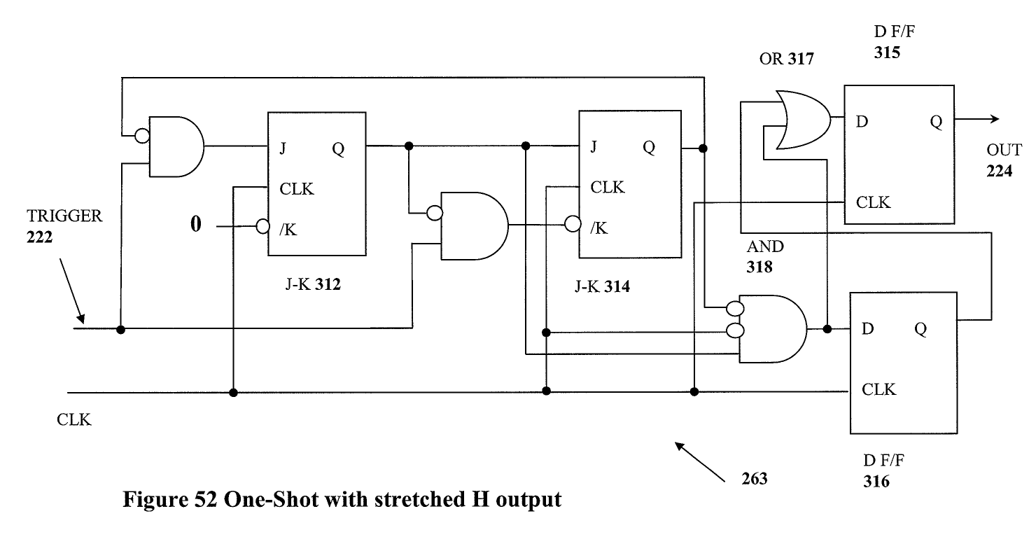

An illustrative digital frequency comparator 208 using four PFDs 132 is as shown in FIG. 50 as the fifth supplement embodiment for the seventh embodiment. The decision circuit 309 for the design in FIG. 50 is very similar to the design in FIG. 44 and we only need to know if the sum of the 16 bit adder is either 4 or 3. If the sum of the 16 bit adder is either 4 or 3, we know for sure that the frequency of the feedback signal from VCO 112 is too fast and must slow down. The only disadvantage to use the design as shown in FIG. 50 is that a lot of hardware is needed. One possible way to save the amount of hardware with the design using shift registers and adders as shown in FIG. 51 is to compress the output 224 from the one-shot. Once the output from the one-shot 224 is compressed, we can not only save the amount of shift registers needed but also the adders. The easiest way to compress the output from the one-shot is to extend the period of H output from the one-shot 263 as shown in FIG. 52. For example, if we are using four PFDs with the shift registers and adders for the decision module, in theory, we will need a 16 bit shift registers to store the outputs from the one-shot 262 over four frequency comparison cycles. Since the output from the one-shot has the frequency of ¼ to 1/16 of the high frequency reference clock frequency 261, the duty cycle of the output from the one shot is from ¼ to 1/16. If we extend the duration of the period for the H output from the one-shot to two high frequency reference clock periods instead of one period, we will then increase the duty cycle of the output from one-shot 263 to be from ½ to ⅛. As a result, we only need an 8 bit shift registers 231 and an 8 bit adders 233 that are clocked at half of frequency of the high frequency of reference clock signal 261, instead of a 16 shift registers 227 and a 16 bit adders 229 that are clocked by the full speed of high frequency reference clock signal 261. This simple method to compress the output signal from one-shot 263 can still perform the same as the original uncompressed design but with some saving of hardware. The FIG. 51 illustrates the design of using compressed one-shot output to save the amount of hardware as the sixth supplement embodiment for the seventh embodiment.

In all the above designs, the frequency of the high frequency reference signal 261 must be N times of the frequency of the reference input signal 110 when N is the number of PFD used. A high frequency reference signal 261 is needed to generate the orthogonal signals precisely so that the response of the frequency comparator will be linear. If a high frequency reference clock 261 is not available, it is also possible to use delay lines or other means to generate the needed orthogonal reference signals without using a high frequency reference clock; however, the delay time of each delay line must be carefully aligned to maintain the phase relationship of the orthogonal references.

The response time of all the non-linear frequency comparators presented so far is fast since there is no need to measure the frequency of the beat signal. It only takes one slide-through of clock edges to determine which signal is faster. Before the slide-through occurs, the output of the non-linear frequency comparators is in the existing state. A single slide-through of the edges is enough for the non-linear frequency comparator in the non-linear frequency locked loop to change the direction of frequency slewing if the slide-through caused the decision module 309 to change the outcome of the decision output 123. Since we are using the high frequency reference signal 261 which is N times the frequency of the reference input signal 110, slide-through can happen N times more often in a period of beat signal. The operation of the non-linear frequency comparator is thus sped up N times. If more PFDs are used, there will be more difference between the numbers of reset pulse in a frequency comparison cycle so that it will be even easier and quicker to decide which signal is faster.

There is also no dead band for the non-linear frequency comparator since the decision mechanism for the frequency does not require a lock window and is precise all the time. The output of the non-linear frequency comparator is either High or Low. The decision is precise and error-free without uncertainty. The metastability problem is fixed completely since all the triggering of the flip-flops is well-defined. These new non-linear frequency comparators except the design as shown in FIG. 43 are thus ideal frequency comparators that provide fast and precise binary decision output 123.

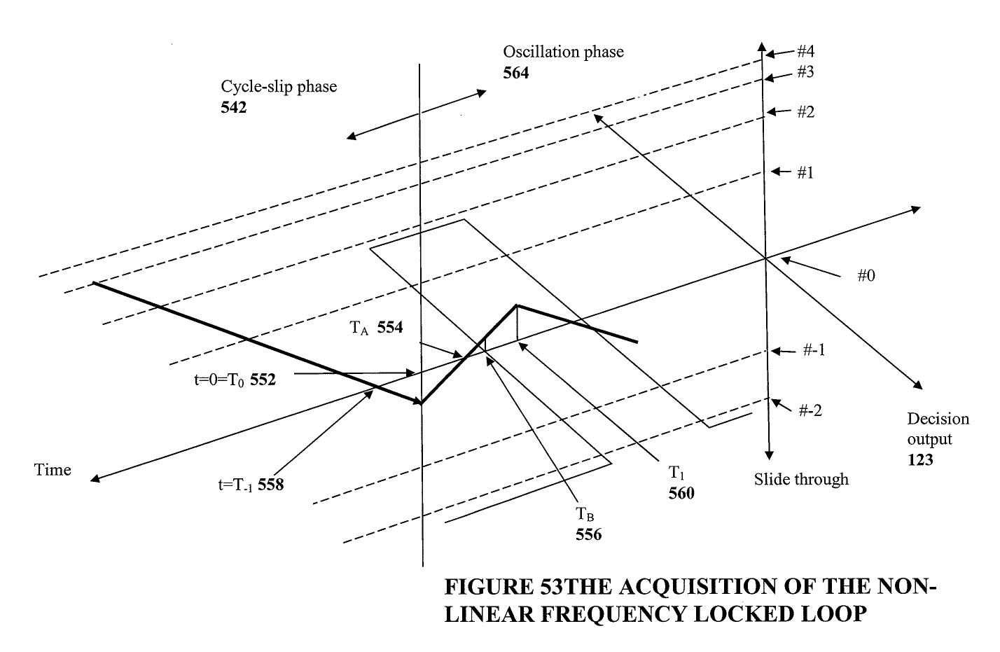

Although the non-linear frequency locked loop is a first order loop, the acquisition behavior of the non-linear frequency locked loop is different than the other first order feedback control loops but is actually more similar to the second order non-linear arrival-time locked loop due to the use of the same VCO as the feedback module 105. Since the frequency comparison can take place only after a slide-through of frequency occurred, the acquisition process of the frequency locked loop can be illustrated as in FIG. 53 with the vertical axial represented by the unit of slide-though. Since the slide-through is caused by the beat signal between the two input signals and the frequency of beat signal depends upon how fast the feedback signal from VCO 112 is changed or slewed across over the reference signal 110, it is very difficult to represent the vertical axial by the actual frequency difference. Using the number of slide-through as the unit of the vertical axial can help us quickly understand the acquisition behavior of the non-linear frequency locked loop and the use of a separate decision output 123 axial can help us conceive the actual frequency of the feedback signal from VCO 112. The slide-through and cycle-slip are used to describe the same beating phenomenon between two signals with different frequencies. The cycle-slip occurs when the beating between two signals occurs so that it occurs at the same rate as the beat signal; since we are using multiple PFDs for frequency detection, there will be multiple slide-through occurring in a cycle of beat signal so that slide-through will occur much more often than cycle-slip. Since the frequency of slide-through will also be reduced as the frequency difference between the two input signals is reduced, the spacing in time between the slide-through will be getting longer as the two frequency is about to be synchronized in frequency when one signal is sliding through the other signal at a constant rate.

Assuming that the initial frequency difference is positive so that the frequency of the feedback signal from VCO 112 is being pumped up by a positive decision output 123 initially and the frequency of the beat signal is slowing down and slide through occurs less frequent and eventually the two frequencies will be synchronized. The acquisition process of the non-linear frequency locked loop can be divided into two phases, the cycle-slip phase 542 and oscillation phase 564. In the cycle-slip phase 542, the frequency of the feedback signal from VCO 112 will be increasing and it will be passing many slide-though points before the two frequencies are finally synchronized which occurs at t=T₀ 552. Since the feedback signal from VCO 112 is the slower signal and the non-linear frequency comparator is speeding up the frequency of the feedback signal from VCO 112 and the final error correction output 115 is ramping up the frequency of the VCO, the phase of the feedback signal from VCO 112 will then be falling behind the orthogonal reference signal 110 all the time initially and the rate of falling behind is constantly reducing since the non-linear frequency comparator is pumping up the frequency of the feedback signal from VCO 112. When the phase of the feedback signal from VCO 112 is falling behind, slide-through between the two input signals will be generated and the slide-through will cause the non-linear frequency comparator to produce an H output for the decision output 123. The decision output 123 from the non-linear frequency comparator is in H state because the feedback signal from the VCO 112 is the slower signal. The slide-through will occur less often as the frequency difference between the two input signals is been reduced. Eventually, after the last slide-through occurred, which is named slide-through #0, the two input signals will have the same frequency occurring at time=0 T₀ 552. At this moment of T₀ 552, the phase of the feedback signal from VCO 112 will be no longer falling behind and the phase of the feedback signal from VCO 112 will begin advancing from this time on because the frequency of the feedback signal from VCO 112 is still being pumped up. The feedback signal from VCO 112 will continue to be sped up and advancing in phase even after the frequency synchronization point at T₀ 552 because before a slide-through is generated to tell the non-linear frequency comparator to do otherwise, the decision output 123 from the non-linear frequency comparator can't be changed and the feedback signal from VCO 112 will continue to be sped up and it can take some time for the non-linear frequency comparator to generate a new slide-through to reverse the direction of ramping because the phase of the feedback signal from VCO 112 now has to advance through some phase shift in order to generate a slide-through to reverse the direction of ramping. The amount of time that the feedback signal from VCO 112 needs to advance to generate a new decision is equal to the amount of time that the feedback signal from VCO 112 had gone through between when the last slide-through #0 at T₋₁ 558 was generated and when the two input signals were synchronized in frequency at T₀ 552. Since the phase interval between when the last slide-through was generated at T₋₁ 558 and when the two input signals were synchronized in frequency is random and can be anywhere from 0 to the 2/N of the beat signal, the feedback signal from VCO 112 now has to advance the same phase interval between the last time a slide-through occurred at T₋₁ 558 until the two input signals are synchronized in frequency at T₀ 552 to generate a new slide-through to reverse the ramping of the frequency. As a result, the frequency of the feedback signal from VCO will becomes higher than the frequency of the orthogonal reference input signal 110 and the frequency of the feedback signal from VCO 112 will continue to go higher until finally a slide-through appears at t=T_{A} 554 to cause the non-linear frequency comparator to produce an L output to slower down the frequency of the feedback signal from VCO 112 occurring at t=T_{B} 556. Due to the inherent loop delay time, the frequency of the feedback signal from VCO 112 will continue to be sped up even after a slide-through is produced at T_{A} 554 to slow down the frequency of the feedback signal from VCO 112. Even after the loop delay time is over, the frequency of the feedback signal from VCO 112 might still continue to be sped up due to the uncertainty of the frequency noise. As a result, the frequency of the feedback signal from VCO is always over-corrected by the loop delay time and the phase interval between when the last slide through occurs at t=T_{A} 554 and when the next time the frequencies are synchronized again at t=T₁ 560 is probably longer than the previous phase interval between T₀ 552 and T_{A} 554 due to the loop delay time. The same process then repeats itself into the other direction.

The period of the first frequency oscillation cycle starts from the moment the frequency difference is zero occurring at T₀ 552 and ends at the moment the frequency difference becomes zero again at T₁ 560 and the oscillation cycle continues forever afterward. During each frequency oscillation cycle, the frequency of the feedback signal from VCO 112 is sped up for approximately half of the time and is slowed down for approximately the other half of the time. The period of the frequency oscillation cycle can grow as the new frequency oscillation cycle is generated if the frequency change occurred during the loop delay period is more than the frequency noise of the non-linear frequency comparator. Otherwise, the period of the frequency oscillation cycle will be stabilized and fluctuate at a certain level.

As a result, every subsequent phase interval between when the two input frequencies are synchronized and when the last slide-though occurred will become longer and longer if the frequency change during the loop delay period is more than the frequency noise of the non-linear frequency comparator. The growing of phase interval between when the two input signals are synchronized in frequency and at the last slide-through will continue until the phase interval between when the two input signals are synchronized in frequency and the last slide-through occurred becomes longer than 2/N and cycle-slip in phase occurs. After the occurrence of cycle-slip, the phase interval between when the two input signals are synchronized in frequency and at the last slide-through will be reset to a very small value and the growing process of phase interval between when the two input signals are synchronized in frequency and at the last slide-through will repeat itself over and over again around new slide-through. Since the number of slide-through can possibly occur to a beat signal is equal to the number PFD used in the non-linear frequency comparator, the slide-through can move from one to another while the frequency of the feedback signal from VCO remains locked all the time.

As a result, the decision output 123 of the non-linear frequency comparator is switched completely randomly and the frequency of the feedback signal from VCO 112 of a non-linear frequency locked loop using a non-linear frequency comparator will always ramp up and down at a fixed rate and the frequency of the feedback signal of VCO 112 will be always over-corrected due to the loop delay time and the frequency of the feedback signal from VCO 112 will turn around randomly after the slide-through occurs.

Since there is always some inherent loop delay time between when the non-linear frequency comparator made the decision to generate a new decision output 123 to correct the frequency of the signal VCO 112 and when a new updated frequency appears at input of the non-linear frequency comparator, the frequency of the signal from VCO 112 will be way above or below the reference input frequency 110 when the input signal to the non-linear frequency comparator is finally updated so that the non-linear frequency locked loop will certainly oscillate. And the oscillation frequency of the loop will be determined by the delay time around the loop, the charging and discharging current from the non-linear frequency comparator to the loop filter 106 and by also the time constant of the loop filter 106. The charging and discharging current from the non-linear frequency comparator and the time constant of the loop filter 106 can also affect the frequency spread of the clock signal especially when the oscillation frequency of the loop is high. Since the start point and end point of each oscillation cycle is determined by the frequency noise of the loop, the start point and stop point of every oscillation cycle will be different. As a result, the non-linear frequency comparator can provide a true broadband spreading for VCO 108 of the non-linear frequency locked loop. The non-linear frequency locked loop with a non-linear frequency comparator thus becomes a perfect spread spectrum clock generator.

In all the designs of the digital frequency comparator as illustrated above, a high frequency reference clock is needed to generate the orthogonal reference signals and also to process the reset pulses from the reset pulse module 307. If a high frequency reference clock is not available in the system, one alternative is to use phase shifter to produce the desired orthogonal phase references. Since an uneven phase between the reference signals will produce uneven frequency noises and spread the frequency unevenly, the phase shifter solution should be prevented at all cost. The other alternative without using a high frequency clock then is to use a lower frequency signal for frequency comparison instead. In this case, we can use a divide-by-three frequency divider for the reference input signal 110 to generate three orthogonal lower-frequency reference comparison signals which have a frequency of ⅓ of the frequency of the reference signal 110 to be compared with a lower-frequency VCO signal that also has ⅓ of the frequency of the feedback signal from VCO 112. As a result, there will be more latency delay from the non-linear frequency comparator since it can only generate a new decision output 123 in every three cycles of reference input signal 110.

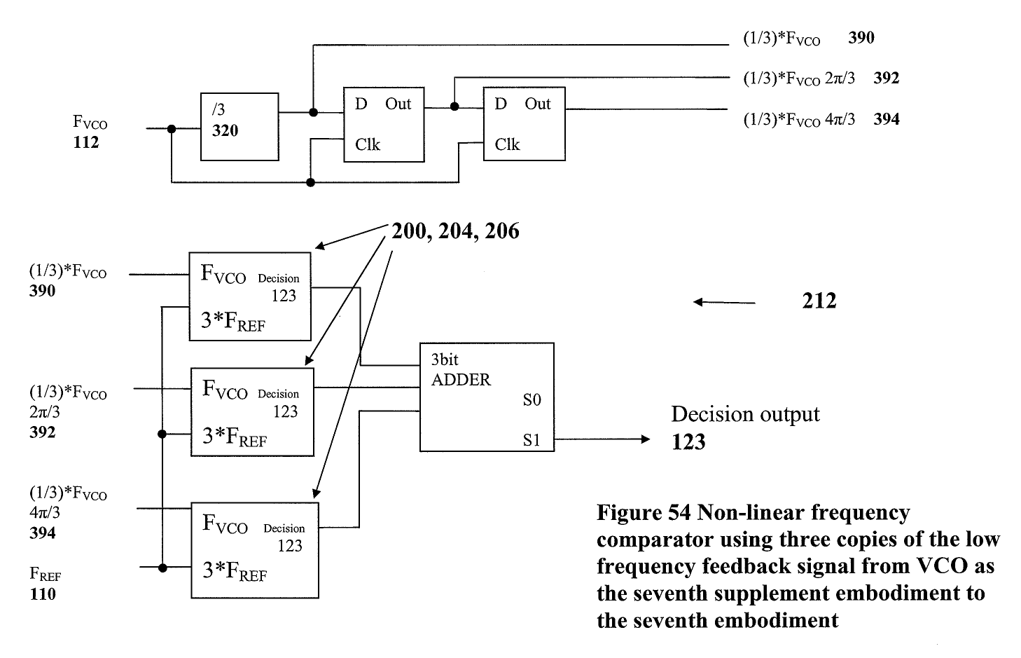

The disadvantage of using a lower comparison frequency is evident since the comparison period can be too long and the frequency spread of the clock will be way over the limit easily. One solution to this problem is to generate three orthogonal copies of lower-frequency VCO signal from the feedback signal from VCO 112 as well and we will then use a separate non-linear frequency comparator for each of the orthogonal lower-frequency VCO signal to be compared with the three orthogonal lower-frequency reference comparison signals. So, totally, we will need nine PFDs to complete this design as shown in FIG. 54 as the seventh supplement embodiment to the seventh embodiment. By doing this way, we will have three frequency comparison decision outputs from each of the three non-linear frequency comparators. We can then use a three bit adder to add all the three decisions from each of the lower-frequency frequency comparator to make a final decision based on the majority vote. As a result, the final frequency decision output 123 can be updated at the same frequency as the original reference signal 110 and the feedback signal from VCO 112 but we need three times of hardware to implement this design.

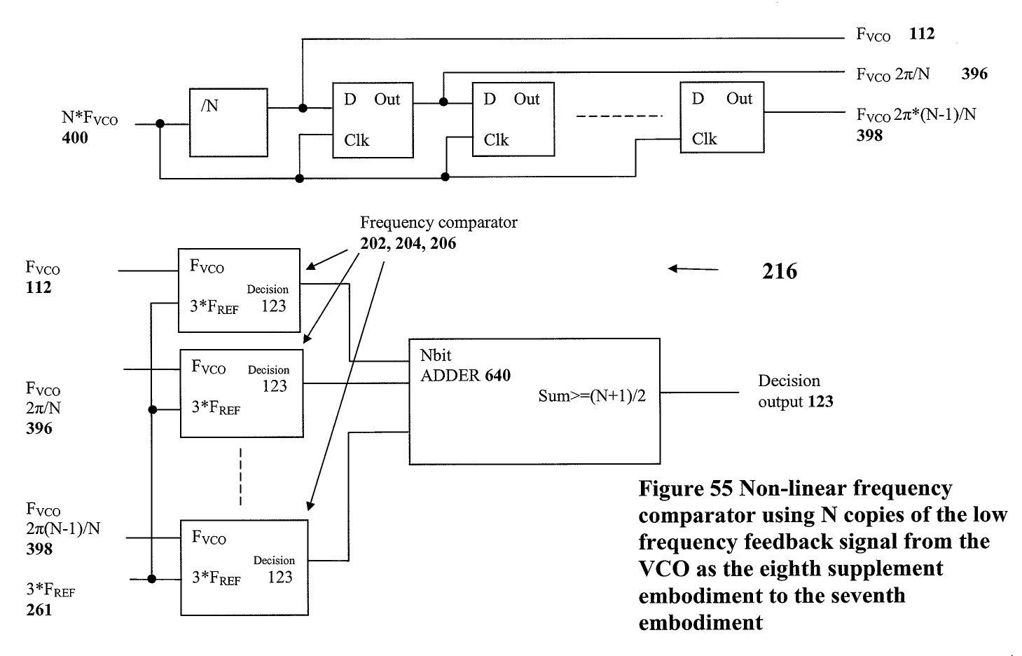

It is also possible to use a divide-by-N frequency divider, where N is a number greater than 3, to produce the feedback signal from VCO 112 from a high frequency feedback signal 400 with frequency equal to N times the frequency of the feedback signal from VCO 112. We can then use the high frequency feedback signal 400 to generate N copies of orthogonal feedback signals from VCO 112 as shown in FIG. 55 as the eighth supplement embodiment to the seventh embodiment. We then compare each of the orthogonal feedback signals from VCO 112 with the high frequency reference comparison signal 261 that has a frequency of 3 times the frequency of reference signal 110 with a non-linear frequency comparator. In this design, we need a total of 3*N PFDs for the frequency comparison and an N bit adder 640 is also needed to add up the N decision outputs 123 from each of the N non-linear frequency comparators to generate the final frequency comparison output 123 based on the majority vote from the N decision outputs 123 from the N non-linear frequency comparators. The frequency of the high frequency feedback signal from VCO must be equal to N*Fref Although the number of hardware used can grow quickly as the number of N increases, this design can offer a very unique advantage that it allows each of the non-linear frequency comparator to be operated at a low frequency of Fref 110 but the final decision of frequency comparison is still made at the rate of the N*Fref. This unique design allows us to produce a frequency comparison output quickly even though the frequency comparison is happening at a slower rate. This design is very useful for frequency locked loop application that the frequency of the VCO can still be switched quickly even at a small frequency step just like the fractional-N technology used today for the phase-locked-loop.

The number of N in the design of the non-linear frequency comparator 216 as shown in FIG. 55 is preferably an odd number so that the sum of the N bit adder 640 can be ranged from 0 to N. As a result, the decision threshold of the frequency comparison can be set at precisely (N+1)/2 and there will be no ambiguity for the frequency decision.

The design of non-linear frequency comparator using N non-linear frequency comparators 216 as shown in FIG. 55 can also be turned into a linear frequency detector using N non-linear frequency comparators by producing a linear weighted error output from the sum of the N bit adder 640, instead of producing a digital bipolar decision output 123 from majority vote. There are many possible ways to weight the error output from the N bit adder 640. For example, we can produce a linear weighting function to the error output of the N bit adder 640 so that the error output from the linear frequency detector using N non-linear frequency comparators increase linearly according to the sum of the N bit adder 640. The linear error output from the linear frequency detector using N non-linear frequency comparator is then subtracted by a fixed constant reference which is equal to the error output that the linear frequency detector using N non-linear frequency comparator produces when the sum of the N bit adder 640 is N/2. The difference between the linear error output from the linear frequency detector using N non-linear frequency comparator and the fixed constant reference is then the desired final linear error output from the linear frequency detector using N non-linear frequency comparators. With this linear frequency detector, we can then build a complete frequency demodulator digitally or a fractional-N frequency synthesizer that always produces an accurate frequency output quickly even at a small frequency step.

To build this linear frequency detector by using N non-linear frequency comparators, the N should be equal to 2^{K}−1 so that the sum of the N bit adder 640 can be ranged from 0 to 2^{K}−1 and represented by K bits from S₀, S₁, S₂ . . . S_{K-1}. The linear weighting function on the sum of the N bit adder 640 will then be 1 for S₀, 2 for S₁, 4 for S₂, and 2^{K-1} for S_{K-1} and so on and the fixed constant reference is (2^{K}−1)/2. So, the sum of the N bit adder 640 will produce an output ranged from 0 to 2^{K}−1 and the final linear error output from the linear frequency detector using N non-linear frequency comparators become −(2^{K}−1)/2 to (2^{K}−1)/2 and the transfer characteristics of this linear frequency detector using N non-linear frequency comparators will be similar to the transfer characteristics as shown in FIG. 37 except that 2^{K}−2 discrete, equally-spaced, ascending steps are to replace the linear ascending slope.

### Frequency Spread of the Clock

It is very important for a spread spectrum clock generator to maintain a constant frequency spread throughout all the operation conditions. Unfortunately, the frequency spread of the clock can vary a lot due to many factors, such as the manufacturing process variations, the temperature and voltage variations; all these factors can affect the frequency spread of the clock. In order to maintain a constant frequency spread, it is very desirable to implement an automatic feedback control loop to regulate the frequency spread of the spread spectrum clock.

To implement a feedback control loop to regulate the frequency spread, we need a non-linear frequency comparator to provide a feedback signal and a mean to adjust the frequency spread. Luckily, we have already had all the components needed for the automatic frequency spread control loop. For example, we can use the typical non-linear frequency locked loop as shown in FIG. 40 or a non-linear arrival-time locked loop with a programmable divider as the spread spectrum clock generator as shown in FIGS. 13 and 14. We can adjust the spread of the clock easily by changing the programmable divider. Or we can use charge pumps with adjustable output current as the output drivers for the error comparator and to control the spread of clock by varying the charge pump output current. We also need a non-linear frequency comparator to check if the spread of frequency is within the limit. If the spread of clock frequency ever exceeds the frequency limit within a frequency spread control cycle, we will decrease the division ratio of the programmable frequency divider or reduce the charging and discharging current from the error comparator to the loop filter to reduce the frequency spread. If the spread of clock frequency is within the limit of frequency spread during the entire period of the frequency spread control cycle, we will then increase the division ratio of the programmable frequency divider or increase the charging and discharging current to the loop filter to increase the frequency spread. Eventually, the programmable divider will be toggled between two numbers all the time or the current output from the charge pumps will be toggled between two settings constantly when the frequency spread of the clock is regulated. The frequency spread control cycle can have a very long period, such as a second, since we only need to check the result of the frequency limit comparison and adjust the frequency division or charge pump output current once in a while so that the process to regulate the frequency spread of the clock does not interfere with the operation of non-linear feedback control loop to generate the spread spectrum clock.

### Experiment Results

An experimental test board was built to demonstrate the various techniques of spread spectrum clock generation. Since both the non-linear arrival-time locked loop and the non-linear frequency locked loop using the same VCO as the feedback module 105 that can be implemented easily, these two methods are the most desirable as the spread spectrum clock generator. The difference between these two designs is little although the non-linear frequency locked loop is usually better since it can produce an error output 123 precisely without dead zone all the time; nevertheless, the non-linear frequency locked loop usually requires a lot more hardware than the non-linear arrival-time locked loop. The non-linear amplitude locked loop and non-linear phase locked loop are usually not as desirable as the other designs because they must be operated at a single frequency and they normally produce a phase spread instead of frequency spread, unless a non-linear feedback module 105 is used.

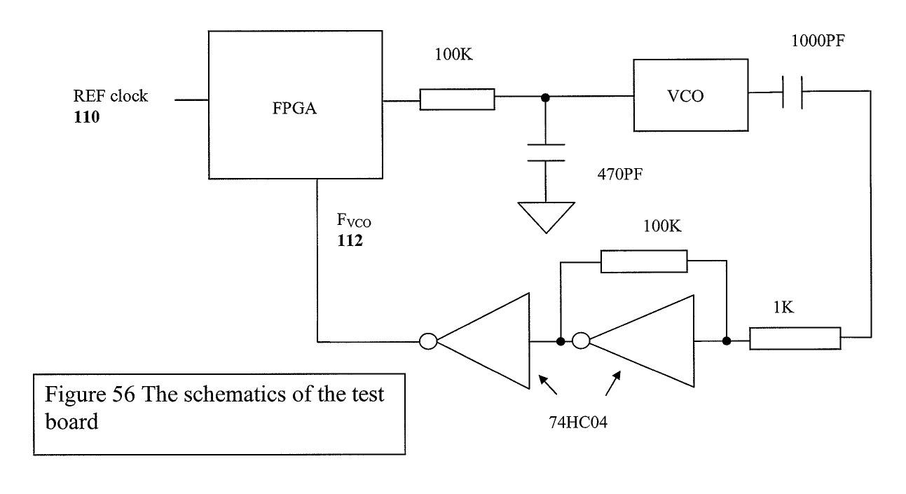

A field programmable gate array 42MX16 from ACTEL was used to provide all the logic gates for the circuits. The 42MX16 has two global internal clock buffers to drive all the logic gates and flip-flops so that it greatly eases the design of the logic circuits. An off-the-shelf VCO module from Mini Circuits, Inc., model: JTOS-100, was used as the feedback module of the loop. This VCO is capable of oscillating from 48 to 59 Mhz when it is tuned from 0-5V. A bypass capacitor of 2000 pf is included inside the VCO module at the VCO tuning input. The schematic diagram of the experimental test board is as shown in FIG. 56. Except the FPGA and VCO, there are only a few components used on the test board. The loop filter is made of a simple RC low pass filter without using an OPAMP to provide the bias for the charge pumps in order to save the parts. Since we are only comparing the performance of different spreading techniques, we can take the short-cut to use a simple loop filter without bias. As a result, the VCO can only be operated at the fixed bias of 2.5V in order to maintain a balanced charging and discharging current from the charge pumps so that the test frequency of the VCO is fixed at 53.08 Mhz.

The loop filter is made of a resistor of 100 Kohm and an external capacitor of 470 pf. The 100K resistor limits the charge pump output to 25 uA. An amplifier made of an inverter is used to amplify the signal from the VCO output to a level with a voltage swing between 1 to 4 volts so that the signal from VCO output can drive the FPGA.

Six different non-linear comparators were built inside the FPGA, 1. An arrival-time comparator as shown in FIG. 15 (A1). 2. An arrival-time comparator has a double-ended output as shown in FIG. 18 (A2), 3. An arrival-time comparator as shown in FIG. 15 is built with an additional digital filter that has a 9 bit shift register and generates a decision based on the sum of the 9 bit shift register. It can turn the current L state into H state only if the sum is greater than 8 and it can turn the current H state into L state only if the sum is less than 1. This filter adds at least 7 reference comparison clock periods to the loop delay. (A3) 4. A frequency comparator is operated at ⅓ of the reference frequency as shown in FIG. 44 (F1). 5. A frequency comparator runs at ⅓ of the reference frequency as shown in FIG. 44 and has the same decision filter as A3 (F2). 6. A frequency comparator uses three low frequency VCO signal to produce a final decision as shown in FIG. 54 (F3).

The frequency spreads of the VCO were measured in two conditions, a low frequency spread and a high frequency spread. The frequency spread was changed by using a different divider for the feedback signal path. No other attempt was made to adjust the frequency spread and the frequency spread was totally determined by the loop delay time.

And the results are listed as follows,

1. Low frequency spread. A divide-by-four frequency divider is used for both the reference signal and the signal from VCO so that the comparison frequency is now 13.27 Mhz for the arrival-time locked loop.

| | Frequency spread | | Spreading loss | Modulation frequency | |
|---|---|---|---|---|---|
| A1. | 280 | Khz | 5 db | 66 | Khz |
| A2. | 600 | Khz | 12 db | 28.5 | Khz |
| A3. | 1 | Mhz | 16 db | 19.6 | Khz |
| F1. | 700 | Khz | 12 db | 27 | Khz |
| F2. | 650 | Khz | 13 db | 27 | Khz |
| F3. | 800 | Khz | 15 db | 25 | Khz |

2. High frequency spread. An additional divide-by-4 frequency divider is used for both the reference signal and the signal from VCO so that the comparison frequency is now 3.32 Mhz for the arrival-time locked loop.

| | Frequency spread | | Spreading loss | Modulation freq. | |
|---|---|---|---|---|---|
| A1. | 750 | Khz | 12 db | 27 | Khz |
| A2. | 1 | Mhz | 20 db | 17 | Khz |
| A3. | 1.5 | Mhz | 43 db | 8 | Khz |
| F1. | 2.5 | Mhz | 41 db | 7.7 | Khz |
| F2. | 2.5 | Mhz | 43 db | 7.7 | Khz |
| F3. | 2.5 | Mhz | 45 db | 7.7 | Khz |

From the above results, it is quite clear that the arrival-time comparator with double-ended output (A2) and the design of frequency comparator using nine PFDs for frequency comparison (F3) are the best two of all designs.

The arrival-time comparator with single-ended output (A1) is not suitable to spread the clock unless more latency delay is added in the loop, such as becoming the design of A3. The design of A1 simply generates too many hasty, noisy decisions during the uncertainty range around the decision threshold.

The use of three frequency comparators, instead of one, can also improve the spreading loss by four db when we compare the result of F1 to F3. This is because the frequency spreading of the VCO with the design of three frequency comparators is produced by three independent frequency noise sources so that the frequency spreading is more random and evenly distributed. For the design using three non-linear frequency comparators, since the noises from each noise sources are uncorrelated, the total noise power is equal to three times of uncorrelated noises power. But for the design of using only one non-linear frequency comparator, the total noise power is equal to three times of correlated noise power so that the total noise power is always higher.

The spread spectrum clock using the non-linear arrival-time locked loop and frequency locked loop is capable producing a clock with a large spreading loss as high as −45 db which is more than 30 db better than the current technology with triangular modulation. The reason that the spreading loss can be so high is because the clock never stays in one frequency or phase regularly and both the amplitude, period and phase of the modulation signal on the final error correction output 115 to the VCO is random. Every modulation cycle in the non-linear arrival-time locked loop is different. Every modulation cycle starts at a random frequency with a random phase and ends at another random frequency and random phase. As a result, the radiated clock energy can only be measured with a video filter with a small bandwidth as low as 300 Hz. For a traditional spread spectrum clock with triangular modulation, a video filter with a bandwidth of 100 Khz is normally used because it is enough to preserve the modulation signal. But for the spread spectrum clock generator using non-linear feedback control loops, since the spectrum is spread so thin that there is nothing preserved in a video filter with small time constant of 100 Khz. A video filter with a small bandwidth is the only way to measure the average power of the radiated clock signal.

The modulation frequency of the spread spectrum clock becomes less than 10 Khz when the spread of frequency is large. Traditionally, the modulation frequency of the spread spectrum clock is chosen to be higher than 30 Khz so that the frequency of modulation signal is out of the audible range. Since the modulation signal of the non-linear feedback control loop now is random noise, instead of a signal with fixed frequency, the noisy modulation signal will behave just like the regular noise in the audible frequency range so that it will not produce any noticeable effect even if it is in the audible range.

The spread of the clock is most effective when the spread of the frequency is large and cycle-slip to the signal from VCO can be produced easily. The frequency spread needs to be at least more than 3% to reduce the clock energy to below −40 db. A smaller spread just does not have enough time to cause the cycle-slip so that the energy of the clock is still very concentrated although it is still far better than the current technology. This will be a problem for applications that require a small frequency spread, for example, for only 0.5% frequency spread. To produce a small frequency spread requirement like this with effective random spread, we need to go through some extra works.

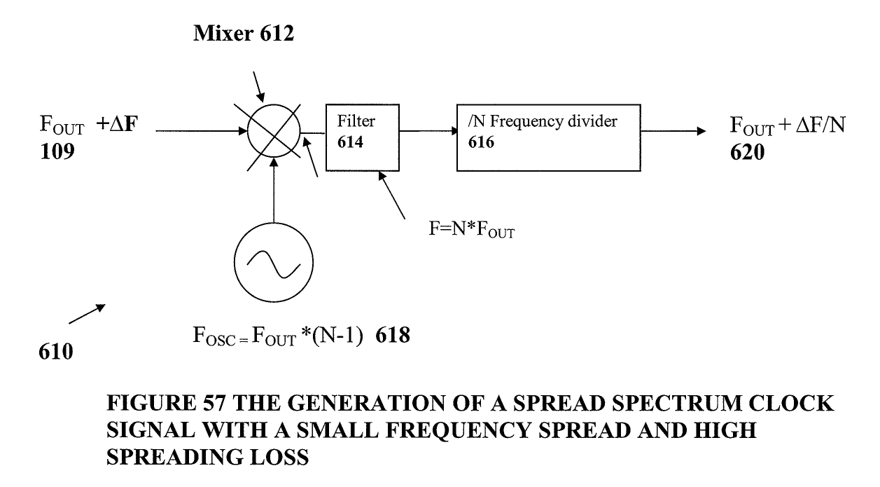

One way to provide an effective random spread for a small frequency spread clock signal is to use a frequency mixer to produce a high frequency clock signal with a higher percentage frequency spread first and then to use a frequency divider to divide the high frequency clock signal down to produce the output with the desired clock frequency with the desired frequency spread as shown in FIG. 57. Suppose, first, we produce a desired low frequency clock signal Fₒᵤₜ 109 with frequency spread of f and a high frequency clock signal without frequency spread but has a frequency that is equal to N−1 times of the desired low frequency clock signal Fₒᵤₜ 109, if we use a frequency mixer 612 to mix these two signals together, we can extract a high frequency clock signal that has N times the frequency of the desired low frequency clock signal with f frequency spread from the output of the mixer. We can then use a divide by N frequency divider 616 to produce a clock with the desired frequency Fₒᵤₜ 109 and the frequency spread of the desired clock will be only f/N. Assuming that the original spreading loss of the low frequency clock with 5% frequency spread is −45 db and we choose N=10, then the spreading loss of the desired clock with 0.5% spread will become −35 db which is still much higher than the spreading loss provided by the current technology. This method does need a lot of hardware but it does deliver a low spread clock with an excellent spreading loss.

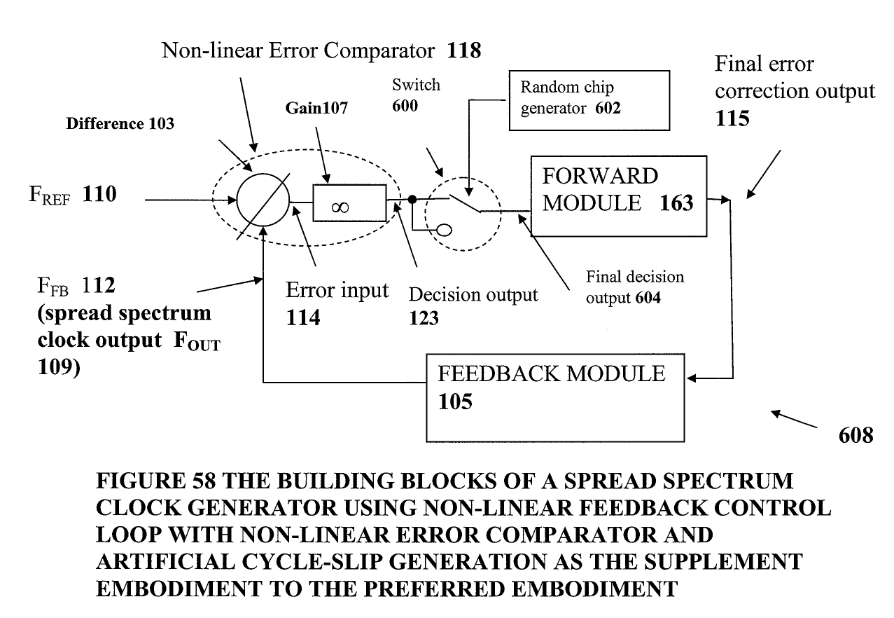

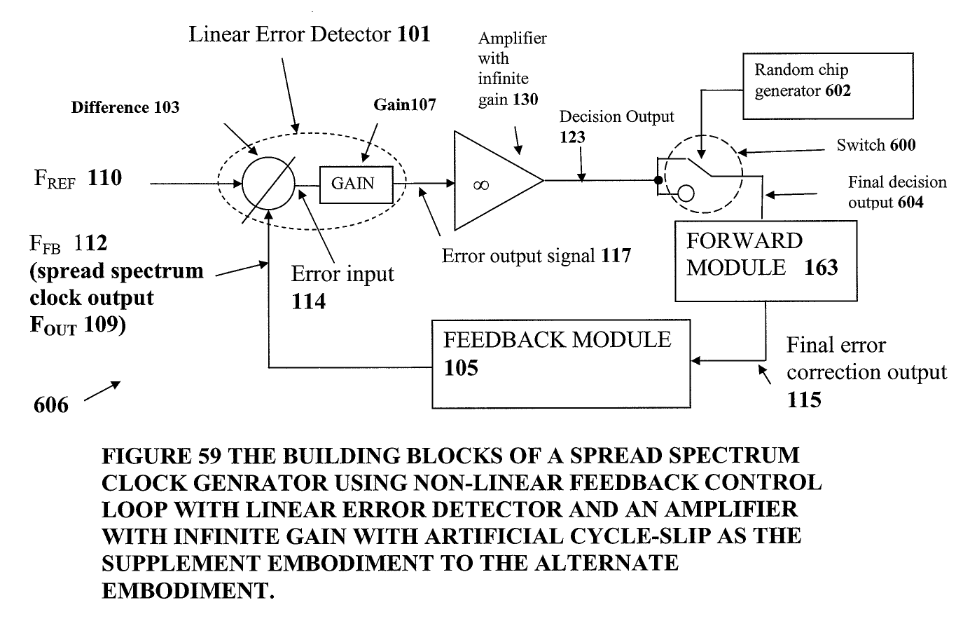

The other method to increase the spreading loss for a spread spectrum clock with small frequency spread is to add the cycle-slip artificially. As explained earlier, the cycle-slip can reset the spreading modulation signal on the final error correction output signal 115 so that the amplitude, frequency and phase of the modulation signal on the final error correction output 115 become completely random. For a spread spectrum clock generator with small frequency spread, since the spreading of the final error correction output signal 115 is not long enough to generate cycle-slips, the amplitude of the modulation signal on the final error correction output signal 115 can only fluctuate in a small range so that the spreading loss is small. Luckily, cycle-slips can be artificially added into the spread spectrum clock generator using non-linear feedback control loop by taking advantage of the fact that the polarity of closed loop gain is irrelevant when the non-linear feedback control loop 116 and 120 is operated in the oscillation phase 564. Since the polarity of the closed loop gain is irrelevant, the non-linear feedback control loop 116 and 120 can still oscillate even when the polarity of the decision output signal 123 is reversed. The reversing of the polarity of decision output signal 123, when it occurs asynchronously and randomly to the spreading modulation signal on the final error correction output 115, can create many short frequency spread for the spread spectrum clock generator just like the short frequency spread caused by the reset of the modulation signal on final error correction signal 115 due to cycle-slips. The reversing of the polarity of decision output signal 123, in effect, is to reverse the direction to generate the spreading modulation waveform on the final error correction output 115 to the feedback module 105. As a result, the amplitude of the modulation signal on the final error correction signal 115 will become random between zero and the peak of the spreading modulation signal on the final error correction output 115 and both the frequency and phase of the spreading modulation waveform on the final error correction output 115 also become random so that the spreading loss is greatly increased. The block diagrams for the spread spectrum clock generator using the non-linear feedback control loop with a random polarity switching to the decision output signal 123 to produce artificial cycle-slips to increase the spreading loss are as shown in FIGS. 58 and 59. In these block diagrams, a single-pole-double-throw switch 600 is used to select either the normal decision output signal 123 or the inverted decision output signal as the final decision output signal 604 to drive the forward module 163. The operation of the switch 600 and the state of the final decision output 604 is determined by the state of the output signal from a random chip generator 602. The random chip generator 602 produces a sequence of digital signal that toggles between H and L state randomly. The switch 600 will select the normal decision output 123 as the final decision output 604 when the output signal from the random chip generator 602 is L and the switch 600 will select the inverted decision output as the final decision signal 604 when the output signal from the random chip generator 602 is H. The switch 600 usually stays at a level, either H or L, longer than the period of the spreading modulation signal on the final error correction output 115 to the feedback module 105.

The technique as shown in FIGS. 58 and 59 to add artificial cycle-slips to the spread spectrum clock generator using non-linear feedback control loop 606 and 608 can also be applied to other spread spectrum clock generators using other technologies to increase the spreading loss as well. One technology that can benefit from this technique easily is the technology to use a look-up table to spread the clock. In this technology, the amount of frequency spread to the clock is determined by the formula stored in a look-up table and a spreading clock sequentially clocks out the formula stored in the table to produce the desired spreading modulation signal to modulate the VCO and the spreading modulation signal to the VCO is usually a repetitive deterministic signal. Even with a repetitive deterministic modulation signal, cycle-slip can still be added by randomly reversing the direction to clock out the formula stored in the look-up table so that the reversing of the direction of clock signal to clock out the spread modulation signal stored in the look-up table creates many short frequency spread so that the amplitude, frequency and phase of the deterministic modulation signal become random. As a result, the amplitude of the spreading modulation signal on the final error correction output 115 will now become random between zero and the peak of the repetitive deterministic spreading modulation signal and the frequency and phase of the spreading modulation waveform can also become random so that the spreading loss can thus be increased significantly.

Randomly reversing the direction to generate the spreading modulation function on the final error correction output 115 to the feedback module 105 of the spread spectrum clock generator is an effective way to produce a random spread to increase the spreading loss of the spread spectrum clock generator, no matter whether the spreading modulation signal on the final error correction output 115 to the feedback module 105 is random or deterministic.

It is quite evident that using more frequency comparators can improve the spreading loss when we compare the result of F1 and F3. In theory, the spreading loss can be improved even further if more frequency comparators are used. The improvement of spreading loss should be proportional to log₁₀(N) where N is the number of non-linear frequency comparators used for the final complete non-linear frequency comparator 216. The design as shown in FIG. 55 is thus the best design for the non-linear frequency comparator 216 although it requires a lot more hardware. In this design, the final decision output 123 is a binary output based on majority vote from the outputs of the N non-linear frequency comparators.

### INDUSTRIAL APPLICABILITY

In the field of consumer electronics, such as PCs, laptops, printers, digital camera and cell phones etc., there is a significant demand for a stable clock with the least amount of frequency spread while still provide enough spreading loss to pass the FCC requirement for the spurious radiations from the clock and its harmonics. These products can all benefit significantly from these inventions by producing lower cost products to the market in less time.

1-11. (canceled)

12. An apparatus for producing a spread spectrum clock signal, comprising:
a non-linear error comparator receiving a reference signal at a first input terminal of said non-linear error comparator;
a feedback control loop having an input terminal coupled an output terminal of said non-linear error comparator; and
an output terminal of said feedback control loop coupled to a second input terminal of said non-linear error comparator;
whereby said non-linear error comparator produces an infinite closed loop gain for said feedback control loop to produce a feedback signal output from said output terminal of said feedback control loop that oscillates randomly around the reference input signal.

13. An apparatus as set forth in claim 12, wherein said non-linear error comparator comprises a non-linear frequency comparator.

14. The apparatus as set forth in claim 12, wherein said non-linear error comparator further comprises:
a difference block comparing said reference signal provided to the first input terminal of said non-linear comparator and a signal received at the second input terminal of said non-linear error comparator, with the result of said comparison producing an error input value; and
a gain block receiving said error input value and producing a bi-polar digital decision output at said output terminal of said non-linear error comparator, regardless of the value of said error input value

15. An apparatus as set forth in claim 14, wherein said non-linear frequency comparator comprises:
an orthogonal module, having an output outputting said reference input signal;
a reset pulse module coupled to receive said reference input signal; and
a decision module coupled to said reset pulse module and outputting said bi-polar decision output.

16. An apparatus as set forth in claim 15, wherein said reset pulse module comprises:
three Phase Frequency Detectors (PFD's), each receiving one of three orthogonal reference input signals offset from each other by 120 degrees and each having an output coupled to an OR gate, said OR gate outputting a final reset signal to said decision module.

17. A method of producing a spread spectrum clock signal, comprising:
providing a reference signal to a first input terminal of a non-linear error comparator;
coupling an input terminal of a feedback control loop to an output terminal of said non-linear error comparator;
coupling an output terminal of said feedback control loop to a second input terminal of said non-linear error comparator; and
producing an infinite closed loop gain for said feedback control loop, thereby producing an oscillation for the feedback control loop to produce a feedback signal output from said output terminal of said feedback control loop that oscillates randomly around the reference input signal.

18. The method of claim 17, wherein said production of the infinite closed loop gain for said feedback control loop comprises:
comparing said reference signal provided to the first input terminal of said non-linear comparator and a signal received at the second input terminal of said non-linear error comparator, with the result of said comparison producing an error input value; and
producing a bi-polar digital decision output at said output terminal of said non-linear error comparator, regardless of the value of said error input value.

19. The method of claim 18, wherein said non-linear error comparator comprises a non-linear frequency comparator.

20. The method of claim 19, wherein said non-linear error comparator further comprises:
a difference block comparing said reference signal provided to the first input terminal of said non-linear comparator and a signal received at the second input terminal of said non-linear error comparator, with the result of said comparison producing an error input value; and
a gain block receiving said error input value and producing a bi-polar digital decision output at said output terminal of said non-linear error comparator, regardless of the value of said error input value.

21. The method of claim 20, wherein said non-linear frequency comparator comprises:
an orthogonal module, having an output outputting said reference input signal;
a reset pulse module coupled to receive said reference input signal; and
a decision module coupled to said reset pulse module and outputting said bi-polar decision output.

22. The method of claim 21, wherein said reset pulse module comprises:
three Phase Frequency Detectors (PFD's), each receiving one of three orthogonal reference input signals offset from each other by 120 degrees and each having an output coupled to an OR gate, said OR gate outputting a final reset signal to said decision module.
